(19) United States
(12) Patent Application Publication
(10) Pub. No.: US 2008/0252563 A1
(43) Pub. Date: Oct. 16, 2008

(54) METHOD OF DRIVING PLASMA DISPLAY PANEL

(75) Inventor: Shunsuke ITAKURA, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku (JP)

(21) Appl. No.: 12/042,909

(22) Filed: Mar. 5, 2008

(30) Foreign Application Priority Data
Mar. 6, 2007 (JP) 2007-055557
Apr. 18, 2007 (JP) 2007-109650

(51) Int. Cl. G09G 3/28

(52) U.S. Cl. 345/63

(57) ABSTRACT

A method of driving a plasma display panel, which includes secondary electron emission material in a fluorescent layer in discharge cells, has a resetting process in which a first reset discharge is generated between one of a pair of row electrodes of the plasma display panel as an anode and a column electrode as a cathode by applying a voltage between the one row electrode and the column electrode. A second reset discharge is generated by applying a first base pulse having a positive peak potential to the other of the row electrodes while applying a negative potential to the one row electrode. A second base pulse having a positive peak potential different from the positive peak potential of the first base pulse is applied to the other row electrode while a negative potential is applied to the one row electrode throughout the execution period of an addressing process.

### BACKGROUND OF THE INVENTION

1. Field of the Invention

The present invention relates to a method of driving a plasma display panel.

2. Description of the Related Art

Recently, AC type (alternating current discharge type) plasma display panels (PDPs), as thin shaped display devices, have been manufactured. The PDPs include two substrates such as a front transparent substrate and a rear transparent substrate parallel to each other with a predetermined distance therebetween. An inner side (facing the rear transparent substrate) of the front transparent substrate as a display surface is provided with a plurality of pairs of sustain electrodes which are composed of row electrodes extending parallel in a pair. The inner side of the front transparent substrate is provided with a dielectric layer covering each pair of the row electrodes as well. The rear transparent substrate is provided with a plurality of column electrodes as address electrodes, which extend in a column direction and intersect the pairs of row electrodes, and also is covered with fluorescent material. In view of the display surface side, display cells corresponding to pixels are formed in intersecting areas of the pairs of row electrodes and the pairs of column electrodes. For such PDPs, a gray scale driving is performed using a sub-field scheme in order to obtain display luminescence of halftone level corresponding to an input image signal.

In the gray scale driving based on the sub-field scheme, a display driving for the image signal corresponding to one field is performed by each of a plurality of sub-fields to which the number (or period) of emission is allotted. An addressing process and a sustaining process are sequentially performed in each sub-field. In the addressing process, a selective discharge is generated between the row electrode and the column electrode within a discharge cell on the basis of the input image signal, thus to generate (or erase) a specific amount of wall charges. In this case, discharge cells having the predetermined amount of wall charges formed thereon are set to an ON mode and discharge cells having insufficient amount of wall charges are set to an OFF mode. In the sustaining process, only the discharge cells having the predetermined amount of wall charges, which are set to the ON mode, are sustain-discharged repeatedly to maintain the emission state according to the sustain discharge. A resetting process is performed previously to the addressing process in at least a head sub-field. In the resetting process, a reset discharge is generated between the row electrodes in a pair within all of the discharge cells, thereby initializing the amount of wall charges remaining in all of the discharge cells and setting all of the discharge cells to one of the ON mode and the OFF mode.

In this case, the reset discharge is a relatively strong discharge but has no contribution to display, and thus the emission depending on the reset discharge causes a contrast of an image to be deteriorated.

### SUMMARY OF THE INVENTION

Under the above circumstances, a plasma display device has been proposed, which has a plasma display panel provided with a magnesium oxide layer including magnesium oxide crystals which generates a cathode luminescence emission with a peak value in a wavelength range of 200 to 300 nm excited by irradiation of an electron beam, within respective display cells (See, e.g., Japanese Patent Kokai No. 2006-54160 (Patent Document 1)). According to such a plasma display panel, a delay time of the discharge occurring within the display cells decreases, and thus it is possible to certainly generate a reset discharge even if a reset pulse with a relatively low peak potential is supplied. Therefore, for the plasma display device, the reset pulse with a relatively low peak potential is supplied to each display cell to generate a reset discharge having a weak discharge intensity. This causes the emission brightness depending on the reset discharge to decrease, thereby improving brightness contrast of a display image.

However, since discharge is more likely to occur due to decrease of the discharge delay time, there arises a problem of an erroneous discharge in a addressing process right after a reset discharge.

Meanwhile, a driving method has been proposed, which prevents a reset discharge from being generated only for black display that discharge cells are kept in an OFF state through the display time of one field (See FIG. 9 of Japanese Patent Kokai No. 2001-312244 (Patent Document 2)). Such driving method expresses a brightness range of the lowest brightness (black display) to the highest brightness with fifteen levels (the first gray scale to the fifteenth gray scale) using fourteen sub-fields. In this case, for the second to fifteen gray scale driving except the first gray scale driving responsible for the lowest brightness (black display), a selective writing discharge (represented by a dual circle) corresponding to the reset discharge is generated only with the first sub-field SF1 to initialize discharge cells to an ON mode. Further, by generating a selective erasing discharge (represented by a black circle) for transition of discharge cells to an OFF mode using only one among the sub-fields SF2 to SF14, a sustain discharge (represented by a white circle) is generated with each of the sub-fields consecutive by the number corresponding to each gray scale.

With the above-described driving method, only the first sub-field SF1 has a chance of the write discharge for initializing the state of the discharge cells, and even the write discharge is not performed in case of the black display, thereby increasing a contrast.

According to such driving, however, a chance of transition of the discharge cells from the OFF mode to the ON mode is given to only the write discharge in the first sub-field SF1. Thus, if the write discharge fails in the first sub-field SF1, the display becomes black regardless of the input image signal to remarkably deteriorate image quality.

The present invention has been made to solve the above-mentioned problems, and it is an object of the present invention to provide a method of driving a plasma display panel, which is capable of preventing an erroneous discharge and improving a dark contrast.

In addition, it is another object of the present invention to provide a method of driving a plasma display panel, which is capable of stably generating a write discharge for selective transition of discharge cells from an OFF mode to an ON mode on the basis of an input image signal.

According to a first aspect of the present invention, there is provided a method of driving a plasma display panel in which a front substrate faces a rear substrate with a discharge space filled with a discharge gas interposed therebetween and discharge cells forming pixels are formed in intersecting areas of a plurality of pairs of row electrodes formed on the front substrate and a plurality of column electrodes formed on the rear substrate, the plasma display panel being gray scale-driven by a plurality of sub-fields every unit display period of an input image signal, wherein a fluorescent layer including a fluorescent material and a secondary electron emission material is formed in the discharge cells on the rear substrate, wherein, in one sub-field in the unit display period, a resetting process to initialize the discharge cells to an OFF mode and an addressing process to change the discharge cells into an ON mode selectively according to the input image signal are performed, wherein, in the resetting process, a voltage is applied between one row electrode as an anode of the pair of row electrodes and the column electrode as a cathode, and then, a first base pulse having a positive peak potential is applied to the other row electrode of the pair of row electrodes while applying a negative potential to the one row electrode, and wherein a second base pulse having a positive peak potential different from the positive peak potential of the first base pulse is applied to the other row electrode while a negative potential is applied to the one row electrode throughout the execution period of the addressing process.

By including the secondary electron emission material in the fluorescent layer in the discharge cells of the plasma display panel (PDP), it is possible to certainly generate a weak reset discharge, thereby improving dark contrast.

In addition, in gray scale-driving the PDP with the plurality of sub-fields every unit display period, the following reseting and addressing processes are performed in one sub-field in the unit display period. First, in the resetting process, the first reset discharge is generated between one row electrode as an anode of the pair of row electrodes and the column electrode as a cathode by applying a voltage between the one row electrode and the column electrode, and then, the second reset discharge is generated by applying a first base pulse having a positive peak potential to the other row electrode of the pair of row electrodes while applying a negative potential to the one row electrode. Next, in the addressing process, the discharge cells are set to an ON mode by selectively address-discharging the discharge cells according to the input image signal. In addition, the second base pulse having a positive peak potential different from the positive peak potential of the first base pulse is applied to the other row electrode while a negative potential is applied to the one row electrode throughout the execution period of the addressing process.

In this case, when the peak potential of the first base pulse is set to be higher than that of the second base pulse, wall charges are erased as the second reset discharge becomes strong, but a small quantity of positive wall charges remain around the one row electrode of each discharge cell and a small quantity of negative wall charges remain around the other row electrode. Accordingly, under the state in which the negative potential is applied to the one row electrode and the second base pulse is applied to the other row electrode in the addressing process, a discharge is prevented from being generated between row electrodes, thereby preventing an erroneous discharge.

Conversely, when the peak potential of the second base pulse is set to be higher than that of the first base pulse, although there exist any discharge cells in which the address discharge becomes weak due to irregularity of discharge intensity for each discharge cell in manufacture, it is possible to certainly set the discharge cells to an OFF mode.

According to another aspect of the present invention, there is provided a method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal, wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed, wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and wherein a negative peak potential of the write scan pulse applied in the writing addressing process of the first sub-field is set to be higher than a negative peak potential of the write scan pulse applied in the writing addressing process of the second sub-field.

According to still another aspect of the present invention, there is provided a method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal,

wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed, wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and wherein a pulse width of the write scan pulse applied in the writing addressing process of the first sub-field is set to be smaller than a pulse width of the write scan pulse applied in the writing addressing process of the second sub-field.

According to yet still another aspect of the present invention, there is provided a method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal, wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed, wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and wherein, in the first sub-field, a negative base pulse is applied to the other row electrode of the pair of row electrodes throughout the execution period of the writing addressing process, and, in the second sub-field, a positive base pulse is applied to the other row electrode throughout the execution period of the writing addressing process.

In the first sub-field and the second sub-field subsequent to the first sub-field in the unit display period, the writing addressing process to change the discharge cells from the OFF mode to the ON mode by selectively writing address-discharging the discharge cells by applying the pixel data pulse to the column electrodes while applying the negative write scan pulse to the one row electrode of the pair of row electrodes of the plasma display panel is performed. In the third sub-field subsequent to the second sub-field, the erasing addressing process to change the discharge cells from the ON mode to the OFF mode by selectively erasing address-discharging the discharge cells by applying the pixel data pulse to the column electrodes while applying the negative erase scan pulse to the one row electrode of the pair of row electrodes is performed. In this case, the negative peak potential of the write scan pulse applied in the writing addressing process of the first sub-field is set to be higher than the negative peak potential of the write scan pulse applied in the writing addressing process of the second sub-field.

In addition, a pulse width of the write scan pulse applied in the writing addressing process of the first sub-field is set to be smaller than a pulse width of the write scan pulse applied in the writing addressing process of the second sub-field.

In addition, a negative base pulse is applied to the other row electrode of the pair of row electrodes throughout the execution period of the writing addressing process of the first sub-field, and a positive base pulse is applied to the other row electrode throughout the execution period the writing addressing process of the second sub-field.

With such a driving, since an erroneous discharge occurring between row electrodes due to the write address discharge generated in the writing addressing process of the first sub-field is prevented, it is possible to certainly generate the write discharge in the writing addressing process of the next second sub-field.

### BRIEF DESCRIPTION OF THE DRAWINGS

FIG. 1 is a schematic view of a plasma display apparatus for driving a plasma display panel using a driving method according to a first embodiment of the present invention;

FIG. 2 is a front view schematically showing an inner structure of a PDP 50 viewed from a display surface side;

FIG. 3 is a cross-sectional view taken along line III-III in FIG. 2;

FIG. 4 is a cross-sectional view taken along line IV-IV in FIG. 2;

FIG. 5 is a schematic view showing MgO crystals included in a fluorescent material 17;

FIG. 6 is a view showing an example of an emission pattern for each of gray scales in the plasma display apparatus shown in FIG. 1;

FIG. 7 is a view showing an example of an emission driving sequence used for the plasma display apparatus shown in FIG. 1;

FIG. 8 is a view showing various driving pulses applied to a PDP 50 according to the emission driving sequence shown in FIG. 7;

FIG. 9 is a view showing another example of an emission driving sequence used for the plasma display apparatus shown in FIG. 1;

FIG. 10 is a view showing various driving pulses applied to the PDP 50 according to the emission driving sequence shown in FIG. 9;

FIG. 11 is a view showing a change of discharge intensity in a column cathode discharge generated under application of a reset pulse RP_{Y1} to a conventional PDP including CL emission MgO crystals in only a magnesium oxide layer 13;

FIG. 12 is a view showing a change of discharge intensity in a column cathode discharge generated under application of a reset pulse RP_{Y1} to the PDP 50 including CL emission MgO crystals in both of a magnesium oxide layer 13 and a fluorescent layer 17;

FIG. 13 is a view showing another waveform of the reset pulse RP_{Y1};

FIG. 14 is a schematic view illustrating a fluorescent layer 17 formed by laminating a secondary electron emission layer 18 on a surface of a fluorescent particle layer 17a;

FIG. 15 is a schematic view of a plasma display apparatus for driving a plasma display panel using a driving method according to a second embodiment of the present invention;

FIG. 16 is a view showing an example of an emission pattern for each of gray scales in the plasma display apparatus shown in FIG. 15;

FIG. 17 is a view showing an example of an emission driving sequence used for the plasma display apparatus shown in FIG. 15;

FIG. 18 is a view showing various driving pulses applied to a PDP 50 according to the emission driving sequence shown in FIG. 17;

FIG. 19 is a view showing another example of an emission driving sequence used for the plasma display apparatus shown in FIG. 15;

FIG. 20 is a view showing various driving pulses applied to a PDP 50 according to the emission driving sequence shown in FIG. 19;

FIG. 21 is a schematic view of a plasma display apparatus for driving a plasma display panel using a driving method according to a third embodiment of the present invention;

FIG. 22 is a view showing an example of an emission driving sequence used for the plasma display apparatus shown in FIG. 21;

FIG. 23 is a view showing another example of an emission driving sequence used for the plasma display apparatus shown in FIG. 21;

FIG. 24 is a schematic view of a plasma display apparatus for driving a plasma display panel using a driving method according to a fourth embodiment of the present invention;

FIG. 25 is a view showing an example of an emission driving sequence used for the plasma display apparatus shown in FIG. 24;

FIG. 26 is a view showing another example of an emission driving sequence used for the plasma display apparatus shown in FIG. 24;

FIG. 27 is a view illustrating another method of applying a reset pulse in a first resetting process R1;

FIG. 28 is a view showing various driving pulses applied to the PDP 50 according to the emission driving sequence shown in FIG. 17;

FIG. 29 is a view showing another example of various driving pulses applied to the PDP 50 according to the emission driving sequence shown in FIG. 17;

FIG. 30 is a view showing another example of various driving pulses applied to the PDP 50 according to the emission driving sequence shown in FIG. 17;

FIG. 31 is a view showing another example of various driving pulses applied to the PDP 50 according to the emission driving sequence shown in FIG. 17;

FIG. 32 is a view showing other waveforms of a reset pulse RP; and

FIG. 33 is a view showing another example of an application timing for each of a minute light emission pulse LP and a reset pulse RP2_{Y1}.

### DETAILED DESCRIPTION OF THE INVENTION

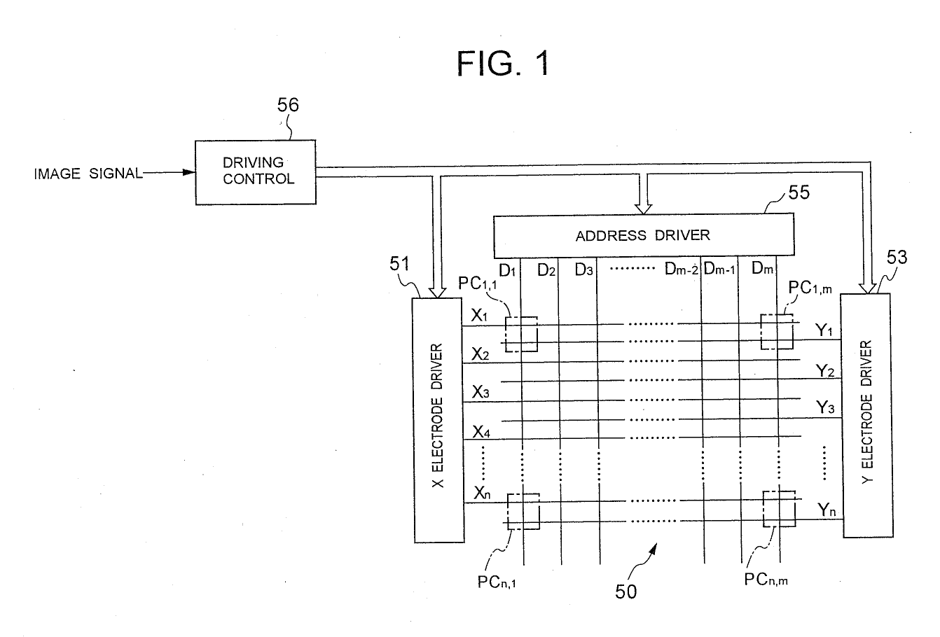

FIG. 1 is a schematic view of a plasma display apparatus for driving a plasma display panel using a driving method according to a first embodiment of the present invention.

As shown in FIG. 1, the plasma display device includes a plasma display panel (PDP) 50, an X electrode driver 51, a Y electrode driver 53, an address driver 55 and a driving control circuit 56.

The PDP 50 is provided with a plurality of column electrodes D₁ to Dₘ each extending and arranged in a longitudinal direction (vertical direction), a plurality of row electrodes X₁ to Xₙ and a plurality of row electrodes Y₁ to Yₙ each extending and arranged in a transverse direction (horizontal direction) in a two-dimensional display screen. The pairs of row electrodes (Y₁,X₁), (Y₂,X₂), (Y₃,X₃), . . . , (Yₙ,Xₙ), which are paired between row electrodes adjacent to each other, are in charge of a first display line to an n-th display line in the PDP 50, respectively. Discharge cells (display cells) PC corresponding to pixels are disposed in respective intersecting areas (areas surrounded by dash-dot lines in FIG. 1) of the respective display lines and the column electrodes D₁ to Dₘ. In other words, the PDP 50 is provided with discharge cells PC_{1,1} to PC_{1,m} belonging to the first display line, discharge cells PC_{2,1} to PC_{2,m} belonging to the second display line, . . . , discharge cells PC_{n,1} to PC_{n,m} belonging to the n-th display line arranged in the form of a matrix.

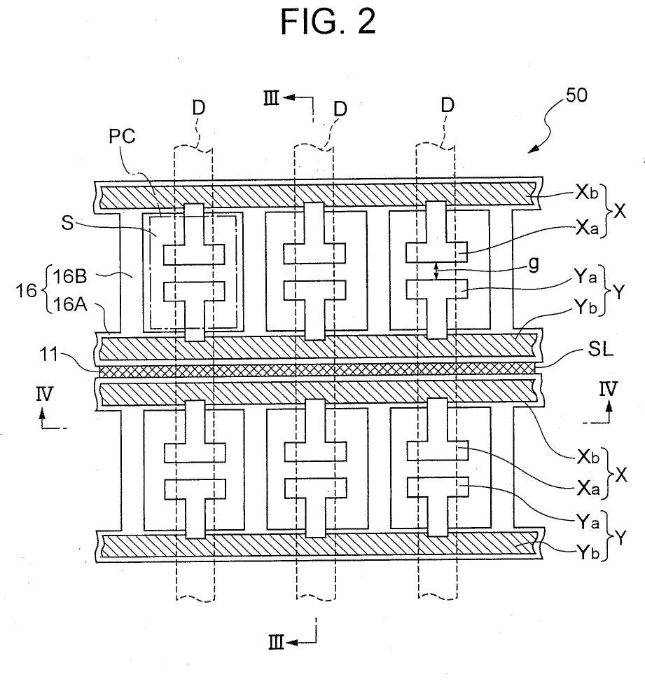

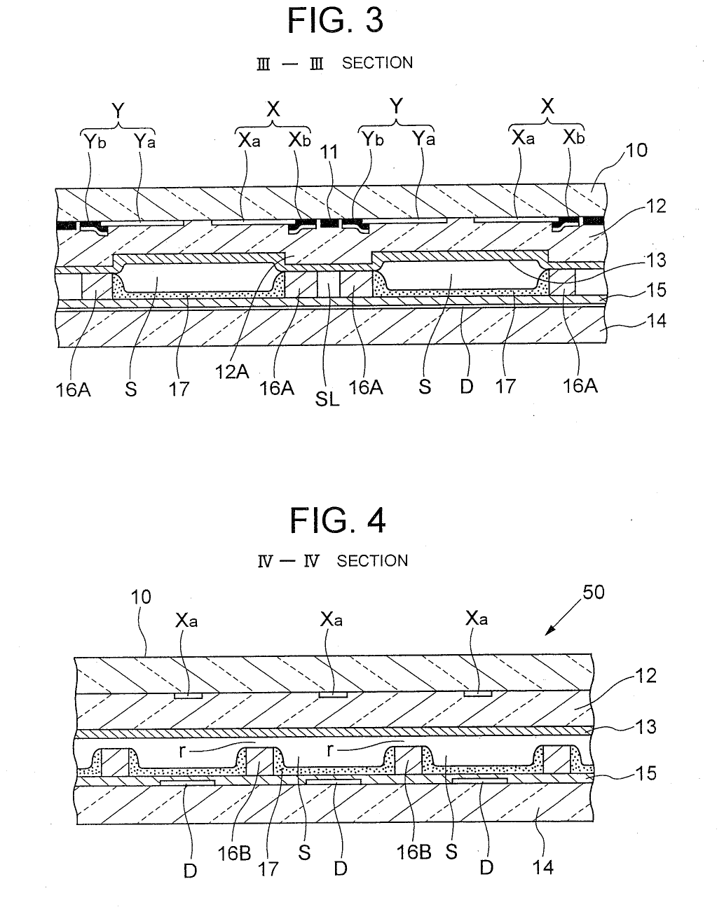

FIG. 2 is a front view showing an inner structure of the PDP 50 viewed from a display surface side. FIG. 2 shows only intersecting areas of three column electrodes D adjacent to each other and two display lines adjacent to each other. FIG. 3 is a cross-sectional view of the PDP 50, which is taken along line III-III in FIG. 2, and FIG. 4 is a cross-sectional view of the PDP 50, which is taken along line IV-IV in FIG. 2.

As shown in FIG. 2, each of the row electrodes X is composed of a bus electrode Xb in a horizontal direction in a two-dimensional display screen and a T-shaped transparent electrode Xa disposed at the corresponding position to each discharge cell PC, contacted with the bus electrode Xb. Each column electrode Y includes a bus electrode Yb in a horizontal direction in a two-dimensional display screen and a T-shaped transparent electrode Ya disposed at the corresponding position to each discharge cell PC, contacted with the bus electrode Yb. The transparent electrodes Xa and Ya are made of, for example, a transparent conductor such as indium tin oxide (ITO), and the bus electrodes Xb and Yb are made of, for example, metal. The row electrodes X composed of the transparent electrodes Xa and the bus electrodes Xb and the column electrodes Y composed of the transparent electrodes Ya and the bus electrodes Yb are disposed on the rear side of a front transparent substrate 10 which forms a display area of the PDP 50 as shown in FIG. 3. The transparent electrodes Xa and Ya in each pair of the row electrodes X and Y extend toward each other forming a pair and face to each other with a discharge gap g1 of a predetermined width therebetween. A light absorbing layer (light-blocking layer) 11 with a dark or dark color and extending in a horizontal direction in a two-dimensional display screen is formed between a pair of the row electrodes X and Y and a pair of the row electrodes X and Y adjacent thereto on the rear side of the front transparent substrate 10 as well. Furthermore, a dielectric layer 12 for covering the pair of the row electrodes X and Y is formed on the rear side of the front transparent substrate 10. On a rear side (an opposite side to the side touching with the pair of the row electrodes) of the dielectric layer 12, a dielectric layer 12A for increasing height (hereinafter, referred to as “height increasing dielectric layer”) is formed in a portion corresponding to the area where the light absorbing layer 11 and the bus electrodes Xb and Yb adjacent to the light absorbing layer 11 are formed.

An MgO layer 13 is formed on a surface of the dielectric layer 12 and the height increasing dielectric layer 12A. The MgO layer 13 includes an MgO crystal (hereinafter, referred to as “CL emission MgO crystal”) as secondary electron emission material which performs a cathode luminescence (CL) emission with a peak value in a wavelength range of 200 to 300 nm, more especially, 230 to 250 nm excited by irradiation of an electron beam. The CL emission MgO crystal is obtained by gas phase-oxidizing magnesium vapor generated by heating magnesium, and has a poly-crystal structure with crystal of cube chained or a single crystal structure of cube. An average diameter of the CL emission MgO crystal is more than 2,000 Å (measured result by a BET method)

When a vaporous method MgO single crystal with a large average diameter more than 2,000 Å is to be formed, heating temperature in generation of magnesium vapor is required to be increased. For this reason, the length of a flame occurring due to reaction of magnesium and oxygen becomes long and thus a temperature difference between the flame and the periphery thereof is enlarged. Consequently, the larger the diameter of the MgO single crystal is, the more the MgO single crystals with an energy level corresponding to a peak wavelength (for example, around 235 nm, in a range of 230 to 250 nm) of the CL emission as mentioned above are formed.

The vaporous method MgO single crystal, which is generated by increasing an amount of magnesium vaporized per unit time to further enlarge a reaction zone of magnesium and oxygen and to react magnesium with more oxygen as compared to a general vapor oxidization method, has the energy level corresponding to the peak wavelength of the CL emission.

The MgO layer 13 is formed by attaching the CL emission MgO crystals to the surface of the dielectric layer 12 using a spray method or an electrostatic coating method. The MgO layer 13 may be formed by forming a thin film MgO layer on the surface of the dielectric layer 12 using a deposition method or a sputtering method and then attaching the CL emission MgO crystal thereon.

Meanwhile, each of the column electrodes D is arranged extending in an orthogonal direction with the pair of the row electrodes X and Y in a position opposite to the transparent electrodes Xa and Ya in the pair of the row electrodes X and Y on the rear substrate 14 disposed in parallel with the front transparent substrate 10. A column electrode protection layer 15 covering the column electrodes D is further formed on the rear substrate 14. Barrier ribs 16 are formed on the column electrode protection layer 15. The barrier ribs 16 are formed in a ladder-shape by two ribs such as a transverse rib 16A extending in a transverse direction in a two-dimensional display screen at a corresponding position to the bus electrodes Xb and Yb of each pair of the row electrodes and a longitudinal rib 16B extending in a longitudinal direction in a two-dimensional display screen at each middle position between the adjacent column electrodes D. Furthermore, the ladder shaped barrier ribs 16 as shown in FIG. 2 are formed in the respective display lines of the PDP 50. There exists a gap SL between the adjacent barrier ribs 16 as shown in FIG. 2. The ladder shaped barrier ribs 16 partitions separate discharge spaces S and the discharge cells PC including the transparent electrodes Xa and Ya. Discharge gases including xenon gas are sealed in the discharge spaces S. A fluorescent layer 17 is formed to cover a side of the transverse rib 16A, a side of the longitudinal rib 16B and the surface of the column electrode protection layer 15 in each discharge cell PC. The fluorescent layer 17 includes three kinds of phosphors such as a phosphor emitting a red color, a phosphor emitting a green color and a phosphor emitting a blue color.

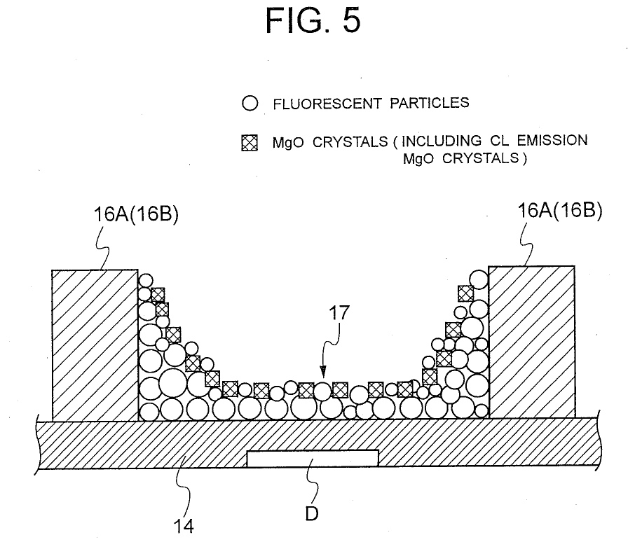

The MgO crystal (which includes the CL emission MgO crystal), for example with a form as shown in FIG. 5, as a secondary electron emission material, is included in the fluorescent layer 17. The MgO crystal, over a surface covering the discharge space S, that is, over a surface touching with the discharge space S, is exposed from the fluorescent layer 17 in order to contact with the discharge gases.

In this case, the discharge cell S and the gap SL in each discharge cell PC are closed to each other because the MgO layer 13 is in contact with the transverse ribs 16A, as shown in FIG. 3. Further, as shown in FIG. 4, there exist gaps r because the longitudinal ribs 16B are not in contact with the MgO layer 13. In other words, the respective discharge spaces S in the discharge cells PC adjacent to each other in a transverse direction in a two-dimensional display screen are connected through the gaps r.

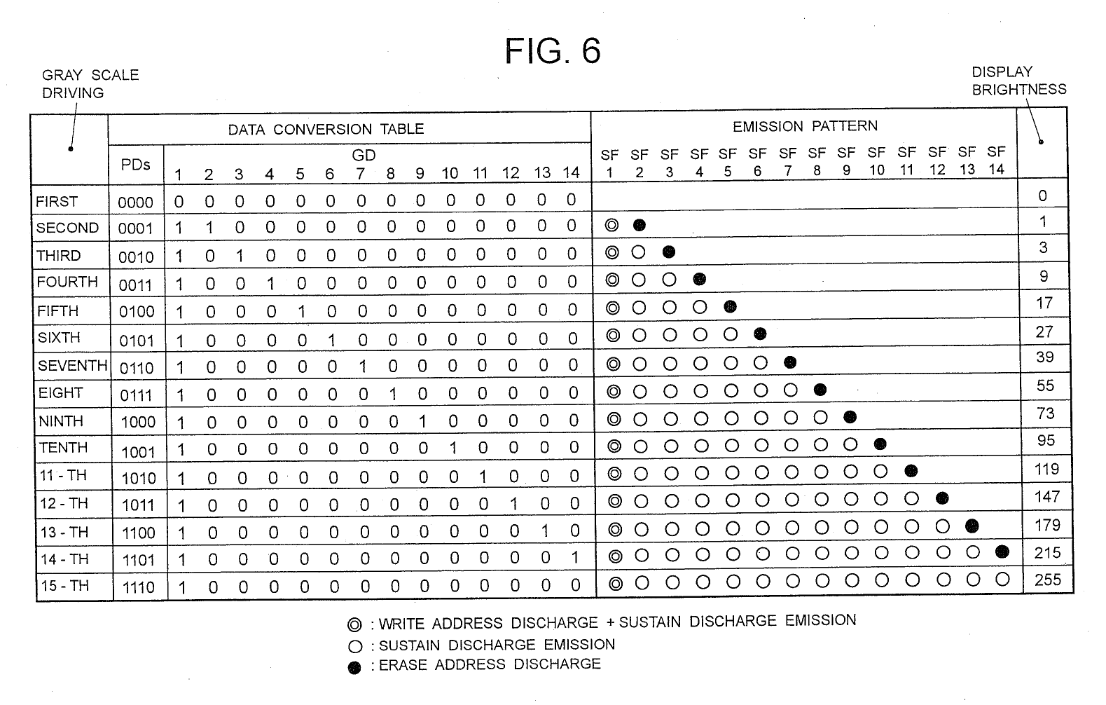

The driving control circuit 56 converts an input image signal into pixel data of 8 bits which represent the entire brightness levels with 256 gray scales for each pixel and then performs a multigrayscale processing comprising error diffusion and dithering process for the pixel data. In other words, in the error diffusion process, high-order 6 bits of the pixel data are allotted as display data and remaining low-order 2 bits thereof are allotted as error data, and then error-diffusion-processed pixel data of 6 bits are obtained by reflecting values to sum up weighted error data for pixel data corresponding to respective neighboring pixels on the display data. According to such error diffusion process, brightness corresponding to the low-order 2 bits for original pixel data is expressed pseudoly, and therefore brightness equal to pixel data of 8 bits using the display data of 6 bits less than 8 bits can be expressed. Subsequently, the driving control circuit 56 performs the dithering process for the error-diffusion-processed pixel data of 6 bits obtained by the error diffusion process. A plurality of pixels adjacent to each other form a pixel unit, and by allocating dithering coefficients having different values to the respective error-diffusion-processed pixel data corresponding to respective pixels in a pixel unit and adding them, and thus dither-addition pixel data are obtained, in the dithering process. According to addition of the dithering coefficients, in view of the pixel unit as stated above, only even high-order 4 bits of the dither-addition pixel data can express brightness corresponding to 8 bits. For this reason, the driving control circuit 56 converts the high-order 4 bits of the dither-addition pixel data into multigrayscale pixel data PDs of 4 bits which represent the entire brightness levels with 15 gray scales, as shown in FIG. 6. The driving control circuit 56 converts the multigrayscale pixel data PDs into pixel driving data GD of 14 bits on the basis of the data conversion table as shown in FIG. 6. The driving control circuit 56 allocates the first bit to the fourteenth bit of the pixel driving data GD to respective sub-fields SF1 to SF14 (described later) and provides the number of bits allocated to the sub-fields SF for the address driver 55 every display line (m) as pixel driving data bits.

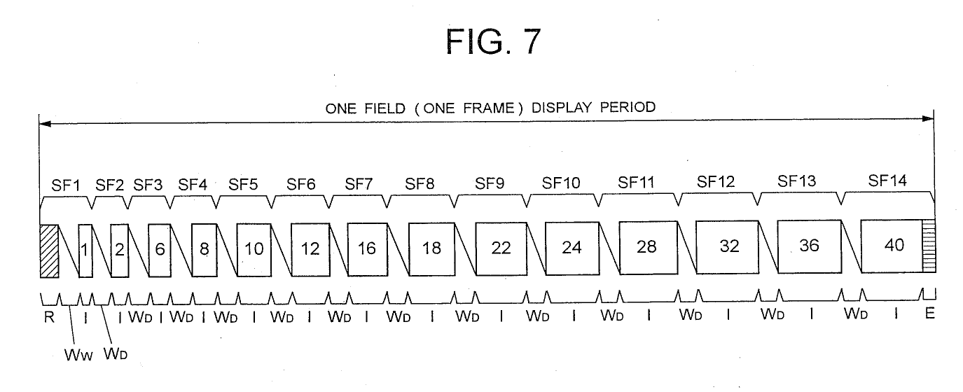

Further, the driving control circuit 56 provides various controls signals for driving the PDP 50 with the above-mentioned structure depending on the emission driving sequence as shown in FIG. 7 for panel drivers such as the X electrode driver 51, the Y electrode driver 53 and the address driver 55. In other words, the driving control circuit 56 provides the various control signals for sequential driving according to each of a resetting process R, a selective writing addressing process W_{W} and a sustaining process I for the panel drivers during the first sub-field SF1 within one field (one frame) display period as shown in FIG. 7. The driving control circuit 56 provides various control signals for sequential driving according to each of a selective erasing addressing process W_{D} and the sustaining process I for the panel drivers during the sub-fields SF2 to SF14. The driving control circuit 56 provides various control signals for sequentially driving according to an erase process E for the panel drivers only during the last sub-field SF14 after performing the sustaining process I.

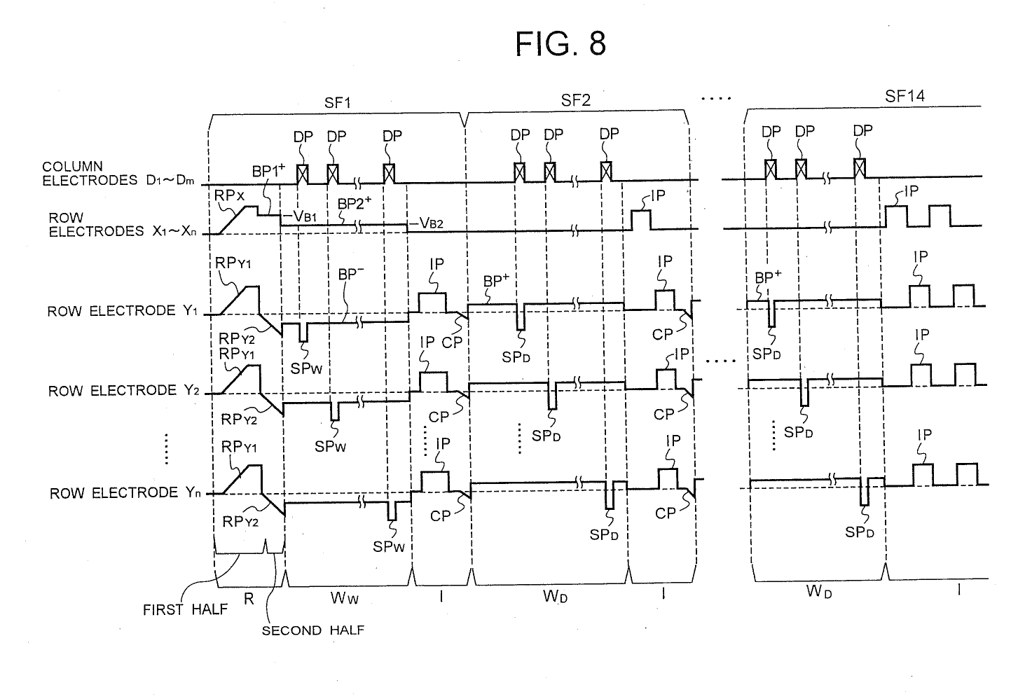

The panel drivers such as the X electrode driver 51, the Y electrode driver 53 and the address driver 55 generate various control pulses as shown in FIG. 8 on the basis of the various control signals from the driving control circuit 56, and provides them for the column electrodes D and the row electrodes X and Y of the PDP 50.

FIG. 8 represents extracted operations of the first sub-field SF1 and the sub-field SF2 subsequent thereto, and the last sub-field SF14 among the sub-fields SF1 to SF14 shown in FIG. 7.

First, the Y electrode driver 53 supplies reset pulses RP_{Y1} with a positive polarity (hereinafter, abbreviate as “positive reset pulses”) with gentle ramp waveforms relative to sustain pulses as stated later to the whole row electrodes Y₁ to Yₙ during the first half of the resetting process R in the sub-field SF1. The peak voltage of the reset pulse RP_{Y1} is higher than that of the sustain pulse. During this time, the address driver 55 sets the column electrodes D₁ to Dₘ to be grounded (0 volt). Responding to the reset pulses RP_{Y1}, the first reset discharge is generated between the row electrodes Y and the column electrodes D of the respective discharge cells PC. In other words, during the first half of the resetting process R, by applying a voltage across two electrodes such that the row electrodes Y are anode and the column electrodes D are cathode, a discharge in which currents flow from the row electrodes Y to the column electrodes D (hereinafter, referred to as “column cathode discharge”) is generated as the first reset discharge. By the first reset discharge, wall charges with a negative polarity (hereinafter, abbreviated as “negative wall charges”) around the row electrodes Y are formed and wall charges with a positive polarity (hereinafter, abbreviated as “positive wall charges”) are formed around the column electrodes D, in the whole discharge cells PC. Furthermore, during the first half of the resetting process R, the X electrode 51 applies reset pulses RP_{X} with the same polarity as the reset pulses RP_{Y1} and with a peak voltage capable of preventing a surface discharge, which accompanies the application of the reset pulses RP_{Y1}, between the row electrodes X and Y, to all of the row electrodes X₁ to Xₙ.

Subsequently, during the second half in the resetting process R, the Y electrode driver 53 generates reset pulses RP_{Y2} with a negative polarity (hereinafter, abbreviate as “negative reset pulses”) with ramp waveforms and supplies them to the whole row electrodes Y₁ to Yₙ. At the same time, the X electrode 51 supplies the first base pulses BP1⁺ with the first base voltage V_{B1} as a peak voltage with a positive polarity (hereinafter, abbreviated as “positive peak voltage”) to the respective row electrodes X₁ to Xₙ, during the second half of the resetting process R, all the time when the reset pulses RP_{Y2} are applied to the row electrodes Y. That is, the X electrode 51 applies the first base pulses BP1⁺ whose peak voltage is the first base voltage V_{B1} as shown in FIG. 8 to the whole row electrodes X. Depending on application of the negative reset pulses RP_{Y2} and the first positive base pulses BP1⁺, a second reset discharge is generated between the row electrodes X and Y in the whole discharge cells PC. Most of the wall charges formed around the row electrodes X and Y in the whole discharge cells PC are erased by the second reset discharge. This initializes the whole discharge cells PC into an OFF mode, that is, a tiny amount of the negative wall charges remain around the row electrodes X and a tiny amount of the positive wall charges remain around the row electrodes Y, respectively. Moreover, depending on application of the reset pulses RP_{Y2}, a weak discharge is generated between the row electrodes Y and the column electrodes D in the whole discharge cells PC to erase some of the positive wall charges formed around the column electrodes D. This adjusts an amount of the wall charges remaining around the column electrodes D in the whole discharge cells PC to an amount thereof capable of generating a selective writing address discharge properly in a selective writing addressing process W_{W} stated later.

Voltages applied to the row electrodes X and Y by the reset pulses RP_{Y2} and the first base pulses BP1⁺ certainly generate the second reset discharge between the row electrodes X and Y in consideration of the wall charges formed around the row electrodes X and Y by the first reset discharge. A negative peak voltage of the reset pulses RP_{Y2} is set to a voltage higher than a peak voltage of negative write scan pulses SP_{W} stated later, that is, a voltage close to 0 volt. In other words, when the peak voltage of the reset pulses RP_{Y2} is lower than that of the write scan pulses SP_{W}, a strong discharge is generated between the row electrodes Y and the column electrodes D to erase a lot of wall charges formed around the column electrodes D, and thus an address discharge becomes unstable in the selective writing addressing process W_{W}. Meanwhile, the peak voltage V_{B1} of the first base pulses BP1⁺ is higher than a peak voltage V_{B2} of a second base pulses BP2⁺ stated later.

In the selective writing addressing process W_{W} in the sub-field SF1, the Y electrode driver 53 supplies base pulses BP⁻ with a peak voltage with a negative peak voltage (hereinafter, abbreviated as “negative peak voltage”), as shown in FIG. 8, to the row electrodes Y₁ to Yₙ at the same time and supplies the write scan pulses SP_{W} with a negative peak voltage to the respective row electrodes Y₁ to Yₙ sequentially and selectively. The X electrode driver 51 continuously applies the second base pulses BP2⁺ with the second base voltage V_{B2} as a positive peak voltage to the row electrodes X₁ to Xₙ during this time. That is, the X electrode driver 51 applies the second base pulses BP2⁺ whose peak voltage is the second base voltage V_{B2} as shown in FIG. 8 to the whole row electrodes X. In this case, the peak voltage V_{B2} of the second base pulses BP2⁺ is lower than the peak voltage V_{B1} of the first base pulses BP1⁺. Voltages applied to the row electrodes X and Y by the second base pulses BP2⁺ and the base pulses BP⁻ are lower than discharge start voltages of the discharge cells PC.

In the selective writing addressing process W_{W}, the address driver 55 first converts pixel driving data bits corresponding to the sub-field SF1 into pixel data pulses DP having pulse voltages according to logic levels of the pixel driving data bits. For example, when the pixel driving data bits with logic level 1 which sets the discharge cells PC to be in an ON mode are supplied, the address driver 55 converts them into the pixel data pulses DP with a positive peak voltage. In the meantime, the address driver 55 converts the pixel driving data bits with logic level 0 which sets the discharge cells PC to be in an OFF mode into the pixel data pulses DP with a low voltage (0 volt). The address driver 55 applies the pixel data pulses DP of one display line (m) to the column electrodes D₁ to Dₘ synchronized with application timing of each write scan pulse SP_{W}. In this case, the selective writing address discharge is generated between the column electrodes D and the row electrodes Y in the discharge cells PC supplied with the pixel data pulses DP with a high voltage for setting them to be in an ON mode together with the write scan pulses SP_{W}. Weak discharge is generated between the row electrodes X and Y in the discharge cells PC right after the selective writing address discharge. Although voltages by the base pulses BP⁻ and the second base pulses BP2⁺ are applied to the row electrodes X and Y after the application of the write scan pulse SP_{W}, the voltages are set to be lower than the discharge start voltages for each discharge cell PC and thus there is no discharge in the discharge cells PC due to the application of the voltages. If, however, the selective writing address discharge is generated, just application of the base pulses BP⁻ and the second base pulses BP2⁺ generates a discharge between the row electrodes X and Y induced by the selective writing address discharge. The discharge cells PC are set to be in an ON mode, that is, positive wall charges are formed around the row electrodes Y, negative wall charges are formed around the row electrodes X, and negative wall charges are formed around the column electrodes D, by such discharge and the selective writing address discharge. In the meantime, the selective writing address discharge as mentioned above is not generated between the column electrodes D and the row electrodes Y in the discharge cells PC supplied with the pixel data pulses DP with a low voltage (0 volt) for setting them to be in an OFF mode together with the write scan pulses SP_{W}, and therefore a discharge is not generated between the row electrodes X and Y, either. Accordingly, the discharge cells PC maintain a previous state, that is, a state of an OFF mode initialized in the resetting process R.

Subsequently, the Y electrode driver 53 generates sustain pulses IP of one pulse with a positive peak voltage and applies them to the respective row electrodes Y₁ to Yₙ at the same time in the sustaining process I of the sub-field SF1. During this time, the X electrode driver 51 sets the row electrodes X₁ to Xₙ to be grounded (0 volt) and the address driver 55 sets the column electrodes D₁ to Dₘ to be grounded (0 volt). A sustain discharge is generated between the row electrodes X and Y in the discharge cells PC set to be in an ON mode as stated above by the application of the sustain pulses IP. Light from the fluorescent layer 17 by the sustain discharge is illuminated outwards through the front transparent substrate 10 and thus display emission of one time according to a brightness weight of the sub-field SF1 is performed by such sustain discharge. Furthermore, a discharge is also generated between the row electrodes Y and the column electrodes D in the discharge cells PC set to be in an ON mode by the application of the sustain pulses IP. Negative wall charges are formed around the row electrodes Y, and positive wall charges are formed around the row electrodes X and the column electrodes D, respectively, by such discharge and the sustain discharge. After applying the sustain pulses IP, the Y electrode driver 53 applies wall charge adjusting pulses CP having a negative peak voltage which smoothly changes with time at a lead edge to the whole row electrodes Y₁ to Yₙ, as shown in FIG. 8. Weak erase discharge is generated in the discharge cells PC which the sustain discharge has been generated as stated above, by the wall charge adjusting pulses CP and thus some of the wall charges remaining inner side thereof are erased. This adjusts an amount of the wall charges remaining in the whole discharge cells PC to an amount thereof capable of generating a selective erase address discharge properly in a selective erasing addressing process W_{D}.

Subsequently, in the selective erasing addressing process W_{D} in the sub-fields SF2 to SF14, the Y electrode driver 53 supplies base pulses BP⁺ with a positive peak voltage, as shown in FIG. 8, to the respective row electrodes Y₁ to Yₙ and supplies the erase scan pulses SP_{D} with a negative peak voltage to the respective row electrodes Y₁ to Yₙ sequentially and selectively. The magnitude of a voltage of the base pulses BP⁺ is set as a magnitude capable of preventing a misfiring between the row electrodes X and Y throughout the execution period of the selective erase address discharge process W_{D}. Throughout the selective erase address discharge process W_{D}, the X electrode driver 51 sets the row electrodes X₁ to Xₙ to be grounded (0 volt). In the selective erasing addressing process W_{D}, the address driver 55 first converts pixel driving data bits according to the sub-field SF into pixel data pulses DP having pulse voltages according to logic levels of the pixel driving data bits. For example, when the pixel driving data bits with logic level 1 which changes the discharge cells PC from an ON mode to an OFF mode are supplied, the address driver 55 converts them into the pixel data pulses DP with a positive peak voltage. In the meantime, the address driver 55 converts the pixel driving data bits with logic level 0 which maintains the discharge cells PC as they are into the pixel data pulses DP with a low voltage (0 volt). The address driver 55 applies the pixel data pulses DP of one display line (m) to the column electrodes D₁ to Dₘ synchronized with application timing of each erase scan pulse SP_{D}. In this case, the selective erase address discharge is generated between the column electrodes D and the row electrodes Y in the discharge cells PC supplied with the positive pixel data pulses DP with a high voltage together with the write scan pulses SP_{D}. By the selective erase address discharge, the discharge cells PC are set in an OFF mode, that is, positive wall charges around the row electrodes Y and X are formed and negative wall charges are formed around the column electrodes D, in the whole discharge cells PC. In the meantime, the selective erase address discharge as mentioned above is not generated between the column electrodes D and the row electrodes Y in the discharge cells PC supplied with the pixel data pulses DP with a low voltage (0 volt) together with the erase scan pulses SP_{D}. Accordingly, the discharge cells PC maintain a previous state (an OFF mode or an ON mode).

Subsequently, the X electrode driver 51 and the Y electrode driver 53 apply the sustain pulses IP with a positive peak voltage to the respective row electrodes X₁ to Xₙ and Y₁ to Yₙ, in the respective sustaining processes I of the sub-fields SF2 to SF14, alternately and repeatedly, as shown in FIG. 8. The sustain pulses IP are repeated as many as the number (even number) corresponding to the brightness weight of the sub-fields. Whenever the sustain pulses IP are applied, the sustain discharge is generated between the row electrodes X and Y in the discharge cells PC set to be in an ON mode. Light from the fluorescent layer 17 by the sustain discharge is illuminated outwards through the front transparent substrate 10 and thus display emission of the number of times according to the brightness weight of the sub-fields SF is performed by such sustain discharge. In this case, depending on last applied sustain pulses IP in the sustaining processes I of the respective sub-fields SF2 to SF14, negative charges are formed around the row electrodes Y and positive wall charges are formed around the row electrodes X and the column electrodes D, respectively, in the discharge cells PC which the sustain discharge has been generated. After applying the last sustain pulses IP, the Y electrode driver 53 generates wall charge adjusting pulses CP with a negative peak voltage with ramp waveforms as shown in FIG. 8 and supplies them to the row electrodes Y₁ to Yₙ. Weak erase discharge is generated in the discharge cells PC which the sustain discharge has been generated as stated above, by the wall charge adjusting pulses CP and thus some of the wall charges remaining inner side thereof are erased. This adjusts an amount of the wall charges remaining in the whole discharge cells PC to an amount thereof capable of generating a selective erase address discharge properly in a selective erasing addressing process W_{D}.

The Y electrode driver 53 applies erase pulses EP with a negative peak voltage to the whole row electrodes Y₁ to Yₙ, at the latest time period of the last sub-field SF14. Only discharge cells PC in an ON mode undertake the erase discharge by the application of the erase pulses EP. The erase discharge changes states of the discharge cells PC from an ON mode to an OFF mode.

The driving mentioned above is performed on the basis of fifteen pixel driving data GD as shown in FIG. 6. According to such driving, as shown in FIG. 6, except for expression of a brightness level of 0 (the first gray scale), the write address discharge (represented by double circle) occurs in the respective discharge cells PC during the first sub-field SF1, and the discharge cells PC are set in an ON mode. Thereafter, the selective erase address discharge (represented by black circle) occurs only in the selective erasing addressing process W_{D} of one among the sub-fields SF2 to SF14, and then the discharge cells PC are set in an OFF mode. That is, each of the discharge cells PC is set in an ON mode in the respective sub-fields as sequential as the number corresponding to middle brightness required to be expressed, and generate repeatedly emission of the number of times allotted to the respective sub-fields, accompanying the sustain discharge (represented by white circle). Brightness is visualized, which corresponds to a total number of the sustain discharge generated within one field (or one frame) display period. Therefore, according to fifteen emission patterns by the first gray scale driving to the fifteenth gray scale driving as shown in FIG. 6, the middle brightness as many as fifteen gray scales corresponding to a total number of the sustain discharge generated in the respective sub-fields represented by white circle is expressed. According to such driving, since time periods when emission patterns (a lit state and an unlit state) are reversed do not exist in one screen during one field display period, pseudo contour generated by such state is prevented.

Furthermore, the driving shown in FIG. 8 gets the number of the sustain pulses IP applied in the sustaining processes I of the respective sub-fields SF2 to SF14 to be an even number. Thus, since negative wall charges are formed around the row electrodes Y and positive wall charges are formed around the column electrodes D right after end of the respective sustaining processes I, a column anode discharge is possible in the selective erasing addressing process W_{D} following each sustaining process I. The column electrodes D is supplied with only positive pulses, which can prevent the address driver 55 from increasing a manufacturing cost.

Herein, the driving as shown in FIGS. 7 and 8 adopts what is called the selective erasing address method, according to which, after setting the discharge cells PC in an ON mode in the first sub-field SF1, the respective discharge cells PC in only one sub-filed among the subsequent sub-fields SF2 to SF14 is changed into an OFF mode.

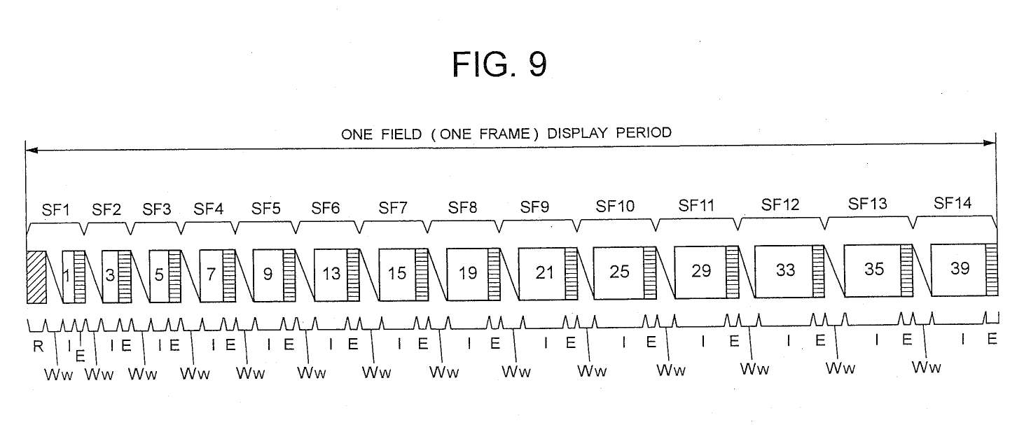

However, on driving the PDP 50, an emission driving sequence based on a selective writing address method as shown in FIG. 9 may be adopted in stead of the selective erasing address method as shown in FIG. 7.

In this case, the driving control circuit 56 supplies various control signals for sequential driving according to each of a selective writing addressing process W_{W}, a sustaining process I and an erasing process E in the sub-fields SF1 to SF14 as shown in FIG. 9, to the panel drivers. The driving control circuit 56 provides various control signals for sequentially driving according to a resetting process R for the panel drivers only in the first sub-field SF1 before the selective writing addressing process W_{W}.

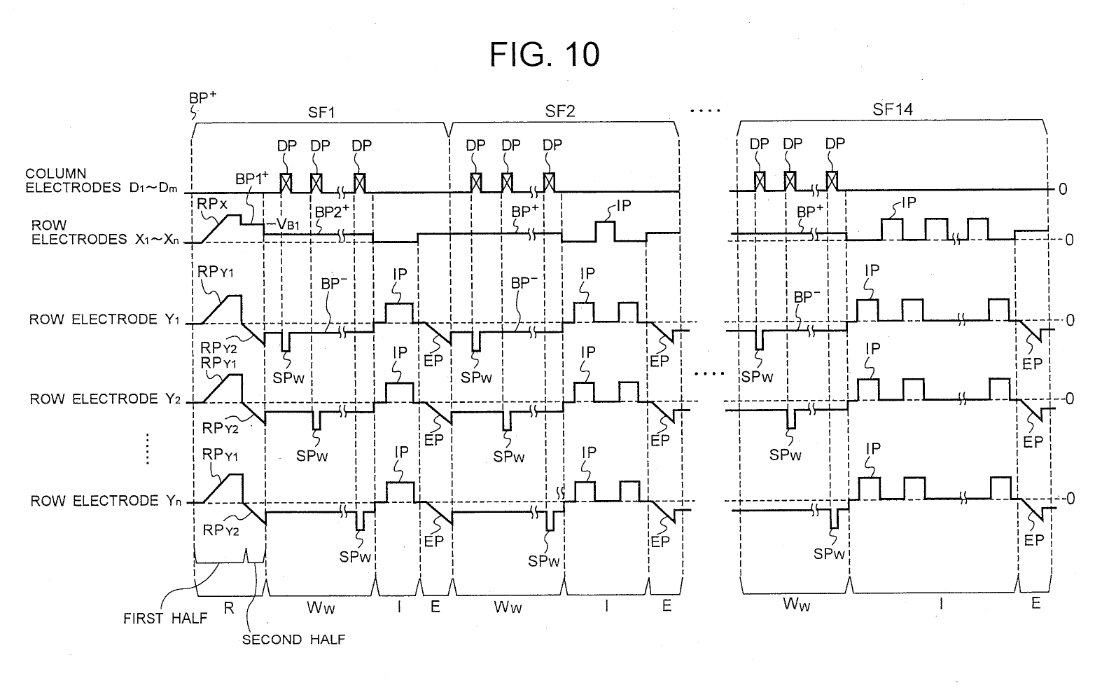

The panel drivers such as the X electrode driver 51, the Y electrode driver 53 and the address driver 55 generates various control pulses as shown in FIG. 10 on the basis of the various control signals from the driving control circuit 56, and provides them for the column electrodes D and the row electrodes X and Y of the PDP 50.

FIG. 10 represents extracted operations of the first sub-field SF1 and the sub-field SF2 subsequent thereto, and the last sub-field SF14 among the sub-fields SF1 to SF14 as shown in FIG. 9. In FIG. 10, the resetting process R and the selective writing addressing process W_{W} of the sub-field SF1 are the same as those shown in FIG. 8, and thus the description thereof will be omitted.

First, the Y electrode driver 53 generates sustain pulses IP of one pulse with a positive peak voltage and applies them to the respective row electrodes Y₁ to Yₙ at the same time in the sustaining process I of the sub-field SF1. During this time, the X electrode driver 51 sets the row electrodes X₁ to Xₙ to be grounded (0 volt) and the address driver 55 sets the column electrodes D₁ to Dₘ to be grounded (0 volt). A sustain discharge is generated between the row electrodes X and Y in the discharge cells PC set to be in an ON mode as stated above by the application of the sustain pulses IP. Light from the fluorescent layer 17 by the sustain discharge is illuminated outwards through the front transparent substrate 10 and thus display emission of one time according to a brightness weight of the sub-field SF1 is performed by such sustain discharge. Furthermore, A discharge is also generated between the row electrodes Y and the column electrodes D in the discharge cells PC set to be in an ON mode by the application of the sustain pulses IP. Negative wall charges are formed around the row electrodes Y, and positive wall charges are formed around the row electrodes X and the column electrodes D in the discharge cells PC, respectively, by such discharge and the sustain discharge.

Subsequently, the Y electrode driver 53 applies erase pulses EP with a negative peak voltage having the same waveform as the reset pulse RP_{Y2} which has been applied during the second half of the resetting process R, to the row electrodes Y₁ to Yₙ in the erasing processes E of the respective sub-fields SF1 to SF14. During this time, the X electrode 51 supplies base pulses BP⁺ with the predetermined voltage with a positive peak voltage to the respective row electrodes X₁ to Xₙ like the second half of the resetting process R. Weak erase discharge is generated in the discharge cells PC which the sustain discharge has been generated as stated above, by the erase pulses EP and the base pulses BP⁺. Some of the wall charges remaining in the discharge cells PC are erased and the discharge cells PC are changed into an OFF mode by the erase discharge. Furthermore, weak discharge is generated between the column electrodes D and the row electrodes Y in the discharge cells PC by the application of the erase pulse EP. Such discharge adjusts an amount of the wall charges formed around the column electrodes D to an amount thereof capable of generating a selective writing address discharge properly in a subsequent selective writing addressing process W_{W}.

Subsequently, the X electrode driver 51 and the Y electrode driver 53 apply the sustain pulses IP with a positive peak voltage V_{SUS} and a pulse width W_{b} to the respective row electrodes X₁ to Xₙ and Y₁ to Yₙ, in the respective sustaining processes I of the sub-fields SF2 to SF14, alternately and repeatedly, as shown in FIG. 10. The sustain pulses IP are repeated as many as the number corresponding to the brightness weight of the sub-fields. Whenever the sustain pulses IP are applied, the sustain discharge is generated between the row electrodes X and Y in the discharge cells PC set to be in an ON mode. Light from the fluorescent layer 17 by the sustain discharge is illuminated outwards through the front transparent substrate 10 and thus display emission of the number of times according to the brightness weight of the sub-fields is performed by such sustain discharge. A total number of the sustain pulses IP applied in the respective sustaining processes I is an odd number. That is, an initial sustain pulse IP and a final sustain pulse IP are applied together to the row electrodes Y in the respective sustaining processes I. Accordingly, right after end of the respective sustaining processes I, negative wall charges are formed around the row electrodes Y, and positive wall charges are formed around the row electrodes X and the column electrodes D, respectively, in the discharge cells PC where the sustain discharge has occurred. This causes a wall charge-formed-state in the respective discharge cells PC to be the same as a state right after the end of the first reset discharge in the resetting process R. Therefore, by applying the erase pulse EP with the same waveform as the reset pulse RP_{Y2} which is applied during the second half of the resetting process R in the erasing process E performed right thereafter, to the row electrodes Y, states of all of the discharge cells PC can be changed into an OFF mode.

Moreover, by generating the selective writing address discharge in the selective writing addressing processes W_{W} of the respective sequential sub-fields, the middle brightness as many as (N+1) (where, N is the number of sub-fields within one field display period) gray scales corresponding to a total number of the sustain discharge generated in the respective sub-fields is expressed likewise to the driving as shown in FIG. 7. That is, the middle brightness display as many as fifteen gray scales is made by fourteen sub-fields SF1 to SF14 similarly to that shown in FIG. 6.

Moreover, according to the driving based on the selective writing address method as shown in FIGS. 9 and 10, the middle brightness corresponding to 2^{N} (where, N is the number of sub-fields within one field display period) gray scales can be expressed by a mixture of sub-fields generating the selective writing address discharge in the whole sub-fields within one field display period. That is, in 14 sub-fields SF1 to SF14, there are 2¹⁴ as a mixture of sub-fields generating the selective writing address discharge, and thus the middle brightness corresponding to 16384 gray scales can be expressed.

According to the driving as shown in FIG. 10, since the reset pulses RP_{Y2} applied to the row electrodes Y in the resetting process R and the erase pulses EP applied to the row electrodes Y in the erasing process E have the same waveforms, both of two pulses can be generated by a common circuit. Since the selective writing addressing processes W_{W} are necessarily performed in the respective sub-fields SF1 to SF14, it is sufficient for a circuit for generating scan pulses to be made of one stage, and moreover it is enough to generate a general column anode discharge where the column electrodes are anodes, in the respective selective writing addressing processes W_{W}.

Accordingly, on driving the PDP 50, the panel drivers for generating the various driving pulses can be produced with a relatively low price when the driving based on the selective writing address method as shown in FIGS. 9 and 10 is adopted, instead of the driving based on the selective erasing address method as shown in FIGS. 7 and 8.

The driving as shown in FIGS. 7 and 8 or FIGS. 9 and 10 first initializes the whole discharge cells PC into an OFF mode by the reset discharge in the first sub-field SF1, and then changes it into an ON mode by generating the selective writing address discharge with respect to the respective discharge cells PC except for performing a black display (brightness level of 0). In case of the black display by the above driving, discharge generated through one field display period is only the reset discharge in the first sub-field SF1. Therefore, the above driving reduces the number of discharge generated within one field display period relative to the driving which first initializes the whole discharge cells PC into an ON mode by the reset discharge and then changes it into an OFF mode by generating the selective erase address discharge. Accordingly, according to such driving, a contrast in displaying a dark image, what is called a dark contrast can be improved.

The driving as shown in FIGS. 7 and 8 or FIGS. 9 and 10 applies a voltage across two electrodes such that the row electrodes Y are anode and the column electrodes D are cathode in the resetting process R of the head sub-field SF1, and thus generates the column cathode discharge in which currents flow from the row electrodes Y to the column electrodes D as the first reset discharge. Accordingly, at the time of the first reset discharge, cations in the discharge gas go toward and collide with the MgO crystal as the secondary electron emission material included in the fluorescent layer 17 as shown in FIG. 5 to emit the secondary electrons therefrom. The PDP 50 of the plasma display device as shown in FIG. 1 exposes the MgO crystal to the discharge space as shown in FIG. 5 to increase the possibility of collision with the cations, and thereby emitting the secondary electrons into the discharge space efficiently. This reduces discharge start voltages of the discharge cells PC due to priming works by such secondary electrons and thus a relatively weak reset discharge can be generated. Therefore, since the emission brightness accompanying the weak reset discharge decreases, display with an improved dark contrast is possible.

Furthermore, the driving as shown in FIG. 8 or FIG. 10 generates the first reset discharge between the row electrodes Y formed on the front transparent substrate 10 and the column electrodes D formed on the rear substrate 14 as shown in FIG. 3. Accordingly, light emitted from the front transparent substrate 10 to an outside decreases to increase the dark contrast much more than generation of the reset discharge between the row electrodes X and Y together formed on the front transparent substrate 10.

Furthermore, the driving as shown in FIG. 8 or FIG. 10 generates the second reset discharge for erase the wall charges in the respective discharge cells PC and initializes the whole discharge cells PC into an OFF mode, by applying the reset pulses RP_{Y2} to the whole row electrodes Y and also applies the first base pulses BP1⁺ to the whole row electrodes X, successive to the first reset discharge. In this case, the peak voltage V_{B1} of the first base pulses BP1⁺ applied to the row electrodes X for generating the second reset discharge is higher than the peak voltage V_{B2} of the second base pulses BP2⁺ applied to the row electrodes X in the selective writing addressing process W_{W} right after the resetting process R. That is, the voltages applied across the row electrodes X and Y are relatively high by the first base pulses BP1⁺ and the reset pulses RP_{Y2}, and thus a discharge intensity of the second reset discharge is increased. Therefore, the second reset discharge is generated by the first base pulses BP1⁺ and the reset pulses RP_{Y2} for erase the wall charges; however, a tiny amount of negative wall charges remain around the row electrodes X and a tiny amount of positive wall charges remain around the row electrodes Y in the whole discharge cells PC.

Thus, as shown in FIGS. 8 and 10, in a state that the second positive base pulses BP2⁺ are applied to the row electrodes X and the negative base pulses BP⁻ are applied to the row electrodes Y as well in the selective writing addressing process W_{W} right after the resetting process R, a discharge is difficult to be generated between the row electrodes X and Y. This prevents an erroneous discharge between the row electrodes X and Y when the negative write scan pulses SP_{W} are applied to the row electrodes Y and the pixel data pulses DP of 0 volt are applied to the column electrodes D for setting the whole discharge cells PC in the selective writing addressing process W_{W}.

The driving as shown in FIG. 8 or FIG. 10 increases display reproducibility for a low brightness image by applying the sustain pulses IP only one time in the sustaining process I of the sub-field SF1 with the lowest brightness weight such that the discharge number of the sustain discharges becomes one time. After the end of the sustain discharge generated by the sustain pulse IP of one time, negative wall charges are formed around the row electrodes Y and the positive wall charges are formed around the column electrodes D. This can generate a discharge in which the column electrodes D become anodes of the column electrodes D between the column electrodes D and the row electrodes Y (hereinafter, referred to as “column anode discharge”) as the selective erase address discharge in the selective erasing addressing process W_{D} of the sub-field SF2 when the driving as shown in FIG. 8 is performed.

For the PDP 50 as shown in FIG. 1, the CL emission MgO crystal as the secondary electron emission material is included not only in the MgO layer 13 formed on the front transparent substrate 10 but also in the fluorescent layer 17 formed on the rear substrate 14, in the respective discharge cells PC.

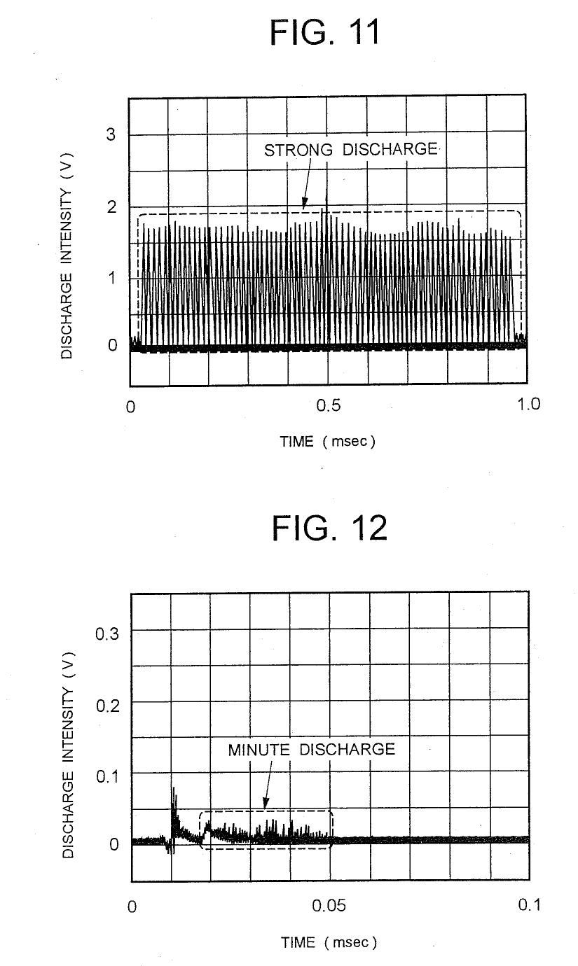

Effects by adoption of such structures will be described below with reference to FIGS. 11 and 12.

FIG. 11 represents a transition of discharge intensity in the column cathode discharge generated on applying the reset pulse RP_{Y1} as shown in FIG. 8 to a conventional PDP including the CL emission MgO crystal in only the MgO layer 13 of the MgO layer 13 and the fluorescent layer 17.

FIG. 12 represents a transition of discharge intensity in the column cathode discharge generated on applying the reset pulse RP_{Y1} to the PDP 50 according to the present invention, including the CL emission MgO crystal in both the MgO layer 13 and the fluorescent layer 17.

As shown in FIG. 11, by the application of the reset pulse RP_{Y1}, a relatively strong column cathode discharge continues for more than 1 ms in the conventional PDP; however, the column cathode discharge is completed within 0.04 ms in the PDP 50 according to the present invention as shown in FIG. 12. That is, the discharge delay time in the column cathode discharge can be largely reduced relatively to the conventional PDP.

Accordingly, as shown in FIG. 8, when the column cathode discharge is generated by the application of the reset pulses RP_{Y1} with a ramp waveform in a rising interval to the row electrodes Y of the PDP 50, the discharge is finished before the voltage of the reset pulse RP_{Y1} reaches the peak voltage thereof. Since the column cathode discharge is finished in a step where voltages applied across the row electrodes and the column electrodes are low, the discharge intensity, as shown in FIG. 12, is largely reduced relative to that shown in FIG. 9.

By applying pulses with a ramp waveform such as the reset pulses RP_{Y1} shown in FIG. 8 to the PDP 50 with the MgO layer 13 and the fluorescent layer 17 including the CL emission MgO crystal, the column cathode discharge with a weak discharge intensity is generated again. As above, since the column cathode discharge with a very weak discharge intensity can be generated as the reset discharge, contrast of images, especially, dark contrast on displaying dark images can be increased.

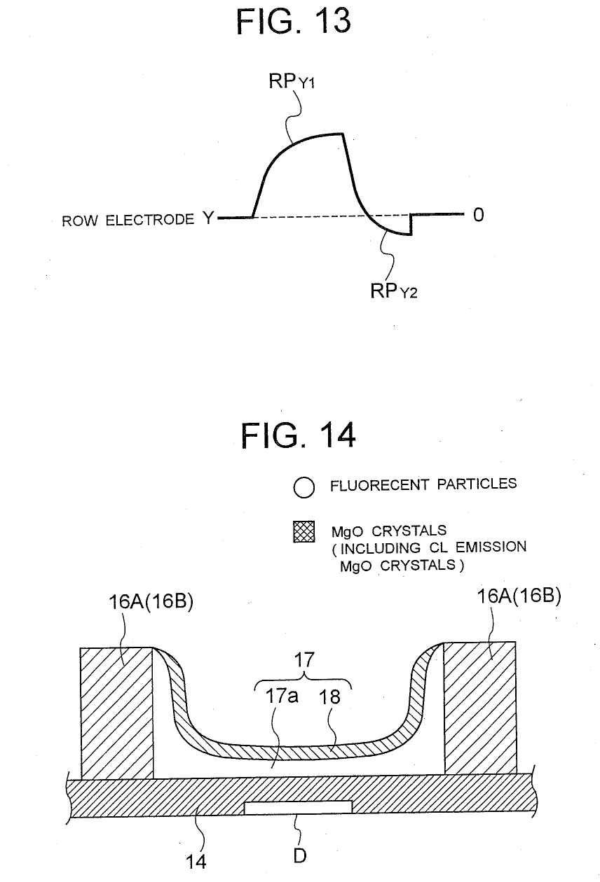

For the reset pulse RP_{Y1} as a waveform on rising, a slope thereof is not limited to constant as shown in FIG. 8, and, for example, it is enough for the slope thereof to be changed slowly as time goes by as shown in FIG. 13.

In the resetting processes R shown in FIGS. 8 and 10, the reset discharge is generated at one time for the whole pixel cells, but may be generated time-divisionally for each block including a plurality of pixel cells.

The MgO crystal is included in the fluorescent layer 17 formed on the rear substrate 14 of the PDP 50 in the embodiment shown in FIG. 5, but the MgO layer 17 may be formed by lamination of the fluorescent particle layer 17a made of fluorescent particles and the secondary electron emission layer 18 made of secondary electron emission material. In this case, the secondary electron emission layer 18 may be formed by filling crystal made of secondary electron emission material (e.g., MgO crystal including CL emission MgO crystal) on the surface of the fluorescent particle layer 17a, or may be formed by making the secondary electron emission material a thin-film.

### EMBODIMENT 2

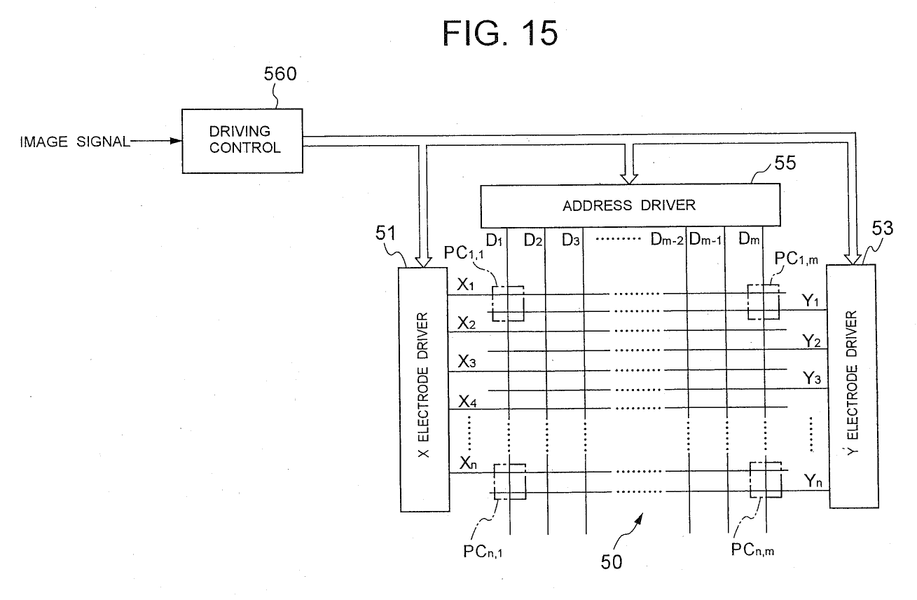

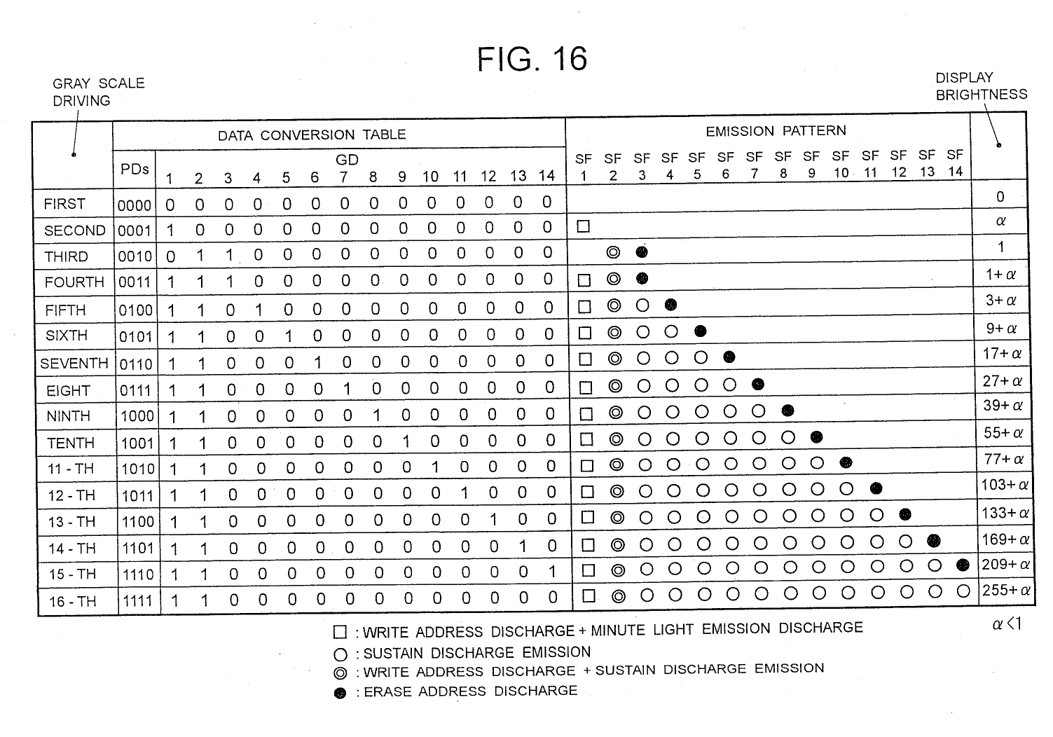

FIG. 15 is a schematic view of a plasma display device for driving a plasma display panel (PDP) according to a driving method by a second embodiment of the present invention.

The PDP 50 of the plasma display device shown in FIG. 15 has the same structure as those shown in FIGS. 1, 2 to 5 and 14. Each of an X electrode driver 51, a Y electrode driver 53 and an address electrode 55 shown in FIG. 15 operates like that shown in FIG. 1. However, in the plasma display device shown in FIG. 15, a driving method of the PDP 50 by a driving control circuit 560 is different from that shown in FIG. 1.

The driving control circuit 560 shown in FIG. 15 converts multigrayscale pixel data PDs of 4 bits obtained by performing the error diffusion process and the dithering process as stated above for pixel data of 8 bits for each pixel into pixel driving data GD of 14 bits based on a data conversion table as shown in FIG. 16. The driving control circuit 560 allocates the first bit to the fourteenth bit of the pixel driving data GD to respective sub-fields SF1 to SF14 and provides the number of bits allocated to the sub-fields SF for the address driver 55 every display line (m) as pixel driving data bits.

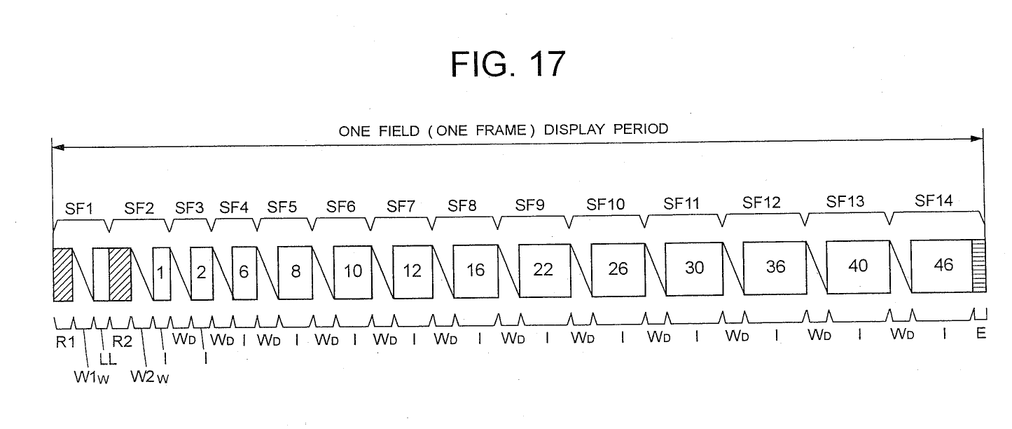

Further, the driving control circuit 560 provides various controls signals for driving the PDP 50 with the above-mentioned structure depending on the emission driving sequence as shown in FIG. 17 for panel drivers such as the X electrode driver 51, the Y electrode driver 53 and the address driver 55. The driving control circuit 560 supplies the various control signals for sequentially driving according to each of a first resetting process R1, a first selective writing addressing process W1_{W} and a minute light emission process LL for the panel drivers during the first sub-field SF1 within one field (one frame) display period. The driving control circuit 560 provides various control signals for sequential driving according to each of a second resetting process R2, a second selective writing addressing process W2_{W} and the sustaining process I for the panel drivers during the sub-filed SF2 subsequent to the first sub-field SF1. The driving control circuit 560 provides various control signals for sequentially driving according to each of a selective erasing addressing process W_{D} and the sustaining process I for the panel drivers during the sub-fields SF3 to SF14. The driving control circuit 560 provides various control signals for sequentially driving according to an erasing process E for the panel drivers only during the last sub-field SF14 in one field after performing the sustaining process I.

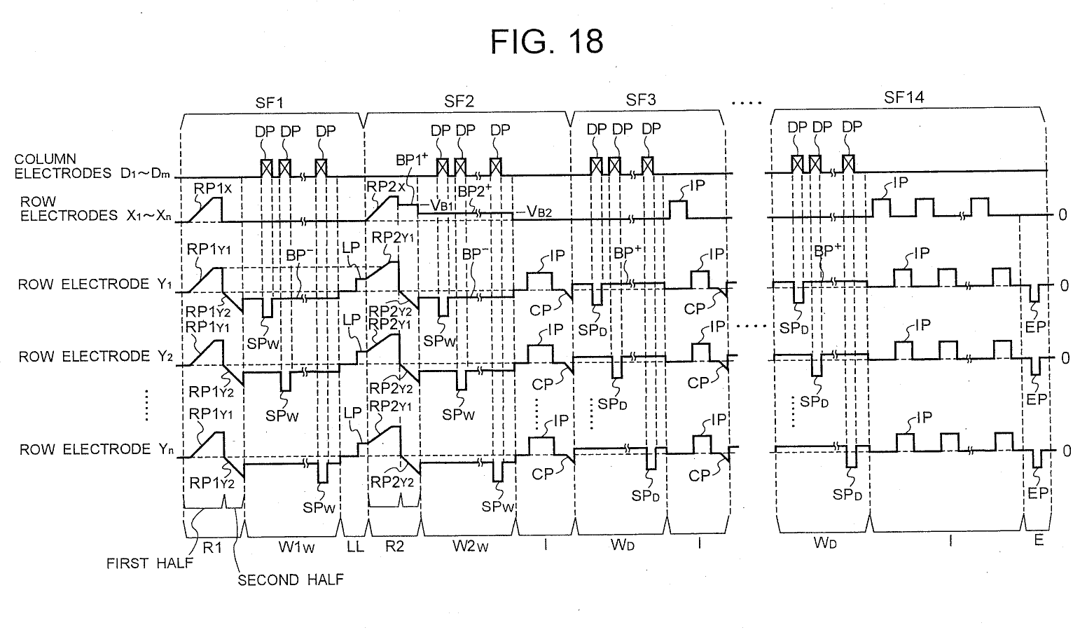

The panel drivers such as the X electrode driver 51, the Y electrode driver 53 and the address driver 55 generate various driving pulses as shown in FIG. 18 on the basis of the various control signals from the driving control circuit 560 for application to the column electrodes D and the row electrodes X and Y of the PDP 50.

FIG. 18 represents extracted operations of the sub-fields SF1 to SF3, and the last sub-field SF14 among the sub-fields SF1 to SF14 shown in FIG. 17.

First, the Y electrode driver 53 supplies reset pulses RP_{Y1} with a positive polarity (hereinafter, abbreviate as “positive reset pulses”) with smooth waveforms to the whole row electrodes Y₁ to Yₙ during the first half of the first resetting process R1 in the sub-field SF1. The peak voltage of the reset pulse RP_{Y1} is higher than that of the sustain pulse as shown in FIG. 18. During this time, the address driver 55 sets the column electrodes D₁ to Dₘ to be grounded (0 volt). Responding to the reset pulses RP_{Y1}, the first reset discharge is generated between the row electrodes Y and the column electrodes D of the respective discharge cells PC. In other words, during the first half of the first resetting process R1, by applying a voltage across two electrodes such that the row electrodes Y are anode and the column electrodes D are cathode, a discharge in which currents flow from the row electrodes Y to the column electrodes D (hereinafter, referred to as “column cathode discharge”) is generated as the first reset discharge. By the first reset discharge, wall charges with a negative polarity (hereinafter, abbreviated as “negative wall charges”) are formed around the row electrodes Y and wall charges with a positive polarity (hereinafter, abbreviated as “positive wall charges”) are formed around the column electrodes D, in the whole discharge cells PC.

Furthermore, during the first half of the first resetting process R1, the X electrode 51 applies reset pulses RP_{X} with the same polarity as the reset pulses RP_{Y1} and with a peak voltage capable of preventing a surface discharge, which accompanies the application of the reset pulses RP_{Y1}, between the row electrodes X and Y, to all of the row electrodes X₁ to Xₙ.

During the second half in the first resetting process R1 of the sub-field SF1, the Y electrode driver 53 generates reset pulses RP1_{Y2} with a negative polarity (hereinafter, abbreviate as “negative reset pulses”) with smooth waveforms for application to the whole row electrodes Y₁ to Yₙ, as shown in FIG. 18. The reset pulses RP1_{Y2} reach a negative peak voltage with a slow decrease in the slope. Depending on application of the reset pulses RP1_{Y2}, a second reset discharge is generated between the row electrodes X and Y in the whole discharge cells PC. The peak voltage of the reset pulses RP1_{Y2} certainly generates the second reset discharge between the row electrodes X and Y in consideration of the wall charges formed around the row electrodes X and Y by the first reset discharge to become a lowest voltage. The peak voltage of the reset pulses RP1_{Y2} is set to a voltage higher than a peak voltage of negative write scan pulses SP_{W} stated later, that is, a voltage close to 0 volt. In other words, when the peak voltage of the reset pulses RP1_{Y2} is lower than that of the write scan pulses SP_{W}, a strong discharge is generated between the row electrodes Y and the column electrodes D to erase a lot of wall charges formed around the column electrodes D, and thus an address discharge becomes unstable in a first selective writing addressing process W1_{W} stated later. Wall charges formed around the row electrodes X and Y in the whole discharge cells PC are erased by the second reset discharge in the second half of the first resetting process R1, and the whole discharge cells PC are initialized into an OFF mode. Moreover, depending on application of the reset pulses RP1_{Y2}, a weak discharge is generated between the row electrodes Y and the column electrodes D in the whole discharge cells PC to erase some of the positive wall charges formed around the column electrodes D. This adjusts an amount of the wall charges remaining around the column electrodes D in the whole discharge cells PC to an amount thereof capable of generating a selective writing address discharge properly in the first selective writing addressing process W1_{W}.

In the first selective writing addressing process W1_{W} in the sub-field SF1, the Y electrode driver 53 supplies base pulses BP⁻ with a peak voltage with a negative polarity (hereinafter, abbreviated as “negative peak voltage”), as shown in FIG. 18, to the row electrodes Y₁ to Yₙ at the same time and supplies the write scan pulses SP_{W} with a negative peak voltage to the respective row electrodes Y₁ to Yₙ sequentially and selectively. During this time, the X electrode driver 51 applies a voltage of 0 volt to the row electrodes X₁ to Xₙ. Additionally, in the selective writing addressing process W1_{W}, the address driver 55 first generates pixel data pulses DP according to logic levels of the pixel driving data bits corresponding to the sub-field SF1. For example, when the pixel driving data bits with logic level 1 which sets the discharge cells PC to be in an ON mode are supplied, the address driver 55 generates the pixel data pulses DP with a positive peak voltage. In the meantime, the address driver 55 generates the pixel data pulses DP with a low voltage (0 volt) according to the pixel driving data bits with logic level 0 which sets the discharge cells PC to be in an OFF mode. The address driver 55 applies the pixel data pulses DP of one display line (m) to the column electrodes D1 to Dm synchronized with application timing of each write scan pulse SP_{W}. In this case, the selective writing address discharge is generated between the column electrodes D and the row electrodes Y in the discharge cells PC supplied with the pixel data pulses DP with a high voltage for setting them to be in an ON mode together with the write scan pulses SP_{W}. Weak discharge is generated between the row electrodes X and Y in the discharge cells PC right after the selective writing address discharge. Although voltages by the base pulses BP⁻ are applied to the row electrodes X and Y after the application of the write scan pulse SP_{W}, the voltages are set to be lower than the discharge start voltages for each discharge cell PC and thus there is no discharge in the discharge cells PC due to the application of the voltages. If, however, the selective writing address discharge is generated, just application of the base pulses BP⁻ generates a discharge between the row electrodes X and Y induced by the selective writing address discharge. The discharge cells PC are set to be in an ON mode, that is, positive wall charges are formed around the row electrodes Y, negative wall charges are formed around the row electrodes X, and negative wall charges are formed around the column electrodes D, by such discharge and the selective writing address discharge. In the meantime, the selective writing address discharge as mentioned above is not generated between the column electrodes D and the row electrodes Y in the discharge cells PC supplied with the pixel data pulses DP with a low voltage (0 volt) for setting them to be in an OFF mode together with the write scan pulses SP_{W}, and therefore a discharge is not generated between the row electrodes X and Y, either. Accordingly, the discharge cells PC maintain a previous state, that is, a state of an OFF mode initialized in the resetting process R.

Subsequently, in the minute light emission process LL in the sub-field SF1, the Y electrode driver 53 supplies minute light emission pulses LP with a predetermined positive peak voltage, as shown in FIG. 18, to the row electrodes Y₁ to Yₙ at the same time. By the application of the minute light emission pulses LP, a discharge (hereinafter, referred to as “minute light emission discharge”) between the column electrodes D and the row electrodes Y in the discharge cells PC set to be in an ON mode is generated. Although the discharge is generated between the row electrodes Y and the column electrodes D in the discharge cells PC in the minute light emission process LL, voltages with a magnitude which cannot generate a discharge between the row electrodes X and Y is applied to the row electrodes Y and thus the minute light emission discharge is generated only between the column electrodes D and row electrodes Y in the discharge cells PC set to be in an ON mode. In this case, the peak voltage of the minute light emission pulses LP is lower than that of sustain pulses IP applied in a sustaining process I after the sub-field SF2 described later, and, for example, is the same as a voltage applied to the row electrode Y in a selective erasing addressing process W_{D} described later. As shown in FIG. 18, a rate of change with time in a rising interval of the voltage of the minute light emission pulse LP is larger than that in a rising interval of the voltage of the reset pulses RP1_{Y1} and RP2_{Y1}. That is, the voltage change in the leading edge of the minute light emission pulse LP becomes larger than that in the leading edge of the reset pulse in order to generate stronger than the first discharge generated in the first resetting process R1. Such discharge is the column cathode discharge as described above, and since the discharge is generated by the weak emission pulse LP with a lower peak voltage than the sustain pulse IP, emission brightness accompanying the discharge is lower than that accompanying a sustain discharge (described later) generated between the row electrodes X and Y. In other words, although the discharge in the minute light emission discharge LL accompanies emission with higher brightness level than the first reset discharge, the discharge is lower than the sustain discharge in the brightness level accompanying it, that is, a discharge accompanying a weak discharge of a degree available for display is generated as the minute light emission discharge. In this case, the selective writing address discharge is generated between the column electrodes D and the row electrodes Y in the discharge cells PC in the first selective writing addressing process W1_{W} performed right before the minute light emission process LL. Accordingly, in the sub-field SF1, by emission accompanying both the selective writing address discharge and minute light emission discharge, brightness corresponding to a gray scale as high as 1 level compared with brightness level of is expressed.

After the minute light emission discharge, negative wall charges are formed around the row electrodes Y and positive wall charges are formed around the column electrodes D.

Subsequently, the Y electrode driver 53 supplies positive reset pulses RP2_{Y1} with gentle smooth waveforms relative to sustain pulses as stated later to the whole row electrodes Y₁ to Yₙ during the first half of the second resetting process R2 in the sub-field SF2. The peak voltage of the reset pulse RP2_{Y1} is higher than that of the reset pulse RP1_{Y1}, as shown in FIG. 18. During this time, the address driver 55 sets the column electrodes D₁ to Dₘ to be grounded (0 volt), and the X electrode 51 applies positive reset pulses RP2_{X} with a peak voltage capable of preventing a surface discharge, which accompanies the application of the reset pulses RP2_{Y1}, between the row electrodes X and Y, to all of the row electrodes X₁ to Xₙ. Only if the surface discharge between the row electrodes X and Y is prevented, the X electrode 51 may set all of the row electrodes X₁ to Xₙ to be grounded (0 volt) instead of the application of reset pulses RP2_{X}. Depending on application of the reset pulses RP2_{Y1}, the first reset discharge weaker than the column cathode discharge in the minute light emission process LL is generated between the row electrodes Y and the column electrodes D in the discharge cells PC where the column cathode discharge has not been generated in the minute light emission process LL among the respective discharge cells PC. By applying a voltage across two electrodes such that the row electrodes Y are anode and the column electrodes D are cathode, and thus the column cathode discharge in which currents flow from the row electrodes Y to the column electrodes D is generated as the first reset discharge in the first half of the second resetting process R2. Meanwhile, there is no discharge by the application of the reset pulse RP2_{Y1} in the discharge cells PC where the discharge has been generated already in the minute light emission process LL. Right after the first half of the second resetting process R2, negative wall charges are formed around the row electrodes Y and positive wall charges are formed around the column electrodes D in the whole discharge cells PC.

During the second half in the second resetting process R2 of the sub-field SF2, the Y electrode driver 53 applies reset pulses RP2_{Y2} with a negative polarity (hereinafter, abbreviate as “negative reset pulses”) with smooth waveforms to the row electrodes Y₁ to Yₙ as shown in FIG. 18. The reset pulses RP2_{Y2} reach a negative peak voltage with a slow decrease in the slope. At the same time, the X electrode 51 supplies the first base pulses BP1⁺ with the first base voltage V_{B1} as a positive peak voltage to the respective row electrodes X₁ to Xₙ, during the second half of the second resetting process R2, all through the application of the reset pulses RP2_{Y2} to the row electrodes Y. That is, the X electrode 51 applies the first base pulses BP1⁺ whose peak voltage is the first base voltage V_{B1} as shown in FIG. 18 to the whole row electrodes X. Depending on application of the negative reset pulses RP2_{Y2} and the first positive base pulses BP1⁺, a second reset discharge is generated between the row electrodes X and Y in the whole discharge cells PC. Most of the wall charges formed around the row electrodes X and Y in the whole discharge cells PC are erased by the second reset discharge. This initializes the whole discharge cells PC into an OFF mode, that is, a tiny amount of the negative wall charges remain around the row electrodes X and a tiny amount of the positive wall charges remain around the row electrodes Y, respectively. Moreover, depending on application of the reset pulses RP2_{Y2}, a weak discharge is generated between the row electrodes Y and the column electrodes D in the whole discharge cells PC to erase some of the positive wall charges formed around the column electrodes D. This adjusts an amount of the wall charges remaining around the column electrodes D in the whole discharge cells PC to an amount thereof capable of generating a selective writing address discharge properly in a second selective writing addressing process W2_{W}.

Voltages applied to the row electrodes X and Y by the reset pulses RP2_{Y2} and the first base pulses BP1⁺ certainly generate the second reset discharge between the row electrodes X and Y in consideration of the wall charges formed around the row electrodes X and Y by the first reset discharge. A negative peak voltage of the reset pulses RP2_{Y2} is set to a voltage higher than a peak voltage of negative write scan pulses SP_{W} stated later, that is, a voltage close to 0 volt. In other words, when the peak voltage of the reset pulses RP2_{Y2} is lower than that of the write scan pulses SP_{W}, a strong discharge is generated between the row electrodes Y and the column electrodes D to erase a lot of wall charges formed around the column electrodes D, and thus an address discharge becomes unstable in the selective writing addressing process W2_{W}. Meanwhile, the peak voltage V_{B1} of the first base pulses BP1⁺ is higher than a peak voltage V_{B2} of a second base pulses BP2⁺ stated later.

In the second selective writing addressing process W2_{W} in the sub-field SF2, the Y electrode driver 53 supplies base pulses BP⁻ with a predetermined peak voltage with a negative peak voltage (hereinafter, abbreviated as “negative peak voltage”), as shown in FIG. 18, to the row electrodes Y₁ to Yₙ at the same time and supplies the write scan pulses SP_{W} with a negative peak voltage to the respective row electrodes Y₁ to Yₙ sequentially and selectively. The X electrode driver 51 continuously applies the second base pulses BP2⁺ with the second base voltage V_{B2} as a positive peak voltage to the row electrodes X₁ to Xₙ during this time. That is, the X electrode driver 51 applies the second base pulses BP2⁺ whose peak voltage is the second base voltage V_{B2} as shown in FIG. 18 to the whole row electrodes X. In this case, the peak voltage V_{B2} of the second base pulses BP2⁺ is lower than the peak voltage V_{B1} of the first base pulses BP1⁺. Voltages applied to the row electrodes X and Y by the second base pulses BP2⁺ and the base pulses BP⁻ are lower than discharge start voltages of the discharge cells PC. Additionally, in the second selective writing addressing process W2_{W}, the address driver 55 first generates pixel data pulses DP according to logic levels of the pixel driving data bits corresponding to the sub-field SF2. For example, when the pixel driving data bits with logic level 1 which sets the discharge cells PC to be in an ON mode are supplied, the address driver 55 generates the pixel data pulses DP with a positive peak voltage. In the meantime, the address driver 55 generates the pixel data pulses DP with a low voltage (0 volt) according to the pixel driving data bits with logic level 0 which sets the discharge cells PC to be in an OFF mode. The address driver 55 applies the pixel data pulses DP of one display line (m) to the column electrodes D₁ to Dₘ synchronized with application timing of each write scan pulse SP_{W}. In this case, the selective writing address discharge is generated between the column electrodes D and the row electrodes Y in the discharge cells PC supplied with the pixel data pulses DP with a high voltage for setting them to be in an ON mode together with the write scan pulses SP_{W}. Weak discharge is generated between the row electrodes X and Y in the discharge cells PC right after the selective writing address discharge. Although voltages by the base pulses BP⁻ and the second base pulses BP2⁺ are applied to the row electrodes X and Y after the application of the write scan pulse SP_{W}, the voltages are set to be lower than the discharge start voltages for each discharge cell PC and thus there is no discharge in the discharge cells PC due to the application of the voltages. If, however, the selective writing address discharge is generated, just application of the base pulses BP⁻ and the second base pulses BP2⁺ generates a discharge between the row electrodes X and Y induced by the selective writing address discharge. The discharge cells PC are set to be in an ON mode, that is, positive wall charges are formed around the row electrodes Y, negative wall charges are formed around the row electrodes X, and negative wall charges are formed around the column electrodes D, by such discharge and the selective writing address discharge. In the meantime, the selective writing address discharge as mentioned above is not generated between the column electrodes D and the row electrodes Y in the discharge cells PC supplied with the pixel data pulses DP with a low voltage (0 volt) for setting them to be in an OFF mode together with the write scan pulses SP_{W}, and therefore a discharge is not generated between the row electrodes X and Y, either. Accordingly, the discharge cells PC maintain a previous state, that is, a state of an OFF mode initialized in the second resetting process R2.

Subsequently, the Y electrode driver 53 generates sustain pulses IP of one pulse with a positive peak voltage and applies them to the respective row electrodes Y₁ to Yₙ at the same time in the sustaining process I of the sub-field SF2. During this time, the X electrode driver 51 sets the row electrodes X₁ to Xₙ to be grounded (0 volt) and the address driver 55 sets the column electrodes D₁ to Dₘ to be grounded (0 volt). A sustain discharge is generated between the row electrodes X and Y in the discharge cells PC set to be in an ON mode by the application of the sustain pulses IP. Light from the fluorescent layer 17 by the sustain discharge is illuminated outwards through the front transparent substrate 10 and thus display emission of one time according to a brightness weight of the sub-field SF1 is performed by such sustain discharge. Furthermore, A discharge is also generated between the row electrodes Y and the column electrodes D in the discharge cells PC set to be in an ON mode by the application of the sustain pulses IP. Negative wall charges are formed around the row electrodes Y, and positive wall charges are formed around the row electrodes X and the column electrodes D, respectively, by such discharge and the sustain discharge.

Subsequently, in the selective erasing addressing process W_{D} in the sub-fields SF3 to SF14, the Y electrode driver 53 supplies base pulses BP⁺ with a positive peak voltage to the respective row electrodes Y₁ to Yₙ and supplies the erase scan pulses SP_{D} with a negative peak voltage to the respective row electrodes Y₁ to Yₙ sequentially and selectively, as shown in FIG. 18. The magnitude of a voltage of the base pulses BP⁺ is set as a magnitude capable of preventing a misfiring between the row electrodes X and Y throughout the execution period of the selective erase address discharge process W_{D}. Throughout the execution period of the selective erase address discharge process W_{D}, the X electrode driver 51 sets the row electrodes X₁ to Xₙ to be grounded (0 volt). In the selective erasing addressing process W_{D}, the address driver 55 first converts pixel driving data bits according to the sub-field SF into pixel data pulses DP having pulse voltages according to logic levels of the pixel driving data bits. For example, when the pixel driving data bits with logic level 1 which changes the discharge cells PC from an ON mode to an OFF mode are supplied, the address driver 55 converts them into the pixel data pulses DP with a positive peak voltage. In the meantime, the address driver 55 converts the pixel driving data bits with logic level 0 which maintains the discharge cells PC as they are into the pixel data pulses DP with a low voltage (0 volt). The address driver 55 applies the pixel data pulses DP of one display line (m) to the column electrodes D₁ to Dₘ synchronized with application timing of each erase scan pulse SP_{D}. In this case, the selective erase address discharge is generated between the column electrodes D and the row electrodes Y in the discharge cells PC supplied with the pixel data pulses DP with a high voltage together with the write scan pulses SP_{D}. By the selective erase address discharge, the discharge cells PC are set in an OFF mode, that is, positive wall charges are formed around the row electrodes Y and X and negative wall charges are formed around the column electrodes D, in the whole discharge cells PC. In the meantime, the selective erase address discharge as mentioned above is not generated between the column electrodes D and the row electrodes Y in the discharge cells PC supplied with the pixel data pulses DP with a low voltage (0 volt) together with the erase scan pulses SP_{D}. Accordingly, the discharge cells PC maintain a previous state (an OFF mode or an ON mode).

Moreover, the X electrode driver 51 and the Y electrode driver 53 apply the sustain pulses IP with a positive peak voltage to the respective row electrodes Y₁ to Yₙ and X₁ to Xₙ, in the respective sustaining processes I of the sub-fields SF3 to SF14, alternately in row electrodes Y and X and repeatedly, as shown in FIG. 18. The sustain pulses IP are repeated as many as the number corresponding to the brightness weight of the sub-fields. Whenever the sustain pulses IP are applied, the sustain discharge is generated between the row electrodes X and Y in the discharge cells PC set to be in an ON mode. Light from the fluorescent layer 17 by the sustain discharge is illuminated outwards through the front transparent substrate 10 and thus display emission of the number of times according to the brightness weight of the sub-fields SF is performed by such sustain discharge.

The Y electrode driver 53 applies erase pulses EP with a negative peak voltage to the whole row electrodes Y₁ to Yₙ, after the end of the sustaining process I of the last sub-field SF14. Only discharge cells PC in an ON mode undertake the erase discharge by the application of the erase pulses EP. The erase discharge changes states of the discharge cells PC from an ON mode to an OFF mode.

The driving mentioned above is performed on the basis of sixteen pixel driving data GD as shown in FIG. 16.

For the second gray scale expressing brightness 1 level higher than the first gray scale expressing a black display (brightness level of 0), as shown in FIG. 16, the selective writing address discharge is generated in only the sub-field SF1 among the sub-field SF1 to SF14 for setting the discharge cells PC to be in an ON mode, and the minute light emission discharge is generated in the discharge cells PC set to be in the ON mode (represented by □). A brightness level on emission accompanying the selective writing address discharge and the minute light emission discharge is lower than that on emission accompanying the sustain discharge of one time. Accordingly, when a brightness level visualized by the sustain discharge is assumed to be [1], brightness corresponding to a brightness level of [α] lower than the brightness level of [1] is expressed by the second gray scale.

For the third gray scale expressing brightness 1 level higher than the second gray scale, the selective writing address discharge is generated in only the sub-field SF2 among the sub-field SF1 to SF14 for setting the discharge cells PC to be in an ON mode (represented by double circle), and then the selective erase address discharge is generated in the subsequent sub-field SF3 such that the discharge cells PC are changed into an OFF mode (represented by black circle). Therefore, emission accompanying the sustain discharge of one time in only the sustaining process I of the sub-field SF2 among the sub-fields SF1 to SF14 is made for the third gray scale, and brightness according to a brightness level of [1] is expressed.

For the fourth gray scale expressing brightness 1 level higher than the third gray scale, the selective writing address discharge is first generated in only the sub-field SF1 among the sub-field SF1 to SF14 for setting the discharge cells PC to be in an ON mode, and the minute light emission discharge is generated in the discharge cells PC set to be in the ON mode (represented by □). For the fourth gray scale, the selective writing address discharge is generated in only the sub-field SF2 among the sub-field SF1 to SF14 for setting the discharge cells PC to be in an ON mode (represented by double circle), and then the selective erase address discharge is generated in the subsequent sub-field SF3 such that the discharge cells PC are changed into an OFF mode (represented by black circle). Therefore, for the fourth gray scale, emission corresponding to a brightness level of [α] in the sub-filed SF1 is made and emission corresponding to a brightness level of [1] accompanying the sustain discharge of one time in the sub-field SF2 is made, and thus brightness corresponding to a brightness level of [α]+[1] is expressed.

For the fifth gray scale through the sixteenth gray scale, the selective writing address discharge is first generated in the sub-field SF1 for setting the discharge cells PC to be in an ON mode, and the minute light emission discharge is generated in the discharge cells PC set to be in the ON mode (represented by □). The selective erase address discharge is generated in the only one sub-field corresponding to the gray scales such that the discharge cells PC are changed into an OFF mode (represented by black circle). Thus, for each of the fifth gray scale through the sixteenth gray scale, after the minute light emission discharge is generated in the sub-filed SF1 and the sustain discharge of one time is generated in the sub-field 2, the sustain discharge is generated as many as the number of times allotted to the sub-fields in the respective sub-fields as subsequent as the number corresponding to the gray scales (represented by white circle). This visualizes brightness corresponding to brightness levels of [α]+[a total number of the sustain discharge generated in one field (or one frame) display period] for each of the fifth gray scale through the sixteenth gray scale. Therefore, according to the driving shown in FIGS. 16 to 18, a brightness range with the brightness levels of [0] to [255+α] can be expressed by the sixteen levels as shown in FIG. 16.

In this case, the driving shown in FIGS. 16 to 18 generates the minute light emission discharge instead of the sustain discharge as a discharge contributed to a display image in the sub-field SF1 with the lowest brightness weight. Such minute light emission discharge is generated between the column electrodes D and the row electrodes Y and thus has a lower brightness level on emission accompanying it than the sustain discharge generated in the row electrodes X and Y. Therefore, in case of expressing brightness (the second gray scale) as high as 1 level relative to a black display (brightness level of 0), the minute light emission discharge reduces a brightness difference with level 0 relative to the sustain discharge. With this, gray scale display ability on displaying an image with low brightness increases. Moreover, for the second gray scale, the reset discharge is not generated in the second resetting process R2 of the sub-field SF2 subsequent to the sub-field SF1, and thus a drop of dark contrast accompanying the reset discharge is obstructed. Although the driving as shown in FIG. 16 also generates the minute light emission discharge accompanying emission of a brightness level of a in the sub-field SF1 for the respective gray scales after the fourth gray scale, the minute light emission discharge may not be generated for the gray scales after the third gray scale. To summarize, since emission accompanying the minute light emission discharge expresses a very low brightness (brightness level of α), the sustain discharge accompanying emission higher than the minute light emission discharge is generated together with the minute light emission discharge for the gray scales after the fourth gray scale and thus a brightness increment of a brightness level of α cannot be visualized. This makes vain efforts to generate the minute light emission discharge.

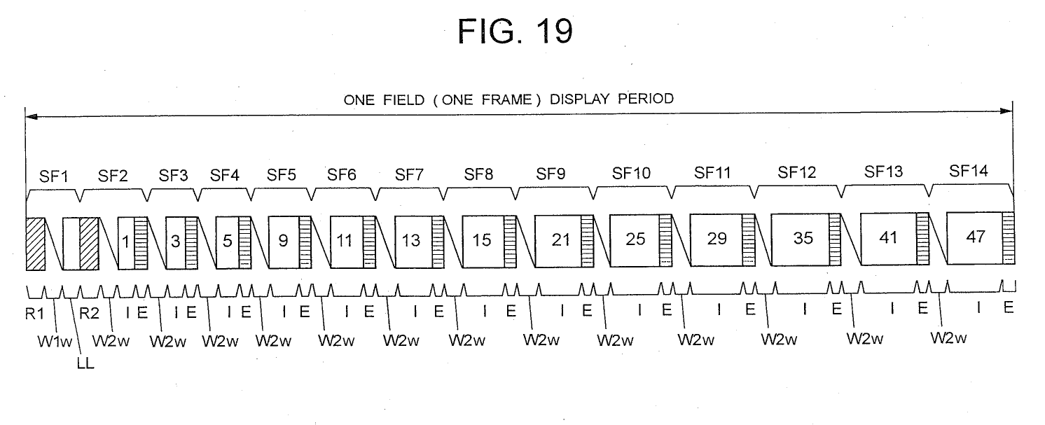

In this case, on driving the PDP 50, an emission driving sequence based on the selective writing address method as shown in FIG. 19 may be adopted instead of the selective erasing address method as shown in FIG. 17.

The driving control circuit 560 supplies the various control signals for sequential driving according to each of a first resetting process R1, a first selective writing addressing process W1_{W} and a minute light emission process LL for the panel drivers during the first sub-field SF1 within one field (one frame) display period as shown in FIG. 19. The driving control circuit 560 provides various control signals for sequential driving according to each of a second selective erasing addressing process W2_{W}, the sustaining process I and the erasing process E for the panel drivers during the sub-fields SF2 to SF14. The driving control circuit 560 provides various control signals for sequential driving according to a second resetting process R2 during the sub-filed SF2 as well, before the second selective writing addressing process W2_{W}.

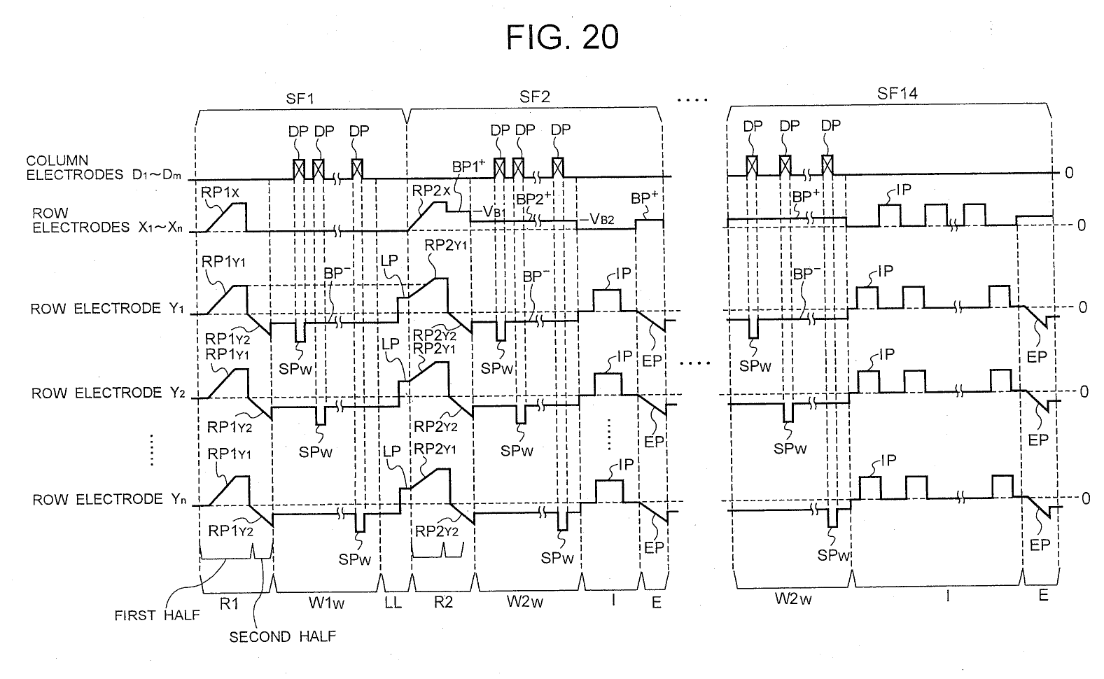

The panel drivers such as the X electrode driver 51, the Y electrode driver 53 and the address driver 55 generate various driving pulses as shown in FIG. 20 on the basis of the various control signals from the driving control circuit 560, and provides them for the column electrodes D and the row electrodes X and Y of the PDP 50.

FIG. 20 represents extracted operations of the first sub-field SF1 and the sub-field SF2 subsequent thereto, and the last sub-field SF14 among the sub-fields SF1 to SF14 as shown in FIG. 19. In FIG. 20, the first resetting process R1, the first selective writing addressing process W1_{W} and the minute light emission process LL in the sub-field SF1 and the second resetting process R2, the second selective writing addressing process W2_{W} and the sustaining process I in the sub-field SF2 are the same as those shown in FIG. 18, and thus the description thereof will be omitted.

The Y electrode driver 53 applies negative erase pulses EP with the same waveform as the reset pulses RP1_{Y2} or RP2_{Y2} applied during the second half of either the first resetting process R1 or the second resetting process R2 to the whole row electrodes Y₁ to Yₙ, in the erasing processes E of the respective sub-fields SF2 to SF14. During this time, the X electrode 51 supplies base pulses BP⁺ with a predetermined positive peak voltage to the respective row electrodes X₁ to Xₙ, like the second half of the second resetting process R2. Weak erase discharge is generated in the discharge cells PC in which the sustain discharge has been generated as stated above, by the erase pulses EP and the base pulses BP⁺. Some of the wall charges remaining in the discharge cells PC are erased and the discharge cells PC are changed into an OFF mode by the erase discharge. Furthermore, weak discharge is generated between the column electrodes D and the row electrodes Y in the discharge cells PC by the application of the erase pulse EP. Such discharge adjusts an amount of the wall charges formed around the column electrodes D to an amount thereof capable of generating a selective writing address discharge properly in a subsequent second selective writing addressing process W2_{W}. The second selective writing addressing processes W2_{W} instead of the selective erasing addressing processes W_{D} are performed in the respective sub-fields SF3 to SF14.

The X electrode driver 51 and the Y electrode driver 53 apply the sustain pulses IP with a positive peak voltage V_{SUS} and a pulse width Wb to the respective row electrodes X₁ to Xₙ and Y₁ to Yₙ, in the respective sustaining processes I of the sub-fields SF3 to SF14, alternately in the row electrodes Y and X and repeatedly, as shown in FIG. 20. The sustain pulses IP are repeated as many as the number corresponding to the brightness weight of the sub-fields. Whenever the sustain pulses IP are applied, the sustain discharge is generated between the row electrodes X and Y in the discharge cells PC set to be in a ON mode. Light from the fluorescent layer 17 by the sustain discharge is illuminated outwards through the front transparent substrate 10 and thus display emission of the number of times according to the brightness weight of the sub-fields SF is performed by such sustain discharge. A total number of the sustain pulses IP applied in the respective sustaining processes I is an odd number. That is, an initial sustain pulse IP and a final sustain pulse IP are applied together to the row electrodes Y in the respective sustaining processes I. Accordingly, right after end of the respective sustaining processes I, negative wall charges are formed around the row electrodes Y, and positive wall charges are formed around the row electrodes X and the column electrodes D, respectively, in the discharge cells PC where the sustain discharge has occurred. This causes a wall charge-formed-state in the respective discharge cells PC to be the same as a state right after the end of the first reset discharge in the first resetting process R1 or the second resetting process R2. Therefore, by applying the erase pulse EP with the same waveform as the reset pulse RP1_{Y2} or RP2_{Y2} which is applied during the second half of the first resetting process R1 or the second resetting process R2 in the erasing process E performed right thereafter, to the row electrodes Y, states of all of the discharge cells PC can be changed into an OFF mode.

For expression of the second gray scale with brightness 1 level higher than the first gray scale expressing a black display (brightness level of 0), the driving shown in FIGS. 19 and 20 generates the selective writing address discharge in only the sub-field SF1 among the sub-field SF1 to SF14. With this, the minute light emission discharge is generated as a discharge contributed to a display image in only the sub-field SF1 among the sub-fields SF1 to SF14. For expression of the third gray scale with brightness 1 level higher than the second gray scale, the selective writing address discharge is generated in only the sub-field SF2 among the sub-field SF1 to SF14. With this, the sustain discharge of one time is generated as a discharge contributed to a display image in only the sub-field SF2 among the sub-fields SF1 to SF14. The selective writing address discharge is generated in each of the sub-fields SF1 and SF2 after the fourth gray scale, and moreover is generated in the respective sub-fields as subsequent as the number corresponding to the gray scales. With this, as a discharge contributed to a display image, the minute light emission discharge is generated in the sub-field SF1, and thereafter the sustain discharge is generated in the respective sub-fields as sequential as the number corresponding to the gray scales. According to such driving, a middle brightness display as many as sixteen gray scales can be made similarly to that shown in FIG. 16.

At this time, according to the driving shown in FIGS. 19 and 20, since the reset pulse RP1_{Y2} or RP2_{Y2} applied to the row electrode Y in the first resetting process R1 or the second resetting process R2 has the same waveform as the erase pulse EP applied to the row electrode Y in the erasing process E, these pulses may be generated by the common circuit. In addition, since only the selective writing addressing process W1_{W} and W2_{W} were employed, as the method for setting a pixel cell PC state (ON mode and OFF mode), in each of the sub-fields SF1 to SF14, the number of circuits required to generate a scan pulse may be just one. The general column anode discharge with a column electrode as an anode is generated in such a selective writing addressing process.

Accordingly, in driving the PDP 50, the selective writing address method as shown in FIGS. 19 and 20 makes it possible to construct a panel driver to various driving pulses at low costs as compared to the selective writing address method as shown in FIGS. 17 and 18.

In addition, in the driving as shown in FIG. 17 or 19, the column cathode discharge to cause current to flow from the row electrode Y toward the column electrode D is generated as the first reset discharge in the first resetting process R1 of the head sub-field SF1 by applying a voltage between the column electrode D as the cathode and the row electrode Y as the anode. Accordingly, in this first reset discharge, when cations in a discharging gas direct to the column electrode D, the cations collide with MgO crystals as secondary electron emitting material contained in the fluorescent layer 17 as shown in FIG. 5, thereby emitting secondary electrons from the MgO crystals. In particular, in the PDP 50, by exposing the MgO crystals to the discharging space as shown in FIG. 5 in order to increase the probability of collision with the cations, the secondary electrons are efficiently emitted into the discharging space. Then, since a discharge start voltage of the discharge cell PC is lowered by the priming caused by the secondary electrons, it is possible to generate a relatively weak reset discharge. Accordingly, since the emission luminance in the reset discharge is lowered by the weakness of the reset discharge, display with improved dark contrast is possible.

In addition, in the driving as shown in FIG. 17 or 19, the reset discharge is generated between the row electrodes Y formed on the front transparent substrate 10 and the column electrodes D formed on the rear substrate 14, as shown in FIG. 3. This allows further decrease of discharge light emitted from the front transparent substrate 10 to the outside, as compared to the reset discharge generated between the row electrodes X and Y formed on the front transparent substrate 10, thereby allowing further improvement of dark contrast.

In addition, in the PDP 50 as shown in FIG. 15, the CL emitting MgO crystals as the secondary electron emitting material are contained in the fluorescent layer 17 formed on the rear substrate 14 as well as the magnesium oxide layer 13 formed on the front transparent substrate 10 in each discharge cell PC, as shown in FIG. 5 or 14.

Accordingly, it is possible to finish weak discharge in a short time (as shown in FIG. 12) as compared to the column cathode discharge (as shown in FIG. 11) in the discharge cell where the CL emitting MgO crystals are contained in only the magnesium oxide layer 13. Accordingly, since the column cathode discharge with very low discharge intensity can be generated as the reset discharge, it is possible to increase dark contrast, particularly when a dark image is displayed.

In the driving as shown in FIGS. 17 and 18, or 19 and 20, all of the discharge cells PC are first initialized to the OFF mode by reset-discharging the discharge cells PC with the head sub-field SF, and then are shifted to the ON mode by generating a write address discharge for each discharge cell PC except for dark display (luminance level of 0). At this time, for the dark display by the driving, discharge generated through one field display period becomes only reset discharge in the head sub-field SF1. Accordingly, this driving allows further decrease of the number of times of discharge generated in one field display period, as compared to the driving to generate the selective erase address discharge to initialize all of the discharge cells to the ON mode by reset-discharging the discharge cells and then shift the discharge cells to the OFF mode. Accordingly, this driving allows improvement of contrast in display of a dark image, which is called ‘dark contrast’.

In addition, in the driving as shown in FIGS. 17 and 18, or 19 and 20, the column cathode discharge to cause current to flow from the row electrode Y toward the column electrode D is generated as the first reset discharge in the resetting process R of the head sub-field SF1 by applying a voltage between the column electrode D as the cathode and the row electrode Y as the anode. Accordingly, in this first reset discharge, when cations in a discharging gas direct to the column electrode D, the cations collide with MgO crystals as secondary electron emitting material contained in the fluorescent layer 17 as shown in FIG. 5, thereby emitting secondary electrons from the MgO crystals. In particular, in the PDP 50 of the plasma display apparatus as shown in FIG. 15, by exposing the MgO crystals to the discharging space as shown in FIG. 5 in order to increase the probability of collision with the cations, the secondary electrons are efficiently emitted into the discharging space. Then, since a discharge start voltage of the discharge cell PC is lowered by the priming caused by the secondary electrons, it is possible to generate a relatively weak reset discharge. Accordingly, since the emission luminance in the reset discharge is lowered by the weakness of the reset discharge, display with improved dark contrast is possible.

In addition, in the driving as shown in FIG. 18 or 20, the first reset discharge is generated between the row electrodes Y formed on the front transparent substrate 10 and the column electrodes D formed on the rear substrate 14, as shown in FIG. 3. This allows further decrease of discharge light emitted from the front transparent substrate 10 to the outside, as compared to the reset discharge generated between the row electrodes X and Y formed on the front transparent substrate 10, thereby allowing further improvement of dark contrast.

In addition, in the driving as shown in FIG. 18 or 20, in the second resetting process R2 of the sub-field SF2, by applying the first base pulse BP1⁺ to all of the row electrodes X while applying the reset pulse RP2_{Y2} to all of the row electrodes Y after generating the first reset discharge in order to generate the second reset discharge for erasing wall charges from each discharge cell PC, all of the discharge cells PC are initialized to the OFF mode. At this time, a peak potential (V_{B1}) of the first base pulse BP1⁺ applied to the row electrodes X in order to generate the second reset discharge is higher than a peak potential (V_{B2}) of the second base pulse BP2⁺ applied to the row electrodes X in the second selective writing addressing process W2_{W} immediately after the second resetting process R2. In other words, a voltage applied between the row electrodes X and Y by the first base pulse BP1⁺ and the reset pulse RP2_{Y2} is relatively high and the discharge intensity of the second reset discharge becomes large. Accordingly, although the second reset discharge is generated as a discharge to erase wall charges under the application of the first base pulse BP1⁺ and the reset pulse RP2_{Y2}, a very small quantity of negative wall charges and a very small quantity of positive wall charges remain near the row electrodes X and the row electrodes Y in all of the discharge cells PC, respectively.

Accordingly, in the second selective writing addressing process W2_{W}, as shown in FIG. 18 or 20, under the condition where the second base pulse BP2⁺ having the positive polarity is applied to the row electrodes X and the base pulse BP⁻ having the negative polarity is applied to the row electrodes Y, it becomes difficult to generate a discharge between the row electrodes X and Y. This prevents an erroneous discharge from being generated between the row electrodes X and Y when applying the pixel data pulse DP of 0 volt to the column electrodes D while the write scan pulse SP_{W} having the negative polarity to the row electrodes Y in order to set the discharge cells PC to the OFF mode in the second selective writing addressing process W2_{W}.

In addition, in the driving as shown in FIG. 18 or 20, in the sustaining process I of the sub-field SF1 having the smallest luminance weight, high display reproducibility for an image having low luminance is achieved by applying the sustain pulse IP just once and hence limiting the number of times of sustain discharge to one. After the sustain discharge generated by the once sustain pulse IP is finished, negative wall charges and positive wall charges remain formed near the row electrodes Y and the column electrodes D, respectively. This makes it possible to generate a discharge with the column electrodes D as anodes (hereinafter referred to as ‘column anode discharge’), as a selective erase address discharge, between the column electrodes D and the row electrodes Y in the selective erasing addressing process W_{D} of the sub-field SF2 in the driving as shown in FIG. 18. At this time, in the driving as shown in FIG. 18, the number of times of application of the sustain pulse IP is an even number in the sustaining process I of each of the sub-fields SF2 to SF14. Accordingly, immediately after the sustaining process I is finished, since negative wall charges and positive wall charges remain formed near the row electrodes Y and the column electrodes D, respectively, the column anode discharge is possible in the selective erasing addressing process W_{D} following the sustaining process I. Accordingly, only the positive pulses are applied to the column electrodes D, thereby preventing increase of costs for the address driver 55.

### EMBODIMENT 3

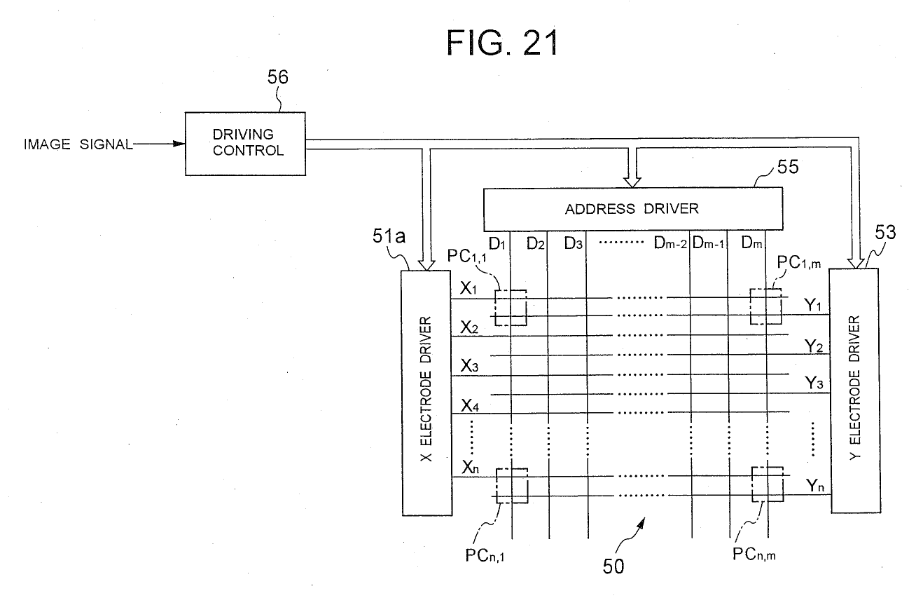

FIG. 21 is a schematic view showing a configuration of the plasma display apparatus to drive the plasma display panel using a driving method according to a third embodiment of the invention.

The PDP 50 of the plasma display apparatus as shown in FIG. 21 has the same structure as the PDP 50 of the plasma display apparatus as shown in FIG. 1, that is, the structure as shown in FIGS. 2 to 5 and 14. In addition, the Y electrode driver 53, the address driver 55 and the driving control circuit 56 in the plasma display apparatus as shown in FIG. 21 have the same operation as those as shown in FIG. 1. Specifically, the driving control circuit 56 supplies various control signals to drive the PDP 50 to panel drivers (X electrode driver 51a, Y electrode driver 53 and address driver 55) according to the emission driving sequence as shown in FIG. 7 for the selective erasing address method and the emission driving sequence as shown in FIG. 9 for the selective writing address method.

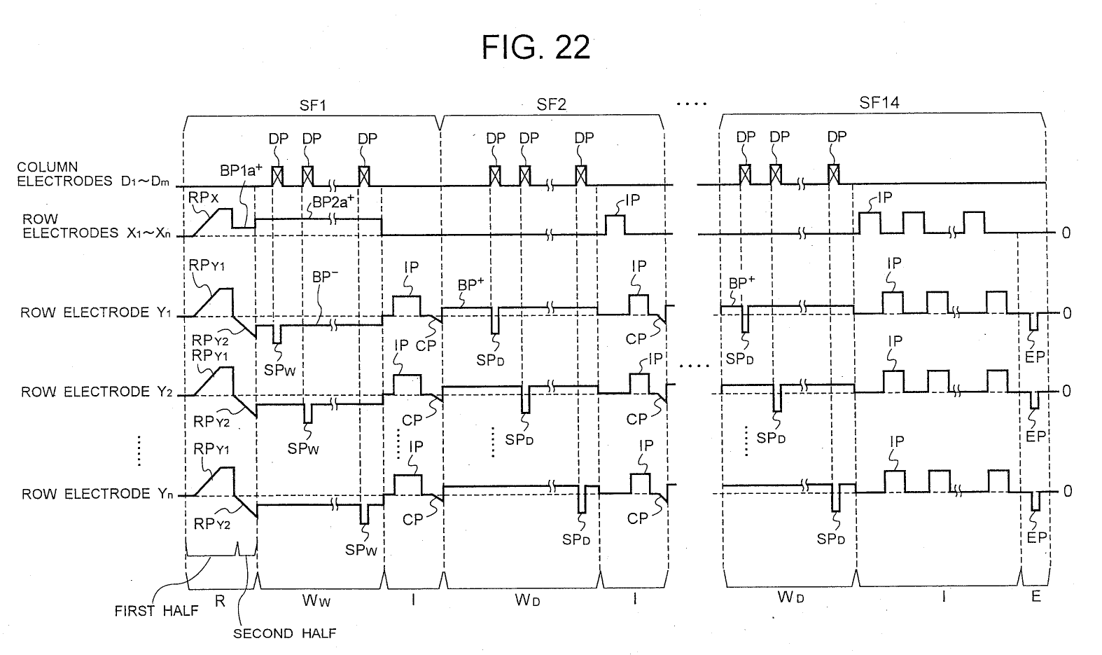

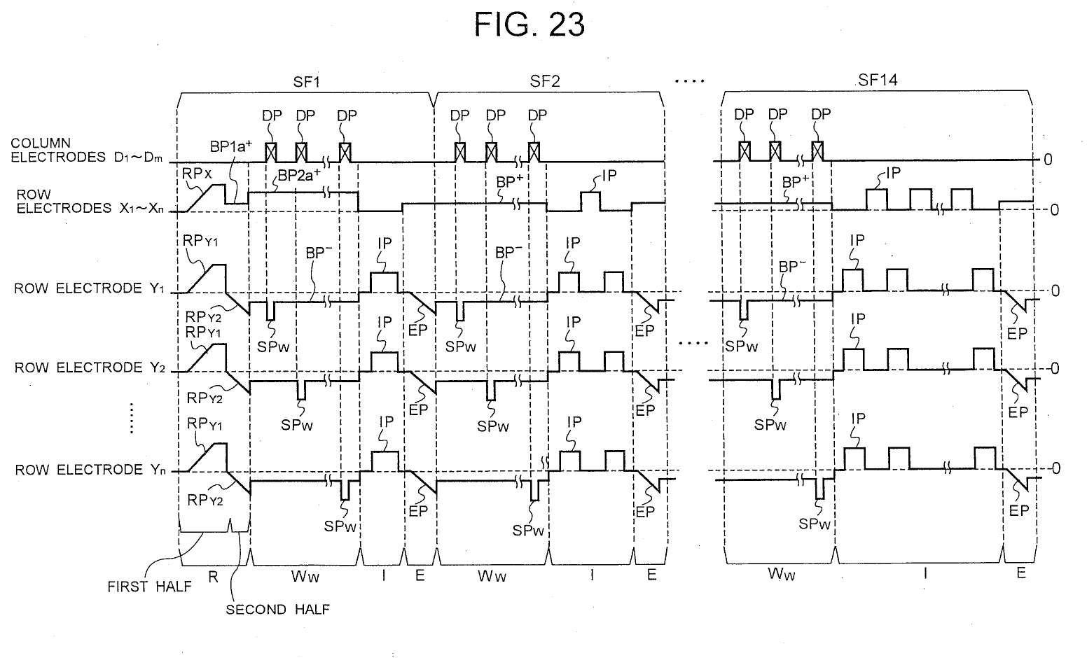

For the selective erasing address method, according to the emission driving sequence as shown in FIG. 7, the panel drivers generate various driving pulses as shown in FIG. 22 for each of the sub-fields SF1 to SF14 and apply these generated driving pulses to the column electrodes D and the row electrodes X and Y of the PDP 50. On the other hand, for the selective writing address method, according to the emission driving sequence as shown in FIG. 9, the panel drivers generate various driving pulses as shown in FIG. 23 for each of the sub-fields SF1 to SF14 and apply these generated driving pulses to the column electrodes D and the row electrodes X and Y of the PDP 50.

In FIG. 22, the sub-fields SF2 to SF14, the first half of the resetting process R of the sub-field SF1, and the sustaining process I of the sub-field SF1 have the same application operation as those as shown in FIG. 8. In addition, in FIG. 23, the sub-fields SF2 to SF14, the first half of the resetting process R of the sub-field SF1, and the sustaining process I and the erasing process E of the sub-field SF1 have the same application operation as those as shown in FIG. 10.

Specifically, in FIG. 22 (or FIG. 23), other driving pulses except the first base pulse BP1a⁺ applied to the row electrodes X in the second half of the resetting process R of the sub-field SF1 and the second base pulse BP2a⁺ applied to the row electrodes X in the selective writing addressing process W_{W} of the sub-field SF1 have the same as those as shown in FIG. 8 (or FIG. 10).

Accordingly, hereinafter, application operation for only driving pulses applied in the second half of the resetting process R of the sub-field SF1 and in the selective writing addressing process W_{W} of the sub-field SF1, which are selected from FIG. 22 (or FIG. 23), will be described.

In the second half of the resetting process R, the Y electrode driver 53 applies the negative reset pulse RP_{Y2} having potential which smoothly changes with time at a leading edge to all of the row electrodes Y, as shown in FIG. 22 or 23. In the meantime, the X electrode driver 51a applies the first base pulse BP1a⁺ having a positive peak potential as the highest pulse potential to all of the row electrodes X. Under the application of the first base pulse BP1a⁺ and the reset pulse RP_{Y2}, the second reset discharge is generated in all of the discharge cells. This second reset discharge initializes all of the discharge cells to the OFF mode. In addition, under the application of the reset pulse RP_{Y2}, a weak discharge is generated between the row electrodes Y and the column electrodes D in all of the discharge cells PC, and some of positive wall charges formed near the column electrodes D are erased. This allows wall charges remaining near the column electrodes D of all of the discharge cells PC to be adjusted to the amount by which the selective writing address discharge can be correctly generated in the selective writing addressing process W_{W}.

In addition, throughout the execution period of the selective writing addressing process W_{W} immediately after the resetting process R, the X electrode driver 51a applies the second base pulse BP2a⁺ having a positive peak potential as the highest pulse potential, which is higher than that of the first positive base pulse BP1a⁺, to all of the row electrodes X, as shown in FIG. 22 or 23. In addition, in this selective writing addressing process W_{W}, the Y electrode driver 53 applies the write scan pulse SP_{W} having a negative peak potential to each of the row electrodes Y₁ to Yₙ in a sequential and selective manner while simultaneously applying the base pulse BP⁻ having a negative peak potential to the row electrodes Y₁ to Yₙ, as shown in FIG. 22 or 23. In the meantime, the address driver 55 generates a positive high-voltage pixel data pulse DP for discharge cells PC to be set to the ON mode and a 0 volt pixel data pulse DP for discharge cells PC to be set to the OFF mode, and applies the generated pixel data pulses DP to the column electrodes D by one display line at a time in synchronization with an application timing of the write scan pulse SP_{W}. At this time, the selective writing address discharge is generated between the column electrodes D and the row electrodes Y in the discharge cells PC to which the high-voltage pixel data pulse DP to cause the discharge cells to be set to the ON mode is applied along with the write scan pulse SP_{W}. Immediately after this selective writing address discharge, a weak discharge is generated between the row electrodes X and Y in the discharge cells PC. In other words, after the write scan pulse SP_{W} is applied, although a voltage according to the base pulse BP⁻ and the second base pulse BP2a⁺ is applied between the row electrodes X and Y, since this voltage is set to be lower than a discharge start voltage of each discharge cell PC, there is no generation of discharge in the discharge cell PC with only this voltage. However, if the selective writing address discharge is generated, a weak discharge caused by this selective writing address discharge is also generated between the row electrodes X and Y with only application of the voltage by the base pulse BP⁻ and the second base pulse BP2a⁺. According to such a weak discharge and the selective writing address discharge, the discharge cells PC are set to a state where positive wall charges are formed near the row electrodes Y, negative wall charges are formed near the row electrodes X, and negative wall charges are formed near the column electrodes D, that is, to the ON mode.

Here, in the driving as shown in FIG. 22 or 23, in order to reliably generate the weak discharge as described above immediately after the selective writing address discharge, the second base pulse BP2a⁺ having a peak potential higher than that of the first base pulse BP1a⁺ is applied to the row electrodes X.

In other words, in a PDP having high resolution, that is, a PDP having a large number of pixels in one picture, ununiformity of discharge intensity between pixels, particularly ununiformity of discharge intensity for counter discharge between the row electrodes Y and the column electrodes D in the discharge cells, becomes large as compared to a PDP having the less number of pixels. Accordingly, because of the ununiformity of discharge intensity between pixels, in some cases, there exist discharge cells PC in the PDP 50 in which a selective writing address discharge having low discharge intensity is generated. In such discharge cells PC, it is difficult to reliably generate the weak discharge as described above immediately after the selective writing address discharge.

In the driving as shown in FIG. 22 or 23, in order to avoid such difficulty, by applying the second base pulse BP2a⁺ having a potential higher than that of the first base pulse BP1a⁺ to the row electrodes X throughout the execution period of the selective writing addressing process W_{W}, the weak discharge is reliably generated even for the discharge cells in which the selective writing address discharge having low discharge intensity is generated.

### EMBODIMENT 4

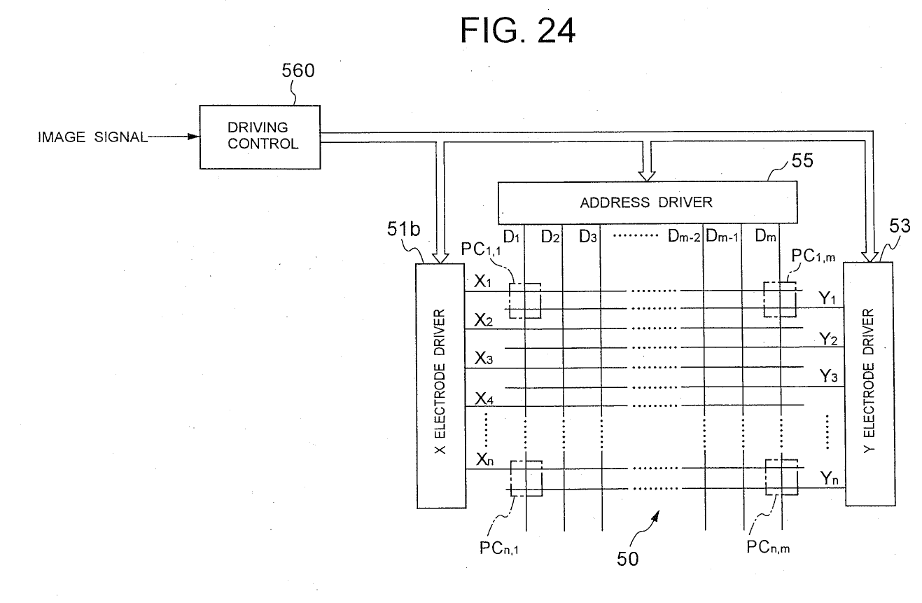

FIG. 24 is a schematic view showing a configuration of the plasma display apparatus to drive the plasma display panel using a driving method according to a fourth embodiment of the invention.

The PDP 50 of the plasma display apparatus as shown in FIG. 24 has the same structure as the PDP 50 of the plasma display apparatus as shown in FIG. 15, that is, the structure as shown in FIGS. 2 to 5 and 14. In addition, the Y electrode driver 53, the address driver 55 and the driving control circuit 560 in the plasma display apparatus as shown in FIG. 24 have the same operation as those as shown in FIG. 15. Specifically, the driving control circuit 560 supplies various control signals to drive the PDP 50 to panel drivers (X electrode driver 51b, Y electrode driver 53 and address driver 55) according to the emission driving sequence as shown in FIG. 17 for the selective erasing address method and the emission driving sequence as shown in FIG. 19 for the selective writing address method.

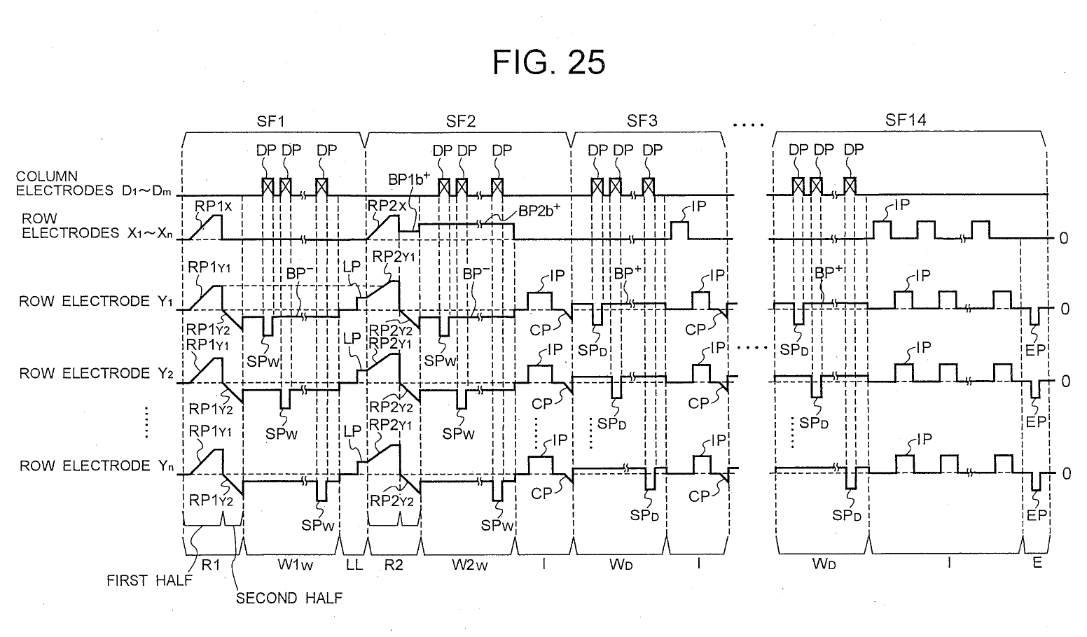

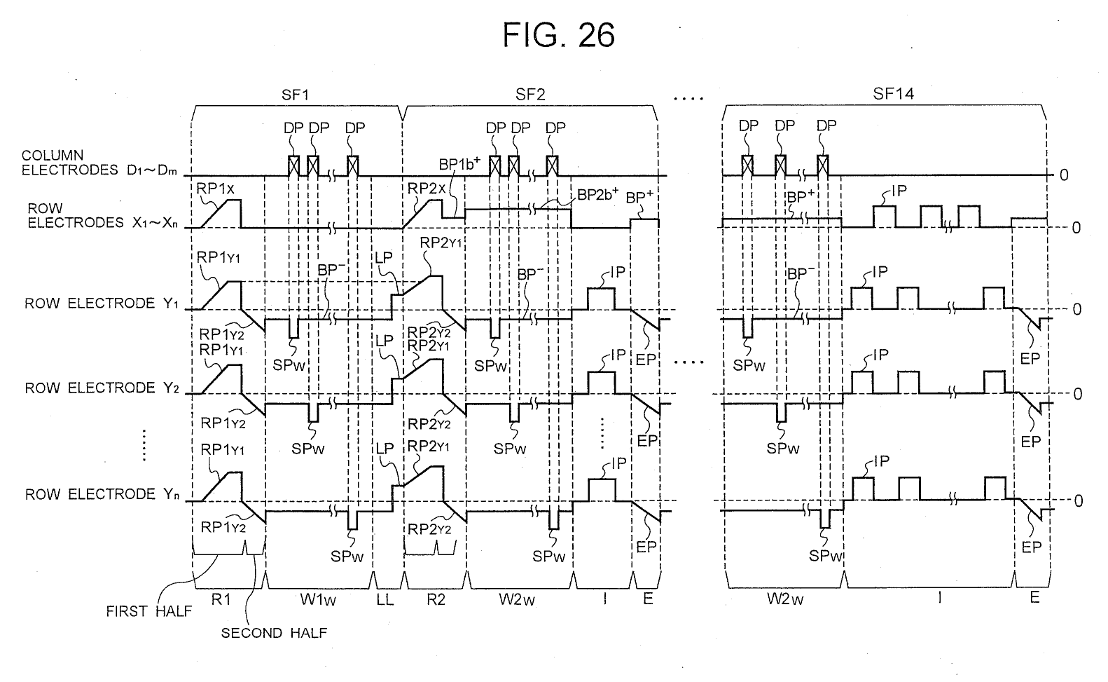

For the selective erasing address method, according to the emission driving sequence as shown in FIG. 17, the panel drivers generate various driving pulses as shown in FIG. 25 for each of the sub-fields SF1 to SF14 and apply these generated driving pulses to the column electrodes D and the row electrodes X and Y of the PDP 50. On the other hand, for the selective writing address method, according to the emission driving sequence as shown in FIG. 19, the panel drivers generate various driving pulses as shown in FIG. 26 for each of the sub-fields SF1 to SF14 and apply these generated driving pulses to the column electrodes D and the row electrodes X and Y of the PDP 50.

In FIG. 25, the sub-fields SF1 and SF3 to SF14, the first half of the second resetting process R2 of the sub-field SF2, and the sustaining process I of the sub-field SF2 have the same application operation as those as shown in FIG. 18. In addition, in FIG. 26, the sub-fields SF1 and SF3 to SF14, the first half of the second resetting process R2 of the sub-field SF2, and the sustaining process I and the erasing process E of the sub-field SF2 have the same application operation as those as shown in FIG. 20.

Specifically, in FIG. 25 (or FIG. 26), other driving pulses except the first base pulse BP1b⁺ applied to the row electrodes X in the second half of the second resetting process R2 of the sub-field SF2 and the second base pulse BP2b⁺ applied to the row electrodes X in the second selective writing addressing process W2_{W} of the sub-field SF2 have the same as those as shown in FIG. 18 (or FIG. 20).

Accordingly, hereinafter, application operation for only driving pulses applied in the second half of the second resetting process R2 of the sub-field SF2 and in the second selective writing addressing process W2_{W} of the sub-field SF2, which are selected from FIG. 25 (or FIG. 26), will be described.

In the second half of the second resetting process R2 of the sub-field SF2, the Y electrode driver 53 applies the negative reset pulse RP2_{Y2} having potential at a leading edge, which smoothly changes with time, to all of the row electrodes Y, as shown in FIG. 25 or 26. In the meantime, the X electrode driver 51b applies the first base pulse BP1b⁺ having a positive peak potential as the highest pulse potential to all of the row electrodes X. Under the application of the first base pulse BP1b⁺ and the reset pulse RP2_{Y2}, the second reset discharge is generated in all of the discharge cells. This second reset discharge initializes all of the discharge cells to the OFF mode. In addition, under the application of the reset pulse RP2_{Y2}, a weak discharge is generated between the row electrodes Y and the column electrodes D in all of the discharge cells PC, and some of positive wall charges formed near the column electrodes D are erased. This allows wall charges remaining near the column electrodes D of all of the discharge cells PC to be adjusted to the amount by which the selective writing address discharge can be correctly generated in the second selective writing addressing process W2_{W}.

In addition, throughout the execution period of the second selective writing addressing process W2_{W} immediately after the second resetting process R2, the X electrode driver 51b applies the second base pulse BP2b⁺ having a positive peak potential as the highest pulse potential, which is higher than that of the first base pulse BP1b⁺, to all of the row electrodes X, as shown in FIG. 25 or 26. In addition, in the second selective writing addressing process W2_{W}, the Y electrode driver 53 applies the write scan pulse SP_{W} having a negative peak potential to each of the row electrodes Y₁ to Yₙ in a sequential and selective manner while simultaneously applying the base pulse BP⁻ having a negative peak potential to the row electrodes Y₁ to Yₙ, as shown in FIG. 25 or 26. In the meantime, the address driver 55 generates a positive high-voltage pixel data pulse DP for discharge cells PC to be set to the ON mode and a 0 volt pixel data pulse DP for discharge cells PC to be set to the OFF mode, and applies the generated pixel data pulses DP to the column electrodes D by one display line at a time in synchronization with an application timing of the write scan pulse SP_{W}. At this time, the selective writing address discharge is generated between the column electrodes D and the row electrodes Y in the discharge cells PC to which the high-voltage pixel data pulse DP to cause the discharge cells to be set to the ON mode is applied along with the write scan pulse SP_{W}. Immediately after this selective writing address discharge, a weak discharge is also generated between the row electrodes X and Y in the discharge cells PC. In other words, after the write scan pulse SP_{W} is applied, although a voltage according to the base pulse BP⁻ and the second base pulse BP2b⁺ is applied between the row electrodes X and Y, since this voltage is set to be lower than a discharge start voltage of each discharge cell PC, there is no generation of discharge in the discharge cell PC with only this voltage. However, if the selective writing address discharge is generated, a weak discharge caused by this selective writing address discharge is also generated between the row electrodes X and Y with only application of the voltage by the base pulse BP⁻ and the second base pulse BP2b⁺. According to such a weak discharge and the selective writing address discharge, the discharge cells PC are set to a state where positive wall charges are formed near the row electrodes Y, negative wall charges are formed near the row electrodes X, and negative wall charges are formed near the column electrodes D, that is, to the ON mode.

Here, in the driving as shown in FIG. 25 or 26, in the second selective writing addressing process W2_{W}, in order to reliably generate the weak discharge as described above immediately after the selective writing address discharge, the second base pulse BP2b⁺ having a peak potential higher than that of the first base pulse BP1b⁺ is applied to the row electrodes X.

In other words, in a PDP having high resolution, that is, a PDP having a large number of pixels in one picture, ununiformity of discharge intensity between pixels, particularly ununiformity of discharge intensity for counter discharge between the row electrodes Y and the column electrodes D in the discharge cells, becomes large as compared to a PDP having the less number of pixels. Accordingly, because of the ununiformity of discharge intensity between pixels, in some cases, there exist discharge cells PC in the PDP 50 in which a selective writing address discharge having low discharge intensity is generated. In such discharge cells PC, it is difficult to reliably generate the weak discharge as described above immediately after the selective writing address discharge.

In the driving as shown in FIG. 25 or 26, in order to avoid such difficulty, by applying the second base pulse BP2b⁺ having a potential higher than that of the first base pulse BP1b⁺ to the row electrodes X throughout the execution period of the second selective writing addressing process W2_{W}, the weak discharge is reliably generated even for the discharge cells in which the selective writing address discharge having low discharge intensity is generated.

In addition, in the first half of the first resetting process R1 as shown in FIGS. 18, 20, 25 and 26, by applying the reset pulse RP1_{Y1} to the row electrodes Y₁ to Yₙ, the first reset discharge is generated as a column cathode discharge, which may be omitted.

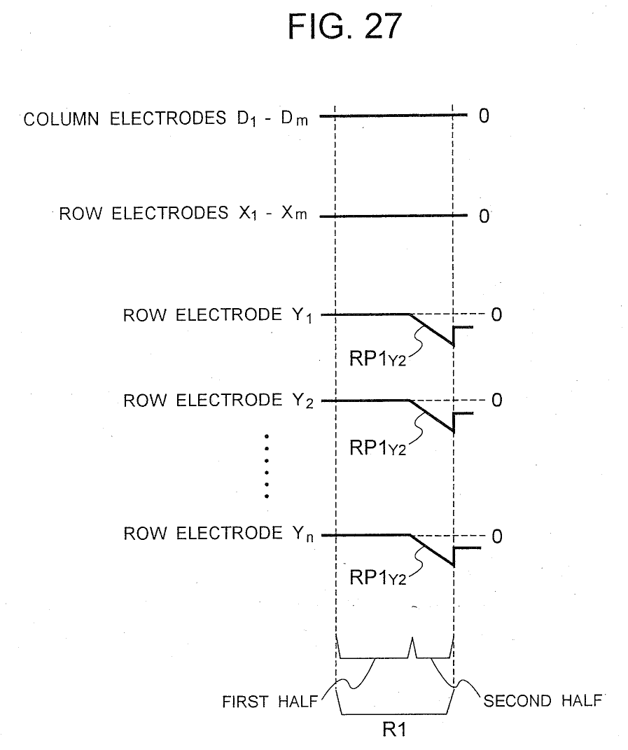

For example, the first resetting process R1 is employed as shown in FIG. 27 instead of the first resetting process R1 as shown in FIGS. 18, 20, 25 and 26. That is, as shown in FIG. 27, the row electrodes Y₁ to Yₙ are set to a ground potential in the first half of the first resetting process R1. In other words, the purpose of the column cathode discharge from the row electrodes Y to the column electrodes D in the first half of the first resetting process R1 is to emit charged particles to stabilize write discharge in the first selective writing addressing process W1_{W}. However, for example when MgO crystals including the CL emitting MgO crystals as shown in FIG. 5 or 14 are contained in a fluorescent layer, the write discharge is further stabilized as compared to when MgO crystals are not contained in the fluorescent layer. Accordingly, in the first half of the first resetting process R1, it is possible to employ a configuration where the column cathode discharge with the row electrodes Y and the column electrodes D set to a ground potential is not generated. In this case, the row electrodes X are also set to a ground potential level, as shown in FIG. 27. In addition, in this case, after finishing the first resetting process R1, all of the discharge cells are set to the OFF state by discharge by the erase pulse EP in an erasing process E of a field immediately before the first resetting process and discharge by application of the reset pulse RP1_{Y2}. At this time, regarding the column cathode discharge by application of the reset pulse RP2_{Y1} in the first half of the second resetting process R2 as shown in FIGS. 18, 20, 25 and 26, charged particles emitted by the reset discharge mainly work to stabilize the write discharge in the second selective writing addressing process W2_{W}. Accordingly, if the column cathode discharge by application of the reset pulse RP2_{Y1} in the first half of the second resetting process R2 is omitted, in a case where there occurs a write miss in the second selective writing addressing process W2_{W}, a sustain discharge can not be generated in the entire sub-field after the sub-field SF2. Therefore, it is preferable that the column cathode discharge by application of the reset pulse RP2_{Y1} is carried out for the first half of the second resetting process R2. This may be similarly applied to the first half of the resetting process R as shown in FIGS. 8, 10, 22 and 23.

Next, an embodiment of a die of the present invention will be described. The plasma display apparatus to drive the plasma display panel using a driving method according to a fifth embodiment has the same configuration as the plasma display apparatus as shown in FIG. 15, and the shown driving control circuit 560 generates pixel driving data GD of 14 bits based on the data conversion table as shown in FIG. 16. In addition, the driving control circuit 560 supplies various driving control signals to drive the PDP 50 having the above structure to panel drivers including the X electrode driver 51, the Y electrode driver 53 and the address driver 55 according to the emission driving sequence as shown in FIG. 17.

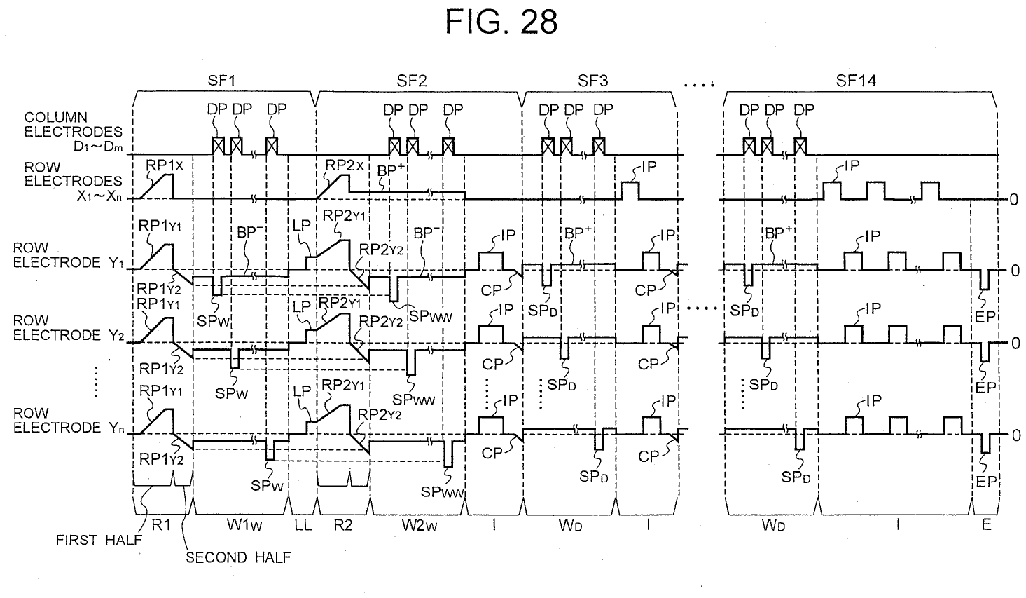

The panel drivers including the X electrode driver 51, the Y electrode driver 53 and the address driver 55 generate various driving pulses according to the various driving control signals supplied from the driving control circuit 560 and supply the generated driving pulses to the column electrodes D and the row electrodes X and Y of the PDP 50, as shown in FIG. 28.

FIG. 28 shows only the operation in the sub-fields SF1 to SF3 and the last sub-field SF14 of the sub-fields SF1 to SF14 shown in FIG. 17.

First, in the first half of the first resetting process R1 of the sub-field SF1, the Y electrode driver 53 applies the positive reset pulse RP1_{Y1} having a potential at a leading edge, which smoothly changes with time as compared to a sustain pulse which will be described later, to all of the row electrodes Y₁ to Yₙ. In addition, a peak potential of the reset pulse RP1_{Y1} is higher than a peak potential of the sustain pulse and is lower than a peak potential of a reset pulse RP2_{Y1} which will be described later. In the mean time, the address driver 55 sets the column electrodes D₁ to Dₘ to a ground potential (0 volt). In the mean time, the X electrode driver 51 applies a reset pulse RP1x, which has the same polarity as the reset pulse RP1_{Y1} and has a peak potential capable of preventing a surface discharge, which is accompanying the application of the reset pulses RP1_{Y1}, between the row electrodes X and Y, to all of the row electrodes X₁ to Xₙ. In the mean time, if the surface discharge does not occur between the row electrodes X and Y, the X electrode driver 51 may set all of the row electrodes X₁ to Xₙ to the ground potential (0 volt) instead of applying the reset pulse RP1_{X}. Here, in the first half of the first resetting process R1, the first reset discharge is generated between the row electrodes Y and the column electrodes D in all of the discharge cell PC according to the application of the reset pulses RP1_{Y1}, as described above. In other words, in the first half of the first resetting process R1, by applying a voltage between the row electrodes Y as anodes and the column electrodes D as cathodes, a discharge causing current to flow from the row electrodes Y to the column electrodes D (hereinafter referred to as “column cathode discharge”) is generated as the first reset discharge. According to such a first reset discharge, negative wall charges and positive wall charges are formed near the row electrodes Y and the column electrodes D in all of the discharge cells PC, respectively.

Next, during the second half in the first resetting process R1 of the sub-field SF1, the Y electrode driver 53 generates the negative reset pulse RP1_{Y2} having a potential at a leading edge, which smoothly changes with time, and applies the generated rest pulse to all of the row electrodes Y₁ to Yₙ. In addition, a negative peak potential in the reset pulse RP1_{Y2} is set to be higher than a peak potential of the negative write scan pulse SP_{W}, which will be described later, that is, to be close to 0 V. In other words, when the peak potential of the reset pulses RP_{Y2} is set to be lower than that of the write scan pulse SP_{W}, a strong discharge is generated between the row electrodes Y and the column electrodes D to erase a lot of wall charges formed around the column electrodes D, and thus an address discharge in the first selective writing addressing process W1_{W} becomes unstable. In the mean time, the X electrode driver 51 sets all of the row electrodes X₁ to Xₙ to the ground potential (0 volt). In addition, the peak potential of the reset pulse RP1_{Y2} is the lowest potential to certainly generate a discharge between the row electrodes X and Y in consideration of the wall charges formed around the row electrodes X and Y by the first reset discharge. Here, in the second half of the first resetting process R1, the second reset discharge is generated between the row electrodes X and Y in all of the discharge cells PC under the application of the reset pulse RP1_{Y2} as described above. In other words, in the second half of the first resetting process R1, by applying a voltage between the row electrodes Y as cathodes and the column electrodes X as anodes, a discharge causing current to flow from the column electrodes D to the row electrodes Y (hereinafter referred to as “column anode discharge”) is generated as the second reset discharge. According to such a second reset discharge, the wall charges formed around the row electrodes X and Y in the discharge cells PC are erased and all of the discharge cells PC are initialized to the OFF mode. In addition, a weak discharge is also generated between the row electrodes Y and the column electrodes D in all of the discharge cells PC under the application of the reset pulse RP1_{Y2}. This weak discharge erases some of positive wall charges formed around the column electrodes D such that the wall charges are adjusted to generate a correct selective writing address discharge in the first selective writing addressing process W1_{W}.

In this manner, in the first resetting process R1, by consecutively applying the reset pulse RP1_{Y1} as a reset head pulse and the reset pulse RP1_{Y2} as a reset tail pulse to the whole row electrodes Y to generate the first and second reset discharges in each discharge cell sequentially, the whole discharge cells are initialized to the OFF mode.

Next, in the first selective writing addressing process W1_{W} of the sub-field SF1, the Y electrode driver 53 applies the base pulse BP⁻ with a predetermined potential of negative polarity as shown in FIG. 28 to the row electrodes Y₁ to Yₙ at the same time and selectively applies the write scan pulses SP_{W} with a negative peak potential to the respective row electrodes Y₁ to Yₙ sequentially. During this time, the address driver 55 first converts pixel driving data bits corresponding to the sub-field SF1 into a pixel data pulse DP having a pulse voltage according to logic levels of the pixel driving data bits. For example, when the pixel driving data bits with logic level 1 which causes the discharge cells PC to be set to an ON mode are supplied, the address driver 55 converts the supplied pixel driving data bits into a pixel data pulse DP having a positive peak potential. In the meantime, the address driver 55 converts the pixel driving data bits with logic level 0, which causes the discharge cells PC to be set to an OFF mode, into a pixel data pulse DP having a low voltage (0 volt). The address driver 55 applies the pixel data pulse DP to the column electrodes D₁ to Dₘ by one display line (m) at a time in synchronization with an application timing of the write scan pulse SP_{W}. At this time, the selective writing address discharge is generated between the column electrodes D and the row electrodes Y in the discharge cells PC to which the high-voltage pixel data pulse DP to cause the discharge cells to be set to the ON mode is applied along with the write scan pulse SP_{W}. During this time, although a voltage according to the write scan pulse SP_{W} is applied between the row electrodes X and Y, since all of the discharge cells PC remains in the OFF mode, that is, the wall charges remains erased, there occurs no discharge between the row electrodes X and Y only by the application of the write scan pulse SP_{W}. Accordingly, in the first selective writing addressing process W1_{W} of the sub-field SF1, the selective writing address discharge is generated only between the column electrodes D and the row electrodes Y in the discharge cells PC under the application of the write scan pulse SP_{W} and the high-voltage pixel data pulse DP. This causes the discharge cells PC to be set to the ON mode in which no wall charge exists near the row electrodes X in the discharge cells PC, positive wall charges are formed in the row electrodes Y and negative wall charges are formed near the column electrodes D. In the mean time, as described above, the selective writing address discharge is not generated between the column electrodes D and the row electrodes Y in the discharge cells PC to which the low-voltage (0 volt) pixel data pulse DP to cause the discharge cells PC to be set to the OFF mode is applied along with the write scan pulse SP_{W}. Accordingly, the discharge cells PC remains in the OFF mode initialized in the first resetting process R1, that is, a state in which there occurs no discharge between the row electrodes Y and the column electrodes D and between the row electrodes X and Y.

Next, in the minute light emission process LL of the sub-field SF1, the Y electrode driver 53 applies a minute light emission pulse LP with a predetermined positive peak potential, as shown in FIG. 28, to the row electrodes Y₁ to Yₙ at the same time. Under the application of the minute light emission pulse LP, a discharge between the column electrodes D and the row electrodes Y in the discharge cells PC set to be in the ON mode is generated (hereinafter, referred to as “minute light emission discharge”). In other words, although the discharge is generated between the row electrodes Y and the column electrodes D in the discharge cells PC in the minute light emission process LL, a potential which cannot generate a discharge between the row electrodes X and Y is applied to the row electrodes Y and thus the minute light emission discharge is generated only between the column electrodes D and row electrodes Y in the discharge cells PC set to be in the ON mode. In this case, the peak potential of the minute light emission pulse LP is lower than that of the sustain pulse IP applied in the sustaining process I after the sub-field SF2, which will be described later, and, for example, is the same as a potential applied to the row electrodes Y in the selective erasing addressing process W_{D}, which will be described later. In addition, as shown in FIG. 8, a rate of change with time in a rising interval of a potential of the minute light emission pulse LP is larger than that in a rising interval of a potential of the reset pulses RP1_{Y1} and RP2_{Y1}. That is, a potential change at a lead edge in the minute light emission pulse LP becomes larger than a potential change at a lead edge in the reset pulse in order to generate a discharge stronger than the first discharge generated in the first resetting process R1 and the second resetting process R2. Here, such a discharge is the column cathode discharge as described above, and since the discharge is generated by the minute light emission pulse LP with a voltage lower than that of the sustain pulse IP, emission brightness accompanying the discharge is lower than that accompanying the sustain discharge (which will be described later) generated between the row electrodes X and Y. In other words, although the discharge in the minute light emission discharge LL accompanies emission with higher brightness level than the first reset discharge, the discharge is lower than the sustain discharge in the brightness level accompanying is, that is, a discharge accompanying a weak discharge of a degree available for display is generated as the minute light emission discharge. In this case, the selective writing address discharge is generated between the column electrodes D and the row electrodes Y in the discharge cells PC in the first selective writing addressing process W1_{W} performed right before the minute light emission process LL. Accordingly, in the sub-field SF1, by the emission accompanying both of the selective writing address discharge and minute light emission discharge, brightness corresponding to a gray scale higher by 1 level than brightness level of 0 is expressed.

In addition, after the minute light emission discharge, negative wall charges are formed around the row electrodes Y and positive wall charges are formed around the column electrodes D.

Subsequently, in the first half of the second resetting process R2 of the sub-field SF2, the Y electrode driver 53 applies the positive reset pulse RP2_{Y1} having a potential at a leading edge, which smoothly changes with time as compared to a sustain pulse which will be described later, to all of the row electrodes Y₁ to Yₙ. The peak potential of the reset pulse RP2_{Y1} is higher than that of the reset pulse RP1_{Y1}. During this time, the address driver 55 sets the column electrodes D₁ to Dₘ to be the ground potential (0 volt), and the X electrode driver 51 applies a positive reset pulse RP2_{X} with a peak potential capable of preventing a surface discharge, which is accompanying the application of the reset pulse RP2_{Y1}, between the row electrodes X and Y, to all of the row electrodes X₁ to Xₙ. Only if the surface discharge between the row electrodes X and Y is prevented, the X electrode driver 51 may set all of the row electrodes X₁ to Xₙ to the ground potential (0 volt) instead of the application of the reset pulse RP2_{X}. Depending on the application of the reset pulse RP2_{Y1}, the first reset discharge weaker than the column side cathode discharge in the minute light emission process LL is generated between the row electrodes Y and the column electrodes D in the discharge cells PC where the column side cathode discharge has not been generated in the minute light emission process LL among the respective discharge cells PC. In other words, in the first half of the second resetting process R2, by applying a voltage across both electrodes such that the row electrodes Y are anode and the column electrodes D are cathode, the column side cathode discharge to cause current to flow from the row electrodes Y to the column electrodes D is generated as the first reset discharge. Meanwhile, there is no discharge by the application of the reset pulse RP2_{Y1} in the discharge cells PC where the minute light emission discharge has been generated already in the minute light emission process LL. Accordingly, right after the first half of the second resetting process R2, negative wall charges are formed around the row electrodes Y and positive wall charges are formed around the column electrodes D in the whole discharge cells PC.

Next, in the second half of the second resetting process R2 of the sub-field SF2, the Y electrode driver 53 applies the negative reset pulse RP2_{Y2} having a potential at a leading edge, which smoothly changes with time, to the row electrodes Y₁ to Yₙ. As shown in FIG. 28, the negative peak potential of the reset pulse RP2_{Y2} is lower than the negative peak potential in the reset pulse RP1_{Y2} applied to the whole row electrodes Y in the first resetting process R1, and is higher than the negative peak potential in the write scan pulse SP_{W} applied to the first selective writing addressing process W1_{W}.

In the second half of the second resetting process R2, the X electrode driver 51 applies the base pulse BP⁺ having a positive potential to each of the row electrodes X₁ to Xₙ. In this case, depending on the application of the negative reset pulse RP2_{Y2} and the positive base pulse BP⁺, the second reset discharge is generated between the row electrodes X and Y in all of the discharge cells PC. In other words, in the second half of the second resetting process R2, by applying a voltage across both electrodes such that the row electrodes Y are cathode and the column electrodes D are anode, the column side anode discharge to cause current to flow from the column electrodes D to the row electrode Y is generated as the second reset discharge. In addition, the peak potentials of the negative reset pulse RP2_{Y2} and the positive base pulse BP⁺ are the lowest potential to certainly generate the second reset discharge between the row electrodes X and Y in consideration of the wall charges formed around the row electrodes X and Y by the first reset discharge. In addition, the negative peak potential in the reset pulse RP2_{Y2} is set to be higher than the peak potential of the negative write scan pulse SP_{W}, that is, to be close to 0 volt. In other words, when the peak potential of the reset pulses RP2_{Y2} is set to be lower than that of the write scan pulse SP_{W}, a strong discharge is generated between the row electrodes Y and the column electrodes D to erase a lot of wall charges formed around the column electrodes D, and thus an address discharge in the second selective writing addressing process W2_{W} becomes unstable. Here, according to the second reset discharge generated in the second half of the second resetting process R2, the wall charges formed around the row electrodes X and Y in the discharge cells PC are erased and all of the discharge cells PC are initialized to the OFF mode. In addition, a weak discharge is also generated between the row electrodes Y and the column electrodes D in all of the discharge cells PC under the application of the reset pulse RP2_{Y2}. This weak discharge erases some of positive wall charges formed around the column electrodes D such that the wall charges are adjusted to generate a correct selective writing address discharge in the second selective writing addressing process W2_{W}.

In this manner, in the second resetting process R2, by consecutively applying the reset pulse RP2_{Y1} as a reset head pulse and the reset pulse RP2_{Y2} as a reset tail pulse to the whole row electrodes Y to generate the first and second reset discharges in each discharge cell sequentially, the whole discharge cells are initialized to the OFF mode.

Next, in the second selective writing addressing process W2_{W} of the sub-field SF2, the Y electrode driver 53 applies the base pulse BP⁻ with the negative predetermined potential as shown in FIG. 28 to the row electrodes Y₁ to Yₙ at the same time and selectively applies the write scan pulse SP_{WW} with a negative peak potential to the respective row electrodes Y₁ to Yₙ sequentially. In addition, as shown in FIG. 28, the negative peak potential in the write scan pulse SP_{WW} is lower than the negative peak potential in the write scan pulse SP_{W} applied to the row electrodes Y in the first selective writing addressing process W1_{W}. The X electrode driver 51 continues to apply the base pulse BP⁺, which is applied to the row electrodes X₁ to Xₙ in the second half of the second resetting process R2, to the row electrodes X₁ to Xₙ in the second selective writing addressing process W2_{W}. In addition, the potentials of the base pulse BP⁻ and the base pulse BP⁺ are each set to be a potential such that a voltage between the row electrodes X and Y in a period of non-application of the write scan pulse SP_{WW} is lower than a discharge start voltage of the discharge cells PC. In addition, in the second selective writing addressing process W2_{W}, the address driver 55 first converts the pixel driving data bits corresponding to the sub-field SF2 into a pixel data pulse DP having a pulse voltage according to a logic level of the pixel driving data bits. For example, when the pixel driving data bits with logic level 1 which sets the discharge cells PC to be in an ON mode are supplied, the address driver 55 converts the pixel driving data bits into the pixel data pulse DP with a positive peak potential. In the meantime, the address driver 55 converts the pixel driving data bits with logic level 0, which causes the discharge cells PC to be set to an OFF mode, into a pixel data pulse DP having a low voltage (0 volt). The address driver 55 applies the pixel data pulse DP to the column electrodes D₁ to Dₘ by one display line (m) at a time in synchronization with an application timing of the write scan pulse SP_{WW}. At this time, the selective writing address discharge is generated between the column electrodes D and the row electrodes Y in the discharge cells PC to which the high-voltage pixel data pulse DP to cause the discharge cells to be set to the ON mode is applied along with the write scan pulse SP_{WW}. In addition, immediately after the selective writing address discharge, a weak discharge is also generated between the row electrodes X and Y in the discharge cells PC. In other words, after the write scan pulse SP_{WW} is applied, although a voltage according to the base pulse BP⁻ and the base pulse BP⁺ is applied between the row electrodes X and Y, since this voltage is set to be lower than the discharge start voltage of the discharge cells PC, there occurs no discharge only by the application of such a voltage. However, when the selective writing address discharge is generated, a discharge is induced by the selective writing address discharge and is generated between the row electrodes X and Y only with the voltage by the base pulse BP⁻ and the base pulse BP⁺. Such a discharge is not generated in the first selective writing addressing process W1_{W} in which the base pulse BP⁺ is not applied to the row electrodes X. According to such a discharge and the selective writing address discharge, the discharge cells PC are set to the ON mode, which is a state in which positive wall charges are formed around the row electrodes Y, negative wall charges are formed around the row electrodes X and negative wall charges are formed around the column electrodes D. In the mean time, the above-mentioned selective writing address discharge is not generated between the column electrodes D and the row electrodes Y in the discharge cells PC applied with the pixel data pulse DP having a low voltage (0 volt) for setting them to be in an OFF mode together with the write scan pulse SPA, and therefore a discharge is not generated between the row electrodes X and Y. Accordingly, the discharge cells PC maintain a previous state, that is, a state of an OFF mode initialized in the second resetting process R2.

Subsequently, in the sustaining process I of the sub-field SF2, the Y electrode driver 53 generates the sustain pulse IP having a positive peak potential by one pulse and applies it to the respective row electrodes Y₁ to Yₙ at the same time. During this time, the X electrode driver 51 sets the row electrodes X₁ to Xₙ to be grounded (0 volt) and the address driver 55 sets the column electrodes D₁ to Dₘ to be grounded (0 volt). A sustain discharge is generated between the row electrodes X and Y in the discharge cells PC set to be in an ON mode by the application of the sustain pulse IP. Light emitted from the fluorescent layer 17 by the sustain discharge is irradiated outwards through the front transparent substrate 10 and thus display emission of one time corresponding to a brightness weight of the sub-field SF1 is performed. Furthermore, a discharge is also generated between the row electrodes Y and the column electrodes D in the discharge cells PC set to be in a ON mode by the application of the sustain pulses IP. Negative wall charges are formed around the row electrodes Y, and positive wall charges are formed around the row electrodes X and the column electrodes D in the discharge cells PC, respectively, by such a discharge and the sustain discharge. In addition, after the application of the sustain pulse IP, the Y electrode driver 53 applies the wall charge adjusting pulse CP having a negative potential at a leading edge, which smoothly changes with time as shown in FIG. 8, to the row electrodes Y₁ to Yₙ. Depending on the application of such a wall charge adjusting pulse CP, a weak erase discharge is generated in the discharge cells PC in which the sustain discharge is generated as described above, and thus some of the wall charges formed in the discharge cells PC are erased. This causes the wall charges in the discharge cells PC to be adjusted to generate a correct selective erase address discharge in the next selective erasing addressing process W_{D}.

Subsequently, in the selective erasing addressing process W_{D} in the sub-fields SF3 to SF14, the Y electrode driver 53 supplies base pulses BP⁺ with a positive peak potential to the respective row electrodes Y₁ to Yₙ and supplies the erase scan pulses SP_{D} with a negative peak potential, as shown in FIG. 28, to the respective row electrodes Y₁ to Yₙ sequentially and selectively. In addition, the magnitude of a potential of the base pulses BP⁺ is set as a magnitude capable of preventing an erroneous discharge between the row electrodes X and Y all throughout the execution period the selective erase address discharge process W_{D}. Throughout the execution period of erase address discharge process W_{D}, the X electrode driver 51 sets the row electrodes X₁ to Xₙ to be grounded (0 volt). In the selective erasing addressing process W_{D}, the address driver 55 first converts pixel driving data bits according to the sub-field SF into pixel data pulses DP having pulse voltages according to logic levels of the pixel driving data bits. For example, when the pixel driving data bits with logic level 1 which changes the discharge cells PC from an ON mode to an OFF mode are supplied, the address driver 55 converts them into the pixel data pulses DP with a positive peak potential. In the meantime, the address driver 55 converts the pixel driving data bits with logic level 0 which maintains the current state of the discharge cells PC into the pixel data pulses DP with a low voltage (0 volt). The address driver 55 applies the pixel data pulses DP of one display line (m) to the column electrodes D₁ to Dₘ in synchronization with an application timing of each erase scan pulse SP_{D}. In this case, the selective erase address discharge is generated between the column electrodes D and the row electrodes Y in the discharge cells PC supplied with the positive pixel data pulses DP with a high voltage together with the erase scan pulses SP_{D}. By the selective erase address discharge, the discharge cells PC are set in an OFF mode, that is, positive wall charges are formed around the row electrodes Y and X and negative wall charges are formed around the column electrodes D. In the meantime, the selective erase address discharge as mentioned above is not generated between the column electrodes D and the row electrodes Y in the discharge cells PC supplied with the pixel data pulses DP with a low voltage (0 volt) together with the erase scan pulses SP_{D}. Accordingly, the discharge cells PC maintain a previous state (an OFF mode or an ON mode).

Next, in the respective sustaining processes I of the sub-fields SF3 to SF14, the X electrode driver 51 and the Y electrode driver 53 apply the sustain pulses IP with a positive peak potential to the respective row electrodes Y₁ to Yₙ and X₁ to Xₙ, alternately in the row electrodes X and Y and repeatedly, as shown in FIG. 28. The sustain pulses IP are repeated as many as the number (even number) corresponding to the brightness weight of the sub-fields. Whenever the sustain pulses IP are applied, the sustain discharge is generated between the row electrodes X and Y in the discharge cells PC set to be in an ON mode. Light emitted from the fluorescent layer 17 by the sustain discharge is irradiated outwards through the front transparent substrate 10 and thus display emission of the number of times according to the brightness weight of the sub-fields SF is performed by such a sustain discharge. In this case, negative wall charges are formed around the row electrodes Y and positive wall charges are formed around the row electrodes X and the column electrodes D in the discharge cells PC in which the sustain discharge is generated by the sustain pulse IP applied finally in the sustaining process I of the sub-field SF2 to SF14. In addition, after the application of the final sustain pulse IP, the Y electrode driver 53 applies the wall charge adjusting pulse CP having a negative peak potential at a leading edge, which smoothly changes with time as shown in FIG. 28, to the row electrodes Y₁ to Yₙ. Depending on the application of such a wall charge adjusting pulse CP, a weak erase discharge is generated in the discharge cells PC in which the sustain discharge is generated as described above, and thus some of the wall charges formed in the discharge cells are erased. This causes the wall charges in the discharge cells PC to be adjusted to generate a correct selective erase address discharge in the next selective erasing addressing process W_{D}.

The Y electrode driver 53 applies erase pulses EP with a negative peak potential to the whole row electrodes Y₁ to Yₙ after the end of the sustaining process I of the last sub-field SF14. Only discharge cells PC in an ON mode undertake the erase discharge by the application of the erase pulses EP. The erase discharge changes states of the discharge cells PC from an ON mode to an OFF mode.

The driving as mentioned above is performed on the basis of sixteen pixel driving data GD as shown in FIG. 16.

First, for the second gray scale expressing brightness higher by 1 level than the first gray scale expressing black display (brightness level of 0), as shown in FIG. 16, the selective writing address discharge is generated in only the sub-field SF1 among the sub-fields SF1 to SF14 for setting the discharge cells PC to be in an ON mode, and the minute light emission discharge is generated in the discharge cells PC set to be in the ON mode (represented by □). In this case, a brightness level on emission accompanying the selective writing address discharge and the minute light emission discharge is lower than that on emission accompanying the sustain discharge of one time. Accordingly, when a brightness level visualized by the sustain discharge is assumed to be [1], brightness corresponding to a brightness level of [α] lower than the brightness level of [1] is expressed by the second gray scale.

Next, for the third gray scale expressing brightness higher by 1 level that the second gray scale, the selective writing address discharge is generated in only the sub-field SF2 among the sub-fields SF1 to SF14 for setting the discharge cells PC to be in an ON mode (represented by double circle), and then the selective erase address discharge is generated in the subsequent sub-field SF3 such that the discharge cells PC are changed into an OFF mode (represented by black circle). Therefore, for the third gray scale, emission accompanying the sustain discharge of one time is made in only the sustaining process I of the sub-field SF2 among the sub-fields SF1 to SF14, and brightness corresponding to a brightness level of [1] is expressed.

Next, for the fourth gray scale expressing brightness higher by 1 level than the third gray scale, the selective writing address discharge is first generated in only the sub-field SF1 for setting the discharge cells PC to be in an ON mode, and the minute light emission discharge is generated in the discharge cells PC set to be in the ON mode (represented by □). In addition, for the fourth gray scale, the selective writing address discharge is generated in only the sub-field SF2 among the sub-field SF1 to SF14 for setting the discharge cells PC to be in an ON mode (represented by double circle), and then the selective erase address discharge is generated in the subsequent sub-field SF3 such that the discharge cells PC are changed into an OFF mode (represented by black circle). Therefore, for the fourth gray scale, emission corresponding to a brightness level of [α] in the sub-filed SF1 is made and emission corresponding to a brightness level of [1] accompanying the sustain discharge of one time in the sub-field SF2 is made, and thus brightness corresponding to a brightness level of [α]+[1] is expressed.

In addition, for the fifth gray scale through the sixteenth gray scale, the selective writing address discharge is first generated in the sub-field SF1 for setting the discharge cells PC to be in the ON mode, and the minute light emission discharge is generated in the discharge cells PC set to be in the ON mode (represented by □). The selective erase address discharge is generated in the only one sub-field corresponding to the gray scales such that the discharge cells PC are changed into an OFF mode (represented by black circle). Thus, for each of the fifth gray scale through the sixteenth gray scale, after the minute light emission discharge is generated in the sub-filed SF1 and the sustain discharge of one time is generated in the sub-field 2, the sustain discharge is generated as many as the number of times allotted to the sub-fields in the respective sub-fields (represented by white circle) consecutive by the number corresponding to the gray scales. This visualizes brightness corresponding to brightness levels of [α]+[the total number of sustain discharges generated in one field (or one frame) display period] for each of the fifth gray scale through the sixteenth gray scale.

That is, according to the driving shown in FIG. 16, a brightness range with the brightness levels of [0] to [255+α] can be expressed by the sixteen levels as shown in FIG. 16.

According to such driving, since time periods when emission patterns (an ON mode and an OFF mode) are reversed do not exist in one screen during one field display period, pseudo contour generated by such state is prevented.

Here, in the driving as shown in FIG. 28, the column cathode discharge to cause current to flow from the row electrodes Y toward the column electrodes D is generated as the first reset discharge in the first resetting process R1 of the sub-field SF1 and the second resetting process R2 of the sub-field SF2 by applying a voltage between the column electrodes D as the cathode and the row electrodes Y as the anode. Accordingly, in this first reset discharge, when cations in a discharging gas direct to the column electrodes D, the cations collide with MgO crystals as secondary electron emitting material contained in the fluorescent layer 17 as shown in FIG. 5, thereby emitting secondary electrons from the MgO crystals. In particular, in the PDP 50 of the plasma display apparatus as shown in FIG. 1, by exposing the MgO crystals to the discharging space as shown in FIG. 5 in order to increase the probability of collision with the cations, the secondary electrons are efficiently emitted into the discharging space. Then, since the discharge start voltage of the discharge cells PC is lowered by the priming caused by the secondary electrons, it is possible to generate a relatively weak reset discharge. Accordingly, since the emission luminance accompanying the reset discharge is lowered by the weakness of the reset discharge, display with improvement of a contrast when a dark image is displayed, which is called “dark contrast” is possible.

In addition, in the driving as shown in FIG. 28, the first reset discharge is generated between the row electrodes Y formed on the front transparent substrate 10 and the column electrodes D formed on the rear substrate 14, as shown in FIG. 3. This allows further decrease of discharge light emitted from the front transparent substrate 10 to the outside, as compared to the reset discharge generated between the row electrodes X and Y formed on the front transparent substrate 10, thereby allowing further improvement of dark contrast.

In addition, in the driving as shown in FIGS. 16, 17 and 28, after the reset discharge to cause all of the discharge cells PC to be initialized to the OFF mode in the head sub-field SF1, the selective writing address discharge to cause the discharge cells PC to be changed from the OFF mode to the ON mode is generated. Then, a driving using a selective erasing address method of generating a selective erase address discharge to cause the discharge cells PC to be changed from the ON mode to the OFF mode is performed for one of the sub-fields SF3 to SF14 subsequent to the sub-field SF2. Accordingly, for the dark display (luminance level of 0) by the driving according to the first gray scale as shown in FIG. 16, a discharge generated through one field display period becomes only a reset discharge in the head sub-field SF1. Accordingly, this driving allows further decrease of the number of times of discharges generated in one field display period, as compared to the driving to generate the selective erase address discharge to initialize all of the discharge cells PC in the sub-field SF1 to the ON mode and then shift the discharge cells to the OFF mode. Accordingly, this driving allows improvement of dark contrast.

In addition, the driving shown in FIGS. 16, 17 and 28 generates the minute light emission discharge, instead of the sustain discharge, as a discharge that contributes to a display image in the sub-field SF1 with the lowest brightness weight. In this case, such a minute light emission discharge is generated between the column electrodes D and the row electrodes Y and thus has a lower brightness level on emission accompanying it than the sustain discharge generated between the row electrodes X and Y. Therefore, in case of expressing brightness (the second gray scale) higher by 1 level than black display (brightness level of 0), the minute light emission discharge reduces a brightness difference with level 0 relative to the sustain discharge. With this, gray scale representation ability for an image with low brightness increases. Moreover, for the second gray scale, the reset discharge is not generated in the second resetting process R2 of the sub-field SF2 subsequent to the sub-field SF1, and thus deterioration of dark contrast accompanying the reset discharge is suppressed.

In addition, in the driving as shown in FIG. 28, the peak potential of the reset pulse RP1_{Y1} applied to the row electrodes Y to generate the first reset discharge in the first resetting process R1 of the sub-field SF1 is set to be lower than the peak potential of the reset pulse RP2_{Y1} applied to the row electrodes Y to generate the first reset discharge in the second resetting process R2 of the sub-field SF2. This weakens emission when the reset discharge is simultaneously generated in the whole discharge cells PC in the first resetting process R1 of the sub-field SF1, thereby suppressing dark contrast from being deteriorated.

In addition, in the driving as shown in FIGS. 16, 17 and 28, by generating the sustain discharge only once in the sustaining process I of the sub-field SF2 having a brightness weight next to the smallest brightness weight, the gray scale representation ability for an image with low luminance increases. In the sustaining process I of the sub-field SF2, since the sustain pulse IP is applied only once to generate the sustain discharge, negative wall charges are formed around the row electrodes Y and positive wall electrodes are formed around the column electrodes D after the end of the sustain discharge generated by the sustain pulse IP of one time. This makes it possible that a discharge with the column electrodes D as anodes (hereinafter referred to as “column side anode discharge”) is generated as the selective erase address discharge between the column electrodes D and the row electrodes Y in the selective erasing addressing process W_{D} of the next sub-field SF3. In the mean time, in the sustaining process I of the sub-fields SF3 to SF14 which will be described later, the number of times of application of the sustain pulse IP is an even number. Accordingly, immediately after the end of the sustaining process I, since negative wall charges are formed around the row electrodes Y and positive wall charges are formed around the column electrodes D, the column anode discharge is possible in the selective erasing addressing process W_{D} subsequent to the sustaining process I. Accordingly, since only a positive pulse is applied to the column electrodes D, it is possible to reduce costs of the address driver 55.

In addition, in the PDP 50 as shown in FIG. 1, the CL emitting MgO crystals as the secondary electron emitting material are contained in the fluorescent layer 17 formed on the rear substrate 14 as well as the magnesium oxide layer 13 formed on the front transparent substrate 10 in each discharge cell PC.

Hereinafter, the operation and effects of the above-described configuration will be described with reference to FIGS. 11 and 12.

Accordingly, when the column cathode discharge is generated by applying the reset pulse RP1_{Y1} or RP2_{Y1} with a potential having a smooth change waveform in its rising interval, as shown in FIG. 28, to the row electrodes Y of the PDP 50, the discharge is ended before the potential of the row electrodes Y reaches a pulse peak. Accordingly, since the column cathode discharge is ended when a voltage applied between the row electrodes and the column electrodes is low, its discharge intensity is significantly lowered as compared to FIG. 11, as shown in FIG. 12.

In other words, by applying the reset pulse RP1_{Y1} or RP2_{Y1} with a potential having a smooth change waveform in its rising interval, as shown in FIG. 28, to the PDP 50 including the CL emitting MgO crystals in both of the magnesium oxide 13 and the fluorescent layer 17, the column cathode discharge with low discharge intensity is generated. Accordingly, since the column cathode discharge with very low discharge intensity can be generated as the reset discharge, it is possible to increase a contrast of an image, especially a dark contrast for display of a dark image.

In addition, in the driving as shown in FIG. 28, by setting the negative peak potentials for the write scan pulse SP_{W} applied to the row electrodes Y in the selective writing addressing process W1_{W} of the sub-field SF1 and the write scan pulse SP_{WW} applied to the row electrodes Y in the selective writing addressing process W2_{W} of the sub-field SF2 to establish a relationship of SP_{WW}<SP_{W}, the selective writing address discharge is certainly generated in the second selective writing addressing process W2_{W}.

Hereinafter, the reason why the selective writing address discharge is certainly generated by setting the negative peak potentials of the write scan pulses SP_{W} and SP_{WW} to establish the above relationship will be described.

According to the driving as shown in FIG. 28, in the first selective writing addressing process W1_{W} of the sub-field SF1, the selective writing address discharge is generated between the column electrodes D and the row electrodes Y under the application of the high-voltage pixel data pulse DP and the write scan pulse SP_{W}. In this case, in order to prevent an erroneous discharge between the row electrodes X and Y, the row electrodes X are set to be grounded as shown in FIG. 28. In the mean time, in the second selective writing addressing process W2_{W} of the sub-field SF2, the selective writing address discharge is generated between the column electrodes D and the row electrodes Y under the application of the high-voltage pixel data pulse DP and the write scan pulse SP_{WW}. In addition, in the second selective writing addressing process W2_{W}, in order to change wall charges formed in the discharge cells into the ON mode by generating a discharge between the row electrodes X and Y as well as between the column electrodes D and the row electrodes Y, the positive base pulse BP⁺ is applied to the row electrodes X, as shown in FIG. 28.

Here, in the first selective writing addressing process W1_{W} of the sub-field SF1, if the negative peak potential in the write scan pulse SP_{W} is lowered, a voltage between the row electrodes X and Y is accordingly increased and thus a weak erroneous discharge may be generated between the row electrodes X and Y due to the selective writing address discharge. Due to such an erroneous discharge, a small quantity of positive wall charges remaining around the row electrodes X are erased, but negative wall charges are charged. In the first half of the second resetting process R2 of the sub-field SF2, in order to prevent an erroneous discharge between the row electrodes X and Y, the reset pulses RP2_{Y1} and RP2_{X} having the same polarity are applied to the row electrodes X and Y, respectively. Accordingly, a discharge is not generated in the row electrodes X, and the next second selective writing addressing process W2_{W} has to be performed with the positive wall charges erased around the row electrodes X.

In this manner, if the negative peak potential in the write scan pulse SP_{W} is low, an erroneous discharge is generated between the row electrodes X and Y, and due to this erroneous discharge, negative wall charges are formed around the row electrodes X, which is not ideal. Accordingly, in the second selective writing addressing process W2_{W} of the sub-field SF2, a discharge may not be generated between the row electrodes X and Y, that is, a write discharge may not be correctly generated. In this case, the addressing process of the sub-fields subsequent to the sub-field SF3 is the selective erasing addressing process W_{D} to change the discharge cells from an ON mode to an OFF mode. Accordingly, discharge cells which fail in the selective writing address discharge in the sub-field SF2 have no sustain discharge in the sustaining process I after the sub-field SF3 and turn into black display, thereby significantly deteriorating display quality.

Therefore, as shown in FIG. 28, the negative peak potential of the write scan pulse SP_{W} applied to the row electrodes Y in the first selective writing addressing process W1_{W} of the sub-field SF1 is set to be higher than the negative peak potential of the write scan pulse SP_{WW} applied to the row electrodes Y in the second selective writing addressing process W2_{W} of the sub-field SF2. In other words, in the first selective writing addressing process W1_{W}, the write scan pulse SP_{W} having a negative peak potential increased such that an erroneous discharge is not generated between the row electrodes X and Y due to a selective writing address discharge is applied to the row electrodes Y. In the mean time, in the second selective writing addressing process W2_{W}, the negative peak potential of the write scan pulse SP_{WW} is set to be lower than the negative peak potential of the write scan pulse SP_{W} such that a discharge is certainly generated between the row electrodes X and Y.

Accordingly, since an erroneous discharge is prevented from being generated between the row electrodes X and Y due to a selective writing address discharge which may be generated in the first selective writing addressing process W1_{W}, an ideal formation state of wall charges is maintained in the discharge cells and thus it is possible to certainly generate the selective writing address discharge in the subsequent second selective writing addressing process W2_{W}.

As described above, as the negative peak potential of the write scan pulse SP_{W} is set to be higher than the negative peak potential of the write scan pulse SP_{WW}, there arises a need to set the negative peak potential for the reset pulse RP1_{Y2} in the first resetting process R1. This is because, if the negative peak potential of the reset pulse RP1_{Y2} as a reset tail pulse is set to be lower than the negative peak potential of the reset pulse RP2_{Y2} as a reset head pulse, the following disadvantages may occur.

The reset pulses RP1_{Y2} and RP2_{Y2} as reset tail pulses are applied to adjust the amount of wall charges to stably generate the selective writing address discharge in the subsequent writing addressing processes W1_{W} and W2_{W}.

However, as described above, since the negative peak potential of the write scan pulse SP_{W} is set to be high in the first selective writing addressing process W1_{W} of the sub-field SF1, if a relatively strong discharge is generated by the reset pulse RP1_{Y2} in the previous phase (the second half of R1), the selective writing address discharge is likely to fail.

Therefore, in order to weaken the discharge generated under the application of the reset pulse RP1_{Y2}, the negative peak potential of the reset pulse RP1_{Y2} is set to be high. Specifically, the negative peak potential of the reset pulse RP1_{Y2} in the first resetting process R1 of the sub-field SF1 and the negative peak potential of the reset pulse RP2_{Y2} in the second resetting process R2 of the sub-field SF2 are set to establish a relationship of RP2_{Y2}≦RP1_{Y2}.

With this relationship, as shown in FIG. 28, although the negative peak potential of the write scan pulse SP_{W} in the first selective writing addressing process W1_{W} is set to be relatively high, it is possible to certainly generate the selective writing address discharge. In addition, by setting the negative peak potential of the reset pulse RP1_{Y2} to be higher than the negative peak potential of the reset pulse RP2_{Y2}, it is possible to weaken the discharge generated under the application of the reset pulse RP1_{Y2}, thereby further improving dark contrast.

In the mean time, if the negative peak potential of the reset pulses RP1_{Y2} and RP2_{Y2} is lower than the negative peak potential of the write scan pulse SP_{W} and SP_{WW}, respectively, the selective writing address discharge can not be certainly generated in the writing addressing processes W1_{W} and W2_{W}.

In consideration of this point, in the driving as shown in FIG. 28, by setting the negative peak potential of the reset pulse RP1_{Y2} and the write scan pulse SP_{W} in the sub-field SF1 and the negative peak potential of the reset pulse RP2_{Y2} and the write scan pulse SP_{WW} in the sub-field SF2 are set to establish a relationship of SP_{WW}<SP_{W}≦RP2_{Y2}≦RP1_{Y2}, the selective writing address discharge can be certainly generated in the second writing addressing process W2_{W}.

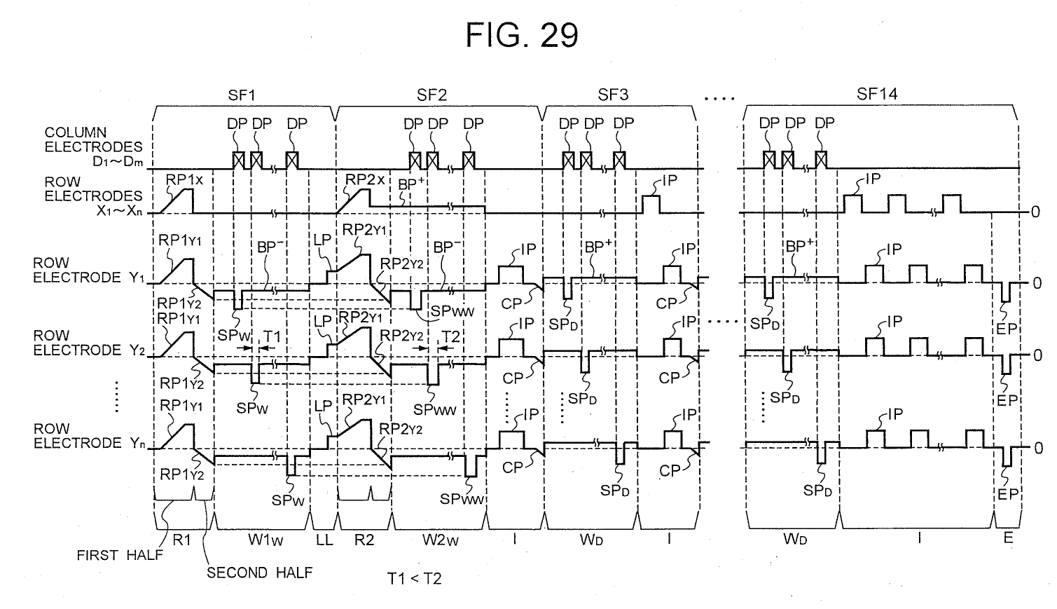

Although the negative peak potential of the write scan pulse SP_{W} is set to be higher than the negative peak potential of the write scan pulse SP_{WW} in the above example, a pulse width T1 of the write scan pulse SP_{W} may be set to be smaller than a pulse width T2 of the write scan pulse SP_{W} with both of the negative peak potentials equal to each other, as shown in FIG. 29. In this case, the negative peak potential of the reset pulses RP1_{Y2} and RP2_{Y2} and the negative peak potential of the write scan pulses SP_{W} and SP_{WW} has a relationship of SP_{WW}=SP_{W}≦RP2_{Y2}≦RP1_{Y2}.

According to the driving as shown in FIG. 29, an erroneous discharge is prevented from being generated between the row electrodes X and Y due to a selective writing address discharge like the driving method as shown in FIG. 28.

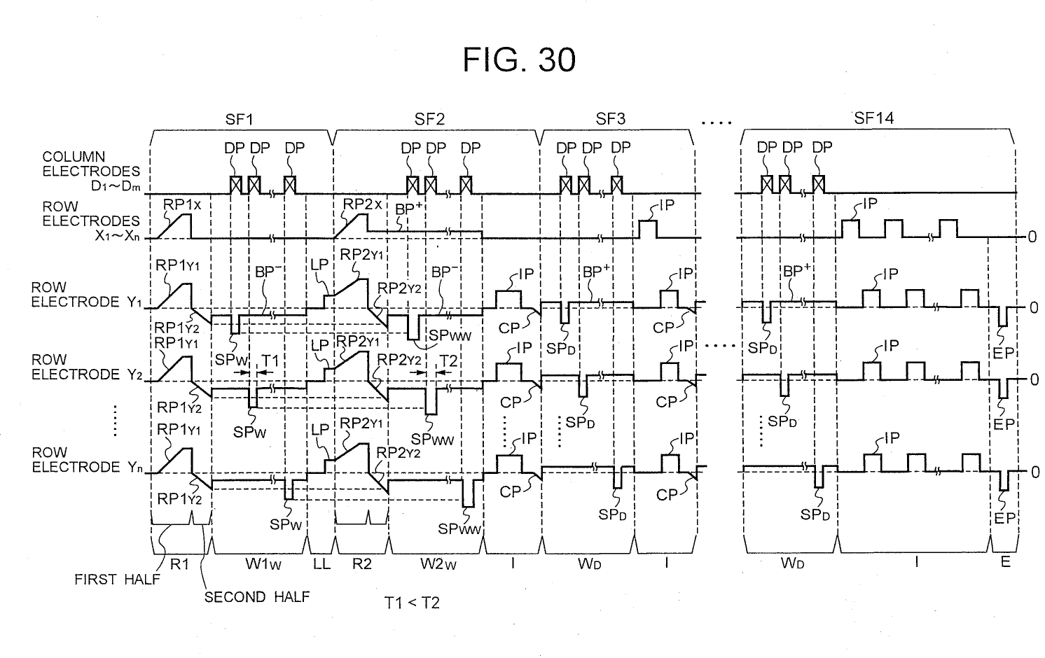

In addition, as shown in FIG. 30, while the negative peak potential of the write scan pulse SP_{W} is set to be higher than the negative peak potential of the write scan pulse SP_{WW}, a pulse width T1 of the write scan pulse SP_{W} may be set to be smaller than a pulse width T2 of the write scan pulse SP_{W}.

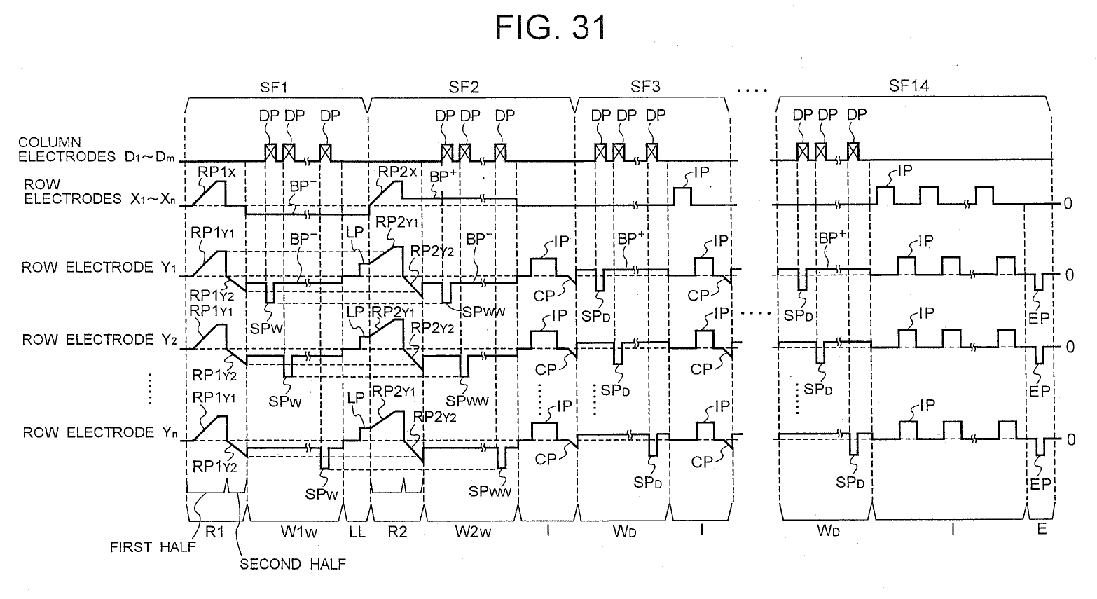

In addition, as shown in FIG. 31, with the negative peak potential of the write scan pulse SP_{W} set to be equal to the negative peak potential of the write scan pulse SP_{WW} and with a pulse width T1 of the write scan pulse SP_{W} set to be equal to a pulse width T2 of the write scan pulse SP_{WW}, the negative base pulse BP⁻ may be applied to the row electrodes X₁ to Xₙ as well as the row electrodes Y₁ to Yₙ throughout the execution period of the first selective writing addressing process W1_{W}. In other words, by applying to the row electrodes X₁ to Xₙ the base pulse having the same polarity as the base pulse BP⁻ applied to the row electrodes Y₁ to Yₙ, an erroneous discharge is prevented from being generated between the row electrodes X and Y.

In addition, as shown in FIG. 31, the driving of applying the negative base pulse BP⁻ to the row electrodes X₁ to Xₙ throughout the execution period of the first selective writing addressing process W1_{W} may be performed in combination with the driving as shown in FIG. 28, 29 or 30.

In short, while applying the negative base pulse BP⁻ to the row electrodes X₁ to Xₙ throughout the execution period of the first selective writing addressing process W1_{W}, the negative peak potential of the write scan pulse SP_{W} may be set to be higher than the negative peak potential of the write scan pulse SP_{WW}, as shown in FIG. 28, or a pulse width of the write scan pulse SP_{W} may be set to be smaller than a pulse width of the write scan pulse SP_{WW}, as shown in FIG. 29.

In addition, although a variation of potential with time is constant in the rising (or falling) interval of each of the reset pulses PR1_{X}, PR2_{X}, PR1_{Y1}, PR1_{Y2}, PR2_{Y1} and PR2_{Y2} in the above example, the variation of potential may be slowly changed with time, as shown in FIG. 32.

In addition, although the first reset discharge is generated as the column cathode discharge by applying the reset pulse RP1_{Y1} to the row electrodes Y₁ to Yₙ in the first half of the first resetting process R1 shown in FIGS. 28 and 29 to 31, this may be omitted.

For example, the first resetting process R1 as shown in FIG. 27 is employed instead of the first resetting process R1 as shown in FIGS. 28 and 29 to 31. As shown in FIG. 27, the row electrodes Y₁ to Yₙ are fixed to the ground potential in the first half of the first resetting process R1. In other words, the purpose of the column cathode discharge from the row electrodes Y to the column electrodes D in the first half of the first resetting process R1 is to emit charged particles to stabilize the write discharge in the first selective writing addressing process W1_{W}. Here, for example with a PDP structure where the MgO crystals containing CL emitting MgO crystals as shown in FIG. 5 are included in the fluorescent layer, the write discharge is stabilized unlike a PDP that does not employ such a structure. Accordingly, in the first half of the first resetting process R1, it is possible to employ a structure where the column cathode discharge is not generated with the row electrodes Y and the column electrodes D set to be grounded. In this case, the row electrodes X are also set to a ground potential level as shown in FIG. 27.

In addition, although the resetting processes R₁ and R₂ and the selective writing addressing processes W1_{W} and W2_{W} are sequentially performed only in the head sub-field SF1, and the second sub-field SF2 in the above example, a series of processes may be performed in the third and subsequent sub-fields in the same way.

In addition, although the reset discharge is simultaneously generated for the whole discharge cells in the first resetting process R1 and the second resetting process R2 as shown in FIGS. 28, 29 and 31, the reset discharge may be generated in a temporally-dispersed manner for each of discharge cell blocks each including a plurality of discharge cells.

In addition, although the minute light emission process LL is performed, as a process to make emission that contributes to image display, only for the head sub-field SF1 instead of the sustaining process I, the minute light emission process LL may be performed for sub-fields other than the head sub-field or a plurality of sub-fields including the head sub-field instead of the sustaining process I.

In addition, although the minute light emission discharge accompanied with emission of a brightness level of α is generated in the minute light emission process LL of the sub-field SF1 in the fourth and subsequent gray scales in the driving as shown in FIG. 16, the minute light emission discharge may not be generated in the third and subsequent gray scales. In short, since emission by the minute light emission discharge has a very low brightness (brightness level of α), when the minute light emission discharge is combined with the sustain discharge accompanied with emission of higher brightness, that is, when increment of brightness of ‘brightness level of α’ can not be visualized in the third and subsequent gray scales, there is no need to generate the minute light emission discharge.

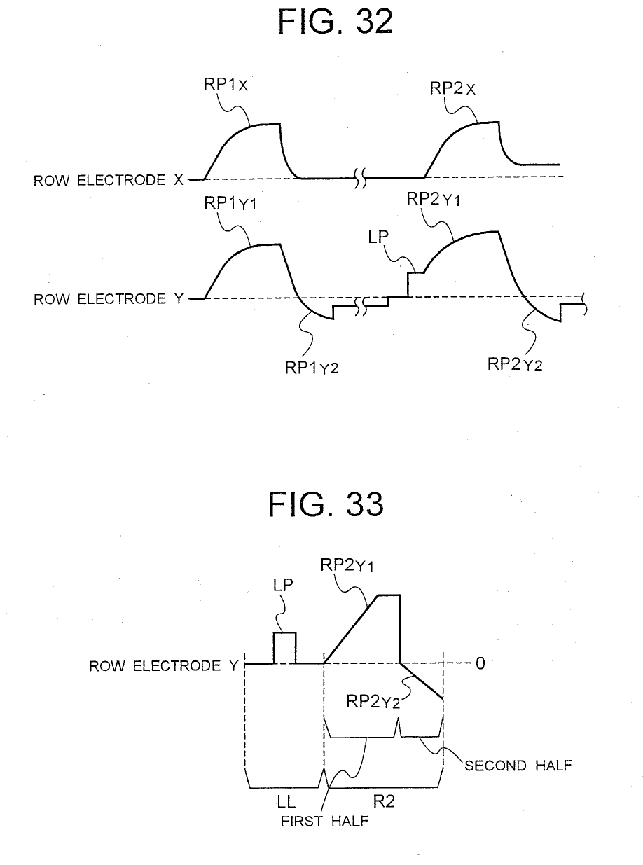

In addition, although the minute light emission pulse LP and the reset pulse RP2_{Y1} connected in time are applied to the row electrodes Y in the example as shown in FIGS. 28 and 29 to 31, both of the pulses may be sequentially applied to the row electrodes Y in a temporally-dispersed manner, as shown in FIG. 33.

In addition, although the MgO crystals are included in the fluorescent layer 17 formed on the rear substrate 14 of the PDP 50 in the example as shown in FIG. 5, a secondary electron emission layer 18 composed of secondary electron emission material may be formed to cover the surface of the fluorescent layer 17. In this case, the secondary electron emission layer 18 may be formed by forming crystals (for example, MgO crystals containing CL emitting MgO crystals) composed of secondary electron emission material on the surface of the fluorescent layer 17 or forming a thin film with the secondary electron emission material on the surface of the fluorescent layer 17.

This application is based on Japanese Patent Applications Nos. 2007-055557 and 2007-109650 which are hereby incorporated by reference.

What is claimed is:

1. A method of driving a plasma display panel in which a front substrate faces a rear substrate with a discharge space filled with a discharge gas interposed therebetween and discharge cells forming pixels are formed in intersecting areas of a plurality of pairs of row electrodes formed on the front substrate and a plurality of column electrodes formed on the rear substrate, the plasma display panel being gray scale-driven by a plurality of sub-fields every unit display period of an input image signal,
wherein a fluorescent layer including a fluorescent material and a secondary electron emission material is formed in the discharge cells on the rear substrate,
wherein, in one sub-field in the unit display period, a resetting process to initialize the discharge cells to an OFF mode and an addressing process to change the discharge cells into an ON mode selectively according to the input image signal are performed,
wherein, in the resetting process, a voltage is applied between one row electrode as an anode of the pair of row electrodes and the column electrode as a cathode, and then, a first base pulse having a positive peak potential is applied to the other row electrode of the pair of row electrodes while applying a negative potential to the one row electrode, and
wherein a second base pulse having a positive peak potential different from the positive peak potential of the first base pulse is applied to the other row electrode while a negative potential is applied to the one row electrode throughout the execution period of the addressing process.

2. The method according to claim 1,
wherein the first base pulse is higher in potential than the second base pulse.

3. The method according to claim 1,
wherein the first base pulse is lower in potential than the second base pulse.

4. The method according to claim 1,
wherein the one sub-field is a head sub-field in the unit display period, and the resetting process is performed only with the head sub-field of the sub-fields.

5. The method according to claim 1,
wherein the one sub-field is a sub-field provided immediately after the head sub-field in the unit display period, and
wherein, in the head sub-field, a resetting process to initialize the discharge cells to an OFF mode and an addressing process to change the discharge cells into an ON mode selectively according to the input image signal are performed.

6. The method according to claim 5,
where, in the resetting process, a voltage is applied between one row electrode as an anode of the pair of row electrodes and the column electrode as a cathode in the discharge cells.

7. The method according to claim 5,
wherein the resetting process is performed only with the head sub-field and one sub-field provided immediately after the head sub-field in the unit display period.

8. The method according to claim 5,
wherein, immediately after the addressing process of the head sub-field, a weak emission process to generate a minute light emission discharge between one row electrode as an anode of the pair of row electrodes and the column electrode as a cathode in the discharge cells set to the ON mode in the addressing process of the head sub-field by applying a voltage between the one row electrode and the column electrode is performed.

9. The method according to claim 8,
wherein the minute light emission discharge is a discharge accompanied with emission corresponding to a gray scale of brightness higher by one level than a brightness level of 0.

10. The method according to claim 1,
wherein the secondary electron emission material is formed of magnesium oxide.

11. The method according to claim 10,
wherein the magnesium oxide includes magnesium oxide crystals that make cathode luminescence emission excited by an electron beam and having a peak in a wavelength range of 200 to 300 nm.

12. The method according to claim 1,
wherein particles formed of the secondary electron emission material contact with the discharge gas in the discharge space.

13. A method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal,
wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed,
wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and
wherein a negative peak potential of the write scan pulse applied in the writing addressing process of the first sub-field is set to be higher than a negative peak potential of the write scan pulse applied in the writing addressing process of the second sub-field.

14. The method according to claim 13,
wherein a pulse width of the write scan pulse applied in the writing addressing process of the first sub-field is set to be smaller than a pulse width of the write scan pulse applied in the writing addressing process of the second sub-field.

15. The method according to claim 13,
wherein the erasing addressing process is performed in all sub-fields subsequent to the third sub-field.

16. The method according to claim 13,
wherein, in each of the first and second sub-field, immediately before the writing addressing process, a resetting process to apply a reset tail pulse to the one row electrode between the column electrode as a cathode and the one row electrode is performed, and
wherein a negative peak potential of the reset tail pulse applied in the first sub-field is set to be higher than a negative peak potential of the reset tail pulse applied in the second sub-field.

17. The method according to claim 13,
wherein a fluorescent material and a secondary electron emission material are included in the fluorescent layer.

18. The method according to claim 17,
wherein the secondary electron emission material is formed of magnesium oxide.

19. The method according to claim 18,
wherein the magnesium oxide includes magnesium oxide crystals that make cathode luminescence emission excited by an electron beam and having a peak in a wavelength range of 200 to 300 nm.

20. The method according to claim 17,
wherein the secondary electron emission material contacts with the discharge gas in the discharge space.

21. The method according to claim 16,
wherein, in the resetting process, all of the discharge cells are initialized to the OFF mode.

22. The method according to claim 16,
wherein, in the resetting process of the second sub-field, immediately before the application of the reset tail pulse, a reset head pulse is applied between the one row electrode as an anode and the column electrode as a cathode.

23. The method according to claim 16,
wherein, in the resetting process of each of the first and second sub-fields, immediately before the application of the reset tail pulse, a reset head pulse is applied between the one row electrode as an anode and the column electrode as a cathode.

24. The method according to claim 22,
wherein, in the resetting process, a potential to prevent a discharge between the other row electrode and the one row electrode of the pair of row electrodes is applied to the other row electrode.

25. The method according to claim 23,
wherein, in the resetting process, a potential to prevent a discharge between the other row electrode and the one row electrode of the pair of row electrodes is applied to the other row electrode.

26. The method according to claim 13,
wherein the first sub-field is a head sub-field in the unit display period and the second sub-field is a sub-field provided immediately before the head sub-field.

27. The method according to claim 23,
wherein the resetting process is included in only the first sub-field and the second sub-field of the sub-fields in the unit display period.

28. The method according to claim 22,
wherein, in the resetting process, a potential is increased slowly at a leading edge of the reset head pulse with time.

29. The method according to claim 23,
wherein, in the resetting process, a potential is increased slowly at a leading edge of the reset head pulse with time.

30. The method according to claim 22,
wherein the reset head pulse has a positive peak potential, and
wherein, in the resetting process, a positive potential is applied to the other row electrode while applying the reset head pulse to the one row electrode.

31. The method according to claim 23,
wherein the reset head pulse has a positive peak potential, and
wherein, in the resetting process, a positive potential is applied to the other row electrode while applying the reset head pulse to the one row electrode.

32. The method according to claim 13,
wherein, in the first sub-field, a weak emission process to generate a minute light emission discharge between one row electrode as an anode of the pair of row electrodes and the column electrode as a cathode in the discharge cells set to the ON mode by applying a voltage between the one row electrode and the column electrode is further performed.

33. The method according to claim 32,
wherein the minute light emission discharge is a discharge accompanied with emission corresponding to a gray scale of brightness higher by one level than a brightness level of 0.

34. The method according to claim 13,
wherein, in the first sub-field, a negative base pulse is applied to the other row electrode of the pair of row electrodes through the writing addressing process, and
wherein, in the second sub-field, a positive base pulse is applied to the other row electrode throughout the execution period of the writing addressing process.

35. A method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal,
wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed,
wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and
wherein a pulse width of the write scan pulse applied in the writing addressing process of the first sub-field is set to be smaller than a pulse width of the write scan pulse applied in the writing addressing process of the second sub-field.

36. The method according to claim 35,
wherein a negative peak potential of the write scan pulse applied in the writing addressing process of the first sub-field is set to be equal to a negative peak potential of the write scan pulse applied in the writing addressing process of the second sub-field.

37. The method according to claim 35,
wherein the erasing addressing process is performed in all sub-fields subsequent to the third sub-field.

38. The method according to claim 35,
wherein, in each of the first and second sub-field, immediately before the writing addressing process, a resetting process to apply a reset tail pulse to the one row electrode between the column electrode as a cathode and the one row electrode is performed, and
wherein a negative peak potential of the reset tail pulse applied in the first sub-field is set to be higher than a negative peak potential of the reset tail pulse applied in the second sub-field.

39. The method according to claim 35,
wherein a fluorescent material and a secondary electron emission material are included in the fluorescent layer.

40. The method according to claim 39,
wherein the secondary electron emission material is formed of magnesium oxide.

41. The method according to claim 40,
wherein the magnesium oxide includes magnesium oxide crystals that make cathode luminescence emission excited by an electron beam and having a peak in a wavelength range of 200 to 300 nm.

42. The method according to claim 39,
wherein the secondary electron emission material contacts with the discharge gas in the discharge space.

43. The method according to claim 38,
wherein, in the resetting process, all of the discharge cells are initialized to the OFF mode.

44. The method according to claim 38,
wherein, in the resetting process of the second sub-field, immediately before the application of the reset tail pulse, a reset head pulse is applied between the one row electrode as an anode and the column electrode as a cathode.

45. The method according to claim 38,
wherein, in the resetting process of each of the first and second sub-fields, immediately before the application of the reset tail pulse, a reset head pulse is applied between the one row electrode as an anode and the column electrode as a cathode.

46. The method according to claim 44,
wherein, in the resetting process, a potential to prevent a discharge between the other row electrode and the one row electrode of the pair of row electrodes is applied to the other row electrode.

47. The method according to claim 45,
wherein, in the resetting process, a potential to prevent a discharge between the other row electrode and the one row electrode of the pair of row electrodes is applied to the other row electrode.

48. The method according to claim 35,
wherein the first sub-field is a head sub-field in the unit display period and the second sub-field is a sub-field provided immediately before the head sub-field.

49. The method according to claim 45,
wherein the resetting process is included in only the first sub-field and the second sub-field of the sub-fields in the unit display period.

50. The method according to claim 44,
wherein, in the resetting process, a potential is increased slowly at a leading edge of the reset head pulse with time.

51. The method according to claim 45,
wherein, in the resetting process, a potential is increased slowly at a leading edge of the reset head pulse with time.

52. The method according to claim 44,
wherein the reset head pulse has a positive peak potential, and
wherein, in the resetting process, a positive potential is applied to the other row electrode while applying the reset head pulse to the one row electrode.

53. The method according to claim 45,
wherein the reset head pulse has a positive peak potential, and
wherein, in the resetting process, a positive potential is applied to the other row electrode while applying the reset head pulse to the one row electrode.

54. The method according to claim 35,
wherein, in the first sub-field, a weak emission process to generate a minute light emission discharge between one row electrode as an anode of the pair of row electrodes and the column electrode as a cathode in the discharge cells set to the ON mode by applying a voltage between the one row electrode and the column electrode is further performed.

55. The method according to claim 54,
wherein the minute light emission discharge is a discharge accompanied with emission corresponding to a gray scale of brightness higher by one level than a brightness level of 0.

56. The method according to claim 35,
wherein, in the first sub-field, a negative base pulse is applied to the other row electrode of the pair of row electrodes through the writing addressing process, and
wherein, in the second sub-field, a positive base pulse is applied to the other row electrode throughout the execution period of the writing addressing process.

57. A method of driving a plasma display panel in which a first substrate faces a second substrate with a discharge space filled with a discharge gas interposed therebetween and discharge cells including fluorescent layers whose surfaces contact with the discharge gas are formed in intersecting areas of a plurality of pairs of row electrodes formed on the first substrate and a plurality of column electrodes formed on the second substrate, the plasma display panel being gray scale-driven by a plurality of sub-fields every unit display period of an image signal,
wherein, in a first sub-field and a second sub-field subsequent to the first sub-field of the plurality of sub-fields in the unit display period, a writing addressing process to change the discharge cells from an OFF mode to an ON mode selectively by applying a pixel data pulse according to pixel data for each pixel based on the image signal to the column electrodes while sequentially applying a negative write scan pulse to one row electrode of the pair of row electrodes is performed,
wherein, in a third sub-field subsequent to the second sub-field, an erasing addressing process to change the discharge cells from the ON mode to the OFF mode selectively by applying a pixel data pulse according to pixel data for each pixel based on the image signal to the column electrodes while sequentially applying a negative erase scan pulse to one row electrode of the pair of row electrodes is performed, and
wherein, in the first sub-field, a negative base pulse is applied to the other row electrode of the pair of row electrodes throughout the execution period of the writing addressing process, and, in the second sub-field, a positive base pulse is applied to the other row electrode through the writing addressing process.
